(19) United States
(12) Patent Application Publication
(10) Pub. No.: US 2015/0082342 A1
(43) Pub. Date: Mar. 19, 2015

(54) SYSTEM AND METHOD FOR VIEWERS TO COMMENT ON TELEVISION CONTENT FOR DISPLAY ON REMOTE WEBSITES USING A WEB BROWSER

(71) Applicant: SOCIAL COMMENTING, LLC, Sedona, AZ (US)

(72) Inventors: Michael Roy Norwood, Phoenix, AZ (US); Stephen Malvern Omohundro, Palo Alto, CA (US)

(73) Assignee: SOCIAL COMMENTING, LLC, Sedona, AZ (US)

(21) Appl. No.: 14/547,890

(22) Filed: Nov. 19, 2014

Related U.S. Application Data
(63) Continuation-in-part of application No. 13/759,693, filed on Feb. 5, 2013.
Application No. 13/759,693 is a continuation of application No. 11/818,912, filed on Jun. 15, 2007, now Pat. No. 8,402,357.
(60) Provisional application No. 61/906,408, filed on Nov. 19, 2013.
(60) Provisional application No. 60/813,982, filed on Jun. 15, 2006.

(51) Int. Cl. H04N 21/81; H04N 21/4782; H04N 21/462; H04N 21/4788

(52) U.S. Cl. CPC H04N 21/8133; H04N 21/812; H04N 21/8173; H04N 21/4788; H04N 21/4782; H04N 21/4622
USPC 725/32

(57) ABSTRACT

A software system and method allowing television and/or cinema viewers to create, store, and display comments pertaining to media content (e.g. programs, streaming movies, advertisements). Users with electronic computing devices comprising a web browser (e.g. smartphone, smart television, etc.) enter comments and transmit them to a third party database for storage and/or display on website(s) (e.g. social media). Webpages display user interface elements allowing the viewer to identify the television content (title of show), and to receive comment data input, which is then transmitted to remote second servers for storage, and/or for display on second websites. An administrator accesses a webpage of the first website server to enter data (e.g. HTML code) for creating user interface elements. When the webpage containing the code is posted to a website, the code results in a comment display page where users can input comments on television content and on posted comments.

### CROSS-REFERENCE TO RELATED APPLICATIONS

This is a utility patent application being filed in the United States as a non-provisional application for patent under Title 35 U.S.C. §100 et seq. and 37 C.F.R. §1.53(b) and, claiming the priority under 35 U.S.C. §119(e) to the provisional application for patent filed in the United States on Nov. 19, 2013, bearing the title of “SYSTEM AND METHOD FOR VIEWERS TO COMMENT ON TELEVISION CONTENT FOR DISPLAY ON REMOTE WEBSITES USING A WEB BROWSER”, and assigned application Ser. No. 61/906,408.

Further, this application is a continuation-in-part of U.S. patent application Ser. No. 13/759,693, filed on Feb. 5, 2013, which application is a continuation of U.S. patent application Ser. No. 11/818,912 filed on Jun. 15, 2007 and issued as U.S. Pat. No. 8,402,357 to Norwood et al., on Mar. 19, 2013, and bears the title of “SYSTEM AND METHOD FOR FACILITATING POSTING OF PUBLIC AND PRIVATE USERS COMMENTS AT A WEBSITE”, which application is a non-provisional application of U.S. Provisional Application for patent filed on Jun. 15, 2006 and assigned serial number 60/813,982.

Each of these above-referenced applications is hereby incorporated by reference in its entirety.

### BACKGROUND

The present disclosure relates generally to Internet methods for viewers to comment on television, and cinema content using their electronic computing devices utilizing a web browser.

Television has been an important source of news and entertainment since its commercial introduction in 1928. For decades, television watching has been a passive experience. Initially viewers could only watch what was being broadcast at the moment. These characteristics made television an ideal advertising medium and the revenue from television ads have supported the creation of programming since its inception. The introduction of video tape allowed viewers to “time-shift” programs and watch programs when they chose. It also allowed viewers to skip over commercials. The introduction of cable networks dramatically increased the quantity and variety of programming. But it also had the effect of spreading a fixed number of viewers over many more shows, lowering the advertising value of each show.

### SUMMARY

The various embodiments serve to make the television viewing experience into an active rather than passive one and it engages viewers with content in a way that increases the value of advertising. Today, younger viewers especially do not passively watch television shows. They talk on the phone, text, or email their friends about what it happening as it happens. This creates deeper social connections and turns the viewing experience into something more active and creative. So-called “second screens” provide an active channel for deeper engagement with programming.

Michael Norwood's U.S. Pat. No. 8,402,357 introduces the technology to take this “second screen” engagement to another level. The original patent described the technology to aggregate user comments on a website so that they could be accessed by others in a central location and be made available at a later time. The various embodiments disclosed herein are a continuation of that original patent in that they focus on the application to television and cinema viewing. Various embodiments may highlight the use of social commenting for interacting with the full range of television programming: sports, entertainment, news, political events, commercial messages, games and entertainment.

By allowing comments to be aggregated on a separate website, the various embodiments may increase the visibility and value of the comments. These visible comments act like testimonials both for the television programming and for the brands which advertise on that programming. In this way they create additional value and make the creation of new programming possible. They also increase the value to a viewer of engaging with shows in real-time. This makes people less likely to time-shift by recording and more likely to watch commercial messages.

### Commenting on Television Viewing

Embodiments presented herein may be directed to computerized systems and methods that enable television viewers to post comments on television, online, or cinema content (e.g. television programs, streaming movies, advertisements, etc.) using web browsers on their electronic computing device or on a smart television. The comments are electronically transmitted via the web browsers and Internet for storage on remote databases, and/or for display on websites.

This disclosure therefore comprises a computerized method, system, and computer program product for a user electronic computing device to display a webpage for commenting on television content, and to enable a website administrator to create such a webpage. The webpage(s) may comprise a user interface element with one or more screens, or elements in a screen, that: 1) allows the user to select or input the identification of the television or cinema content—e.g. program or streaming movie; 2) transmit over the Internet the comment in response to a user input, such as one user action (e.g. 1-Click) on the webpage; 3) receive at a remote second website server the user input; and, 4) store the user input (i.e. comment(s)) in a database of the second server and/or display on a webpage of the website of the second server.

The second server, website and webpages may be those of a third party, such as a social networking site, that consolidates, edits (e.g. removing viewer identifying information, or taking parts of comments-phrases), and posts the comments of a plurality of viewers. And/or the third party may be an entity that stores the comments on a second server for internal use, such as television rating firm conducting mathematical computations to analyze various factors of the likeability of a television program or advertisement or streaming video.

Additionally, the various embodiments as disclosed herein, as well as variations thereof, may further comprise the comment being transmitted from the second server to a third, fourth, etc. server for storage and/or display on a third, fourth, etc. webpage of a website. For example, the second server may comprise a rating firm that screens the database for positive comments, and then transmits them to a third server for display on a webpage (e.g. a social network website).

“Television content” may comprise any program (channel of a network, syndicated, cable etc. entity) as viewed on a standard television (i.e. without Internet connectivity). It may also comprise any content viewed on a smart television with a web browser, such as a streaming video or movie (e.g. NetFlix®, Hulu®, Amazon® etc. provider).

Comments may pertain to, for example, televised sports events, votes on game show actions, choices of storyline, votes about a show's characters, news items, testimonials about advertised products, and so forth.

The viewer's electronic computing device may comprise any type of electronic computing device enabled to communicate via a web browser with the first website server. Non-limiting examples of devices comprise: laptop computers, desktop computers, tablet computers, and mobile electronic communications devices—e.g. smartphones, cellular phones, and personal digital assistant devices with web browsers, and smart television remote controls when the television displays a web browser to navigate to an administrator's website for inputting user comments on television comments.

The viewer's electronic computing device may further comprise a device able to electronically communicate with a smart television comprising a web browser. For example, the viewer's device may comprise a smart television remote control with or without a keyboard to input and transmit comments to a web browser on a smart television, wherein the browser displays a user interface element (e.g. webpage) for viewer commenting.

Additionally, the various embodiments as disclosed herein, as well as variations thereof, the user's input may comprise audio, video, photo, and textual comment data pertaining to television content.

The various embodiments may further comprise a local server with a database (e.g. user's smartphone memory) in lieu of, or in addition to, a remote second website server for storage of the user's comment.

The term “end-user” as used herein, may refer to readers of website content, television viewers, and/or both.

The present embodiments may further computer program products for one or more embodiments disclosed herein, wherein the products comprise computer code stored in memory on the system server, such as a remote cloud-based server, and/or accessible by or stored in whole or in part the within the memory of an end user's electronic computing device. The products may further comprise non-transitory computer readable medium containing computer executable instructions to carry out, by the processor, the methods disclosed herein.

The present embodiment or aspects further comprises a non-transitory computer readable apparatus (e.g. server, electronic computing device) having at least one computer program or module or application thereon configured to execute the methods disclosed herein.

The present embodiments further comprise: a computerized method for receiving and managing end user comments associated with a web page, wherein a first web site server displays a web page modified to display an end user comment function and is configured to receive data related to a comment entered by an end user of said web page displayed by said first web site server, the method comprising the actions of: a) receiving at a remote second web site server data related to a comment and associated with the web page, said data related transferred upon said user actuating a submit function displayed on the web page presented by the first web site server; and, b) storing at said remote second web site server, using a database that is remote from said first web site server said data related to said comment that was entered by an end user of said web page at said first web site server; and, c) wherein said comment pertains to television, online, or cinema content.

### BRIEF DESCRIPTION OF THE DRAWINGS

FIG. 1 is a block diagram of the basic components for an exemplary embodiment.

FIG. 2 is a detailed block diagram of components for an exemplary embodiment.

FIG. 3 is a login screen shot according to an exemplary embodiment.

FIG. 4 is an administrator page creator screen shot according to an exemplary embodiment.

FIG. 5A and FIG. 5B are personal journal screen shots according to an exemplary embodiment.

FIG. 6 is an administrator page editor screen shot according to an exemplary embodiment.

FIG. 7 is a display page screen shot for an exemplary embodiment.

FIG. 8 is a tell-a-friend screen shot according to an exemplary embodiment.

FIG. 9 is an administrator email screen shot according to an exemplary embodiment.

FIG. 10 is an administrator change page editor screen shot according to an exemplary embodiment.

FIGS. 11, 11A, 11B, 12, 12A-12F, 13, 13A, 13B, 14, 14A-14C, 15, 15A, 15B and 16 are screen shots for administrator category creation according to an exemplary embodiment.

FIG. 17 is example iFrame code according to an exemplary embodiment.

FIGS. 18 and 19 are screen shots for creating and managing banners according to an exemplary embodiment.

FIGS. 20-22 are end user comment screen shots for an exemplary embodiment.

FIGS. 23A-23OO are a flow diagram illustrating the web site administration, user administration, and end user components for an exemplary embodiment.

FIG. 24 is a sample web page comprising a comment area according to an exemplary embodiment.

FIG. 25 is a flowchart illustrating the iFrame solution according to an exemplary embodiment.

FIGS. 26A and 26B are illustrations of the computing devices utilized in the commenting on television, online, or cinema content.

FIG. 27 is a flowchart illustrating the computer steps for a website administrator to create webpages that can receive input for television viewer commenting.

FIG. 28 is a flowchart illustrating the computer steps for a second remote website server to store an end user's comments on television content.

FIG. 29 is a flowchart illustrating the viewer's steps is entering comments using a smartphone or smart T.V. with a web browser.

### DETAILED DESCRIPTION

As used herein, the term “User Interface Element” refers to a screen displayed by an application as viewed on an electronic computing device (e.g. the interface of a smartphone or the screen of a television with Internet connectivity). It may also refer to a part of a screen, such as a tab, check box, drop down menu, text input area, etc.

As used herein, the term “End-user” or “User” or “Viewer” may refer to viewers of the television or cinema content who input and transmit comments, readers of the comments, and/or responders who input comments in response to a viewer's comment. The end-user may also be required to meet pre-set criteria in order to participate in inputting, and/or viewing comments. Criteria may comprise, by way of non-limiting examples, one or more of: being located at a designated venue; and/or, possessing a demographic trait comprising age, race, geographical location, and income.

As used herein, the term “Comment Actuator” refers to a distinguishing feature, marker, or other indicia, as well as or alternatively, a hidden or subtle feature that is activated or may become more pronounced on a touch event by an end-user as displayed on a webpage of a first website server, or second sub-system as viewed from the end-user computing device. When activated, a module or function can be initiated or a command can be sent to cause such initiation. The comment actuator is typically associated with a portion of the mobile application display or webpage content, such as an image, video and/or audio content included within the webpage or mobile application. It should be appreciated that throughout this description, the term comment actuator can be applied to the modification to a mobile application display and/or associated webpage that allows the viewer of the app/webpage to invoke a commenting function as well as the underlying routine, module or function that results from the actuation.

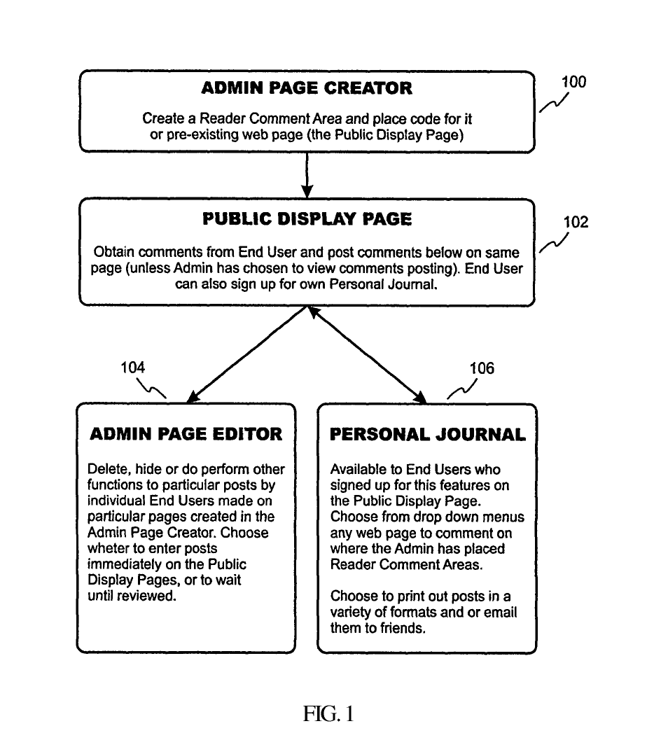

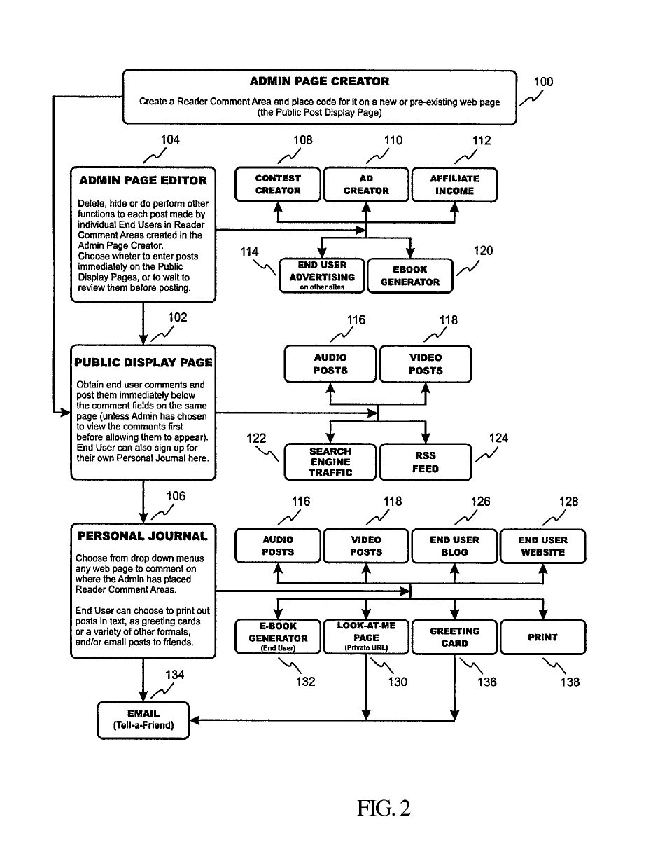

Referring to FIG. 1, a block diagram of the basic components for an exemplary embodiment is shown. An administrator page creator component allows an administrator to first create a comment area and place code for the comment on any new or pre-existing web page 100. Once posted to a web site, a public display page component 102 allows end users to input comments that are posted on the page. The comments may be displayed on the page when they are entered or the administrator may review them prior to displaying them. The end user may also sign up for his or her own personal journal at the web page. An administrator page editor 104 component allows an administrator to delete, hide, and perform other functions on posts entered by individual end users on particular pages created using the administrator page creator 100. The administrator may decide whether to enter posts immediately on the public display page or to review them prior to displaying them. A personal journal component 106 is available to end users that select a personal journal feature. End users can choose web pages from drop down menus and enter comments in any area where an administrator has placed a comment area. The end user can review and manage his or her own comments, print them in a variety of formats, and/or email them to friends.

Referring to FIG. 2, a detailed block diagram of component for an exemplary embodiment is shown. A public display page component 102 may support audio posts 116 and video posts 118 in addition to text entries. Because posts are part of the web pages on which they are entered, they may be considered by search engines in page rankings 122 and they may be considered web page updates to RSS feeds 124. An administrator page editor component 104 may use to generate eBooks of end user posts 120. Finally, a personal journal component 106 allows an end user to manage his or her own posts and perform various functions based the personal posts. For example, an end user may create an end user blog 126 or a web site 128 based on his or her own posts as well as a private URL to a page of the end user's posts 130. The end user may create an eBook of the posts 132 or a greeting card of the posts 136. Finally, the end user may print the posts 138. Posts in a variety of formats may be emailed to friends 134.

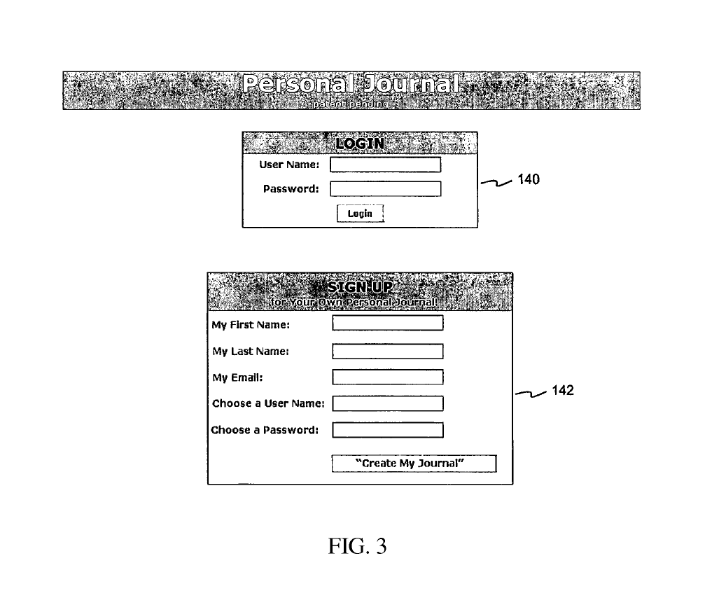

Referring to FIG. 3, a login screen shot according to an exemplary embodiment is shown. An end user who is already signed up for a personal journal logs in with his or her user name and password and selects a sign-up option to reach a personal journal page 140. In another portion of the screen 142, the end user signs up to create his or her own personal journal. Fields include first name, last name, email address, user name, and password. The end user selects a “create my journal” option to the complete the process.

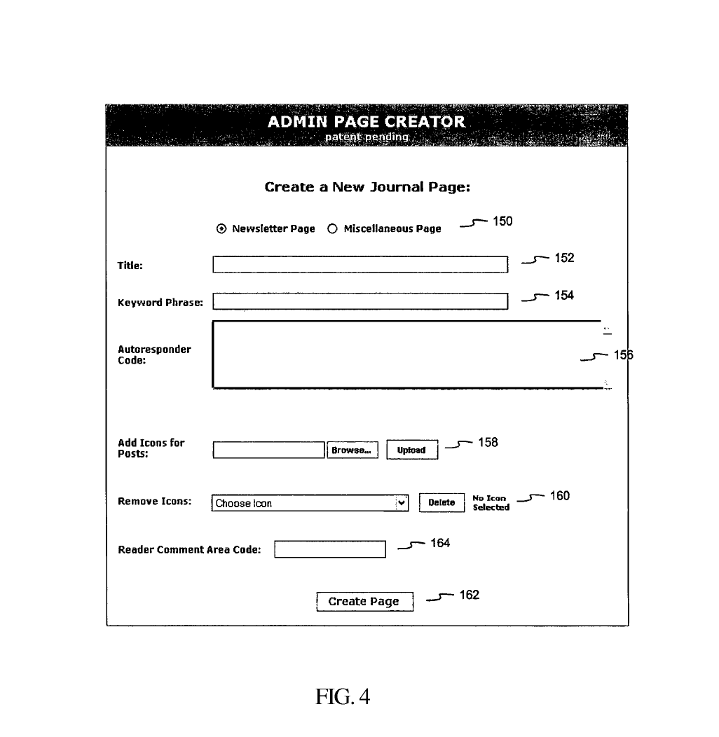

Referring to FIG. 4, an administrator page creator screen shot according to an exemplary embodiment is shown. The administrator may create new comment areas for various types of web documents such as newsletters and miscellaneous web pages at the web site. The administrator identifies the type of web page 150. A newsletter page option may be used for a web page that was originally created as a newsletter. A miscellaneous page may refer to any other type of web page. In the title field 152, the administrator enters the title of the web site page for which he or she is creating a comment area. In the keyword phrase field 154, administrator enters keywords of his or her choice for search engine optimization. These keywords appear next to the time/date stamp of the end user posts. An auto responder code field 156 is where the administrator enters the form/post HTML code that automatically subscribes new end users who are making posts or who are signing up for personal journals to the administrator's Auto responder. (The auto responder is the database/emailing service that maintains the administrator's list of subscribers). The “add icons for posts” browse menu 158 enables the administrator to upload images from which the end user can choose to add to his or her posts. Images uploaded automatically are reformatted to a preset width, length and kilobyte size. A “remove icons” pull down menu 160 enables the administrator to remove previously added icons. A comment area code field 164 is an output field and is created after the administrator presses the create page option 162. It is the specialized XML code that allows the administrator to have the comment areas appear on remote web sites and, it is where all the administrator's selections in the previous fields appear.

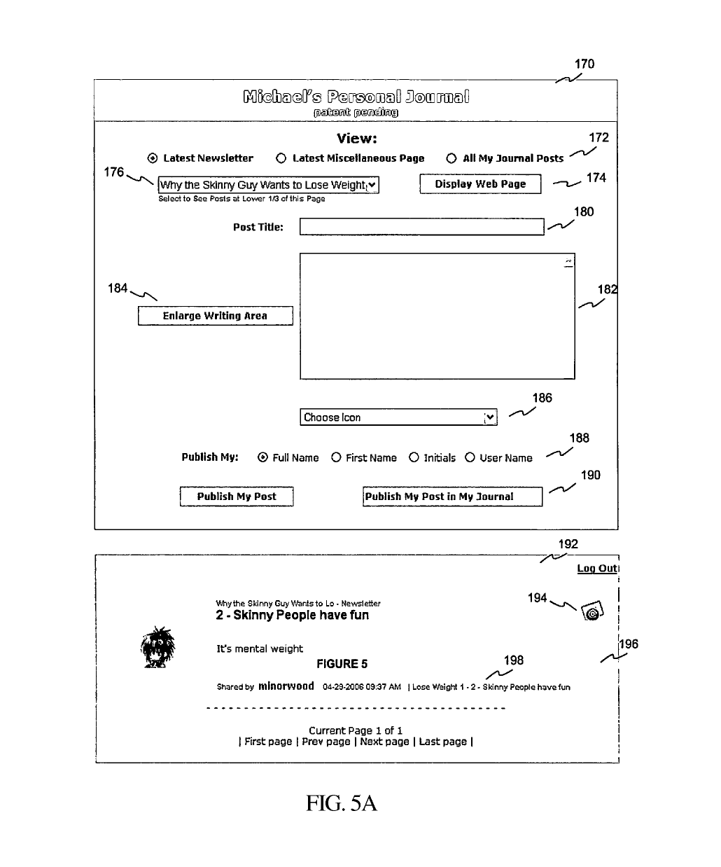

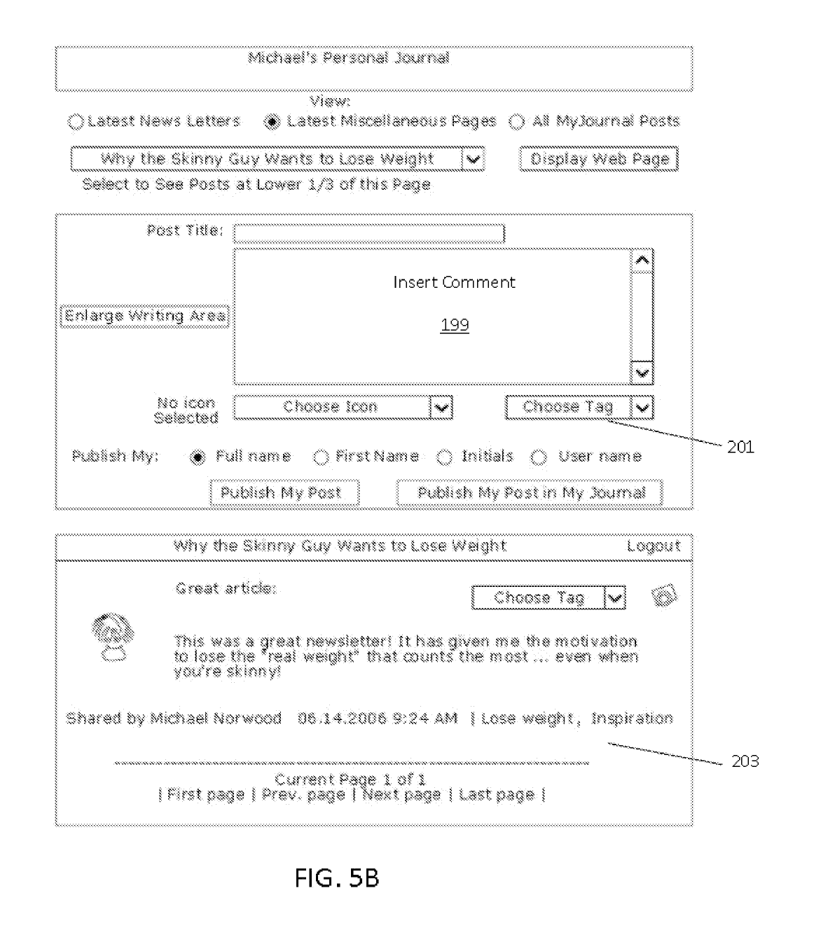

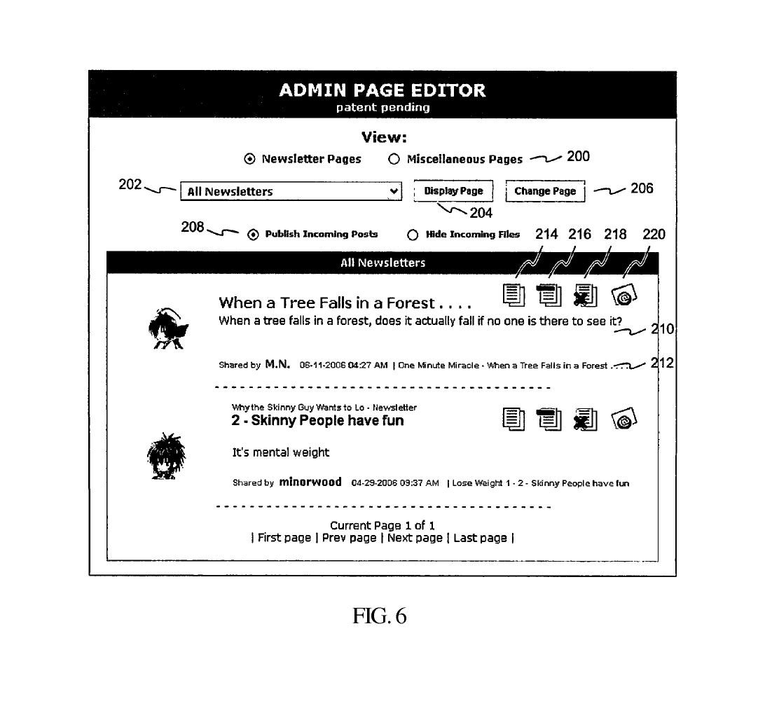

Referring to FIG. 5, a personal journal screen shot according to an exemplary embodiment is shown. This screen displays the end user's personal journal resulting from the sign-up process of FIG. 3. At the top of the page, the end user's first name automatically appears indicating <end user's first name> personal journal 170. Radio buttons 172 allow the end user to choose the web page to which he or she would like to post a comment. The end user may also choose to view the previous posts he or she wrote. This option displays every post the end user previously entered on every newsletter or other web page the administrator has made available for postings. A pull down menu option 176 displays all the web pages with titles entered by the administrator in the title field of the administrator page creator based on the radio button 172 selected. A display web page option 174 allows the end user to see a popup of the display page where his or her posts will be appearing. The title next to the display web page option automatically reflects the title that the end user selected from the pull down menu 176.

Posting data fields are in the middle section of the screen. The end user may provide a title for his or her post in a post title field 180. A comment field 182 is where the end user enters his or her actual post. An enlarged writing area option 184 results in a popup that provides the end user with an enlarged writing area to compose his or her comment. The end user can adjust this writing area to any comfortable size including full screen. It automatically adjusts the writing area field proportionately to whatever size the end user desires the page to appear on his screen. A choose icon pull down menu 186 allows the end user to choose from the icons the administrator entered in the “add icons for posts” field of the administrator page creator screen (FIG. 4). The end user may choose from a selection of four radio buttons 188 to have his or her full name, first name, initials, or user name published on the public display page. Publishing options 190 include a public posting option and an option to publish the post only in the end user's private journal.

Post fields appear at the bottom of the screen. The newsletter/miscellaneous title 194 listing reflects which newsletter or miscellaneous page the end user selected previously. The title listing reflects the title the end user chose from post title field 196. The comment field has the content entered previously by the end user. Next to the comment field is the icon selected by the end user. The identifier reflects the name option selected previously 198.

Referring to FIG. 6, an administrator page editor screen shot according to an exemplary embodiment is shown. Using this screen an administrator may monitor incoming end user posts created in the comment areas. The administrator may select a newsletter or other page 200. Pull down menu options 202 display the web page titles entered by the administrator for the selected newsletter or other miscellaneous page. A display page option 204 allows the administrator to view a popup of the display page for the selected title. A change page option 206 allows the administrator to view a popup of the original administrator page creator to change any item previously entered on that page such as titles, keywords, and auto responder codes. The selected title is displayed in the pull down menu option 202 and the administrator can select an option to display new posts or to hide new posts 208 depending on whether posts entered by end users should be automatically posted onto the display pages, or if they first should be manually approved for publication by the administrator. Hidden posts receive a grey background so the administrator knows at a glance they are hidden.

Each end user post may be displayed in a separate portion of the screen. The icon the end user selected appears with his or her post 210. The title 210 selected by the end user is displayed as well as the end user's comment 210. Also shown is the identifier 212 (name, initials, user name) selected by the end user. A publish option 214 enables the administrator to allow the end user's post to appear on the display page if the administrator had previously chosen to hide this post either via a hide post option 216, or the hide new posts option above 208. The hide post option 216 enables the administrator to hide any individual end user post from appearing on a display page. The entire post appears with a grey background when it is hidden so the administrator knows at a glance it is hidden. A delete post option 218 permanently deletes the post. An email-a-friend option 220 results in a popup that enables the administrator to email the end user who wrote the post (e.g., to thank them for posting, to ask permission to quote his or her post, etc.)

Posts may be selected (e.g., by selecting a checkbox next to each post) for printing, to appear in an eBook, or for other functions. A post counter may be used to tell the administrator how many total posts were received for each newsletter or miscellaneous web page.

End user comments areas defined by administrators and comments entered by end users (readers and television content viewers) are hosted on a server and stored in database remote from the administrator's web site. An “iFrame” is used to allow this remote hosting. The iFrame provides a simple “window” to the database where all end user comments are actually entered, stored, and posted. However, in order for the actual “text” in the posts of the end user comment areas stored on the database to become part of the text on the local web site of the administrator, different formats for input and output are used. An “iFrame” is used for the actual input data fields while XML code is used for output data (the posts themselves). It is important for the actual text of the posts to be a part of the local site (i.e., the administrator's web site) rather than just being reflected there so that the administrator gets the benefit of using incoming posts for search engine optimization. The administrator does not receive this benefit if the text in the posts is not actually on the local site and remains solely in the remote database. By using iFrames for input and XML code for output, the administrator may have continually fresh keyword-rich content added to his or her site via end user posts.

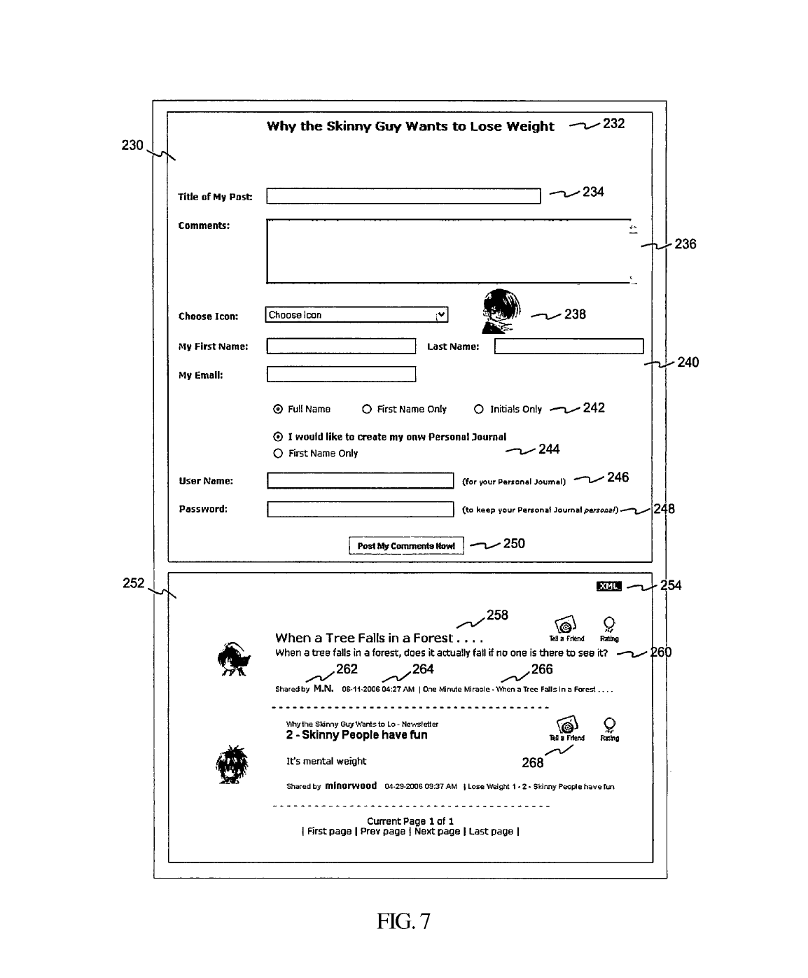

Referring to FIG. 7, a display page screen shot for an exemplary embodiment is shown. The display page is the page that is created for public viewing. It is the page that results when an administrator uses the administrator page creator component to create comment areas for pre-existing web pages. Typically, the administrator places code generated in the administrator page creator below any pre-existing content on a web page to allow the comment areas and posts to appear at the bottom. The administrator can also place code for the comment areas in such a way that the comment areas appear at the very top of the page or any other area of the page relative to the pre-existing content. The web page content with the inserted code is then saved for posting at a web site. In FIG. 7, the title 232 is the only pre-existing content appearing above the comment area on this particular web page.

The display page comprises a comment input section 230. The end user enters comment data in this section of the display page. In the title field 232, the end user provides a title for his or her post. The end user enters his or her actual comment in the comment field 236. The end user can select an icon from the icon pull down menu 238 which has the icons the administrator originally uploaded in the administrator page creator. The end user enters a name in the name field and an email address 240. The end user can select an option for publishing his or her full name, first name only, or initials 242. The user name options from the personal journal page are not available on the display page because end users coming to the display page may not yet have signed up for a personal journal, and therefore, do not have a user name.

If the end user then chooses an option to create a personal journal 244, JavaScript Show-Hide Layer Code allows the appearance of the otherwise invisible user name and password fields 248. The end user chooses a use name for logging onto his or her personal journal and a password. These user name and password fields 248 remain hidden if the end user chooses a “just post my comments below without creating my personal journal” option 246. The end user's comments are posted with the selection of a post comments option 250.

The display page also comprises a comment output section 252. The post fields appear at the bottom of the display page in the comment output section. The most recent end user's post is posted first on the page rather than last. The advantage of publishing the most recent end user's post first is the immediate gratification it gives the end user of being “headlined,” versus stuck at the bottom of the webpage. An RSS option 254 enables web site visitors to create RSS feeds of the incoming posts on his or her own web sites if they like, or to view in other RSS-viewable places (e.g., choosing different RSS feeds is one of various preferences available to Yahoo.com's users). This option support further promotion of the administrator's web site.

The icon 256 for the post reflects the icon selected by the user from the icon pull down menu 238. The title 258 reflects the title entered by the end user previously in the title field 232. The comment 260 reflects the content entered by the end user in the comment field 236. The identifier 262 reflects the end user's choice for identifying his or her posts 242. Because the posts here also reflect posts made by end users in their personal journals, the identifier may reflect the end user's user name per that option uniquely available to end users posting from a personal journal. The date and time labels 264 reflect the date and the time the end user's post was made. The keyword label 266 reflects the keywords the administrator chose in the administrator page creator screen (FIG. 4). The combination of the keyword label 266 and the title listing 258 makes a dynamic keyword-rich page thus making it highly optimized to receive search engine traffic.

A tell-a-friend option 268 displayed next to each post results in a tell-a-friend popup. This feature enables the end user to email any post to multiple friends, which brings more traffic to the site. A rating option 268 may also be added next to each post to allow the end user and other visitors to rate every post on the page (e.g., 1=I didn't like this post; 2=I liked this post; and 3=I loved this post!). This option enables the administrator to create a contest for web page postings. As an incentive to get end users to write more posts, the administrator can award prizes to the top-winning end user poster for a given period of time.

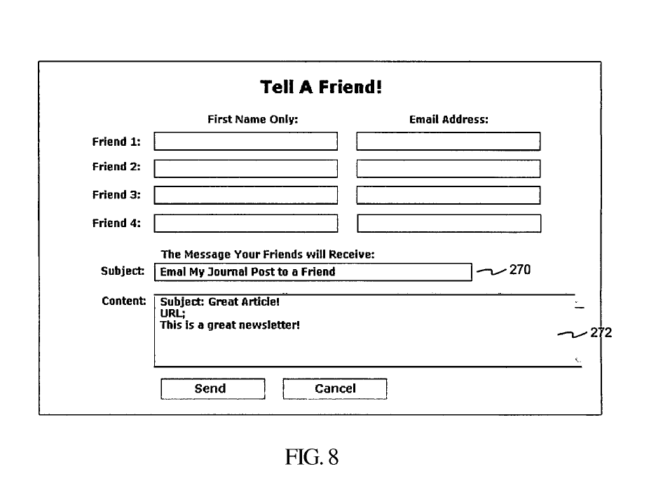

Referring to FIG. 8, a tell-a-friend screen shot according to an exemplary embodiment is shown. This figure shows a standard tell-a-friend script that enables the end user to simultaneously email multiple friends to tell them about the web site they have just visited. It is coupled directly to the posts generated by end users. The entire tell-a-friend page can be made to automatically appear in a popup window when an end user enters a post on the display page or in his or her personal journal. The administrator page creator screen allows the administrator to automatically provide a subject line for the message 270 and to type any message into the message field 272 of the tell-a-friend page to provide the end user with a readily available message for the end user to tell a friend. The message includes a dynamically-generated URL that refers the end user's friend to the dynamically-generated “look-at-me-page” (as described below) which always highlights the end user's post.

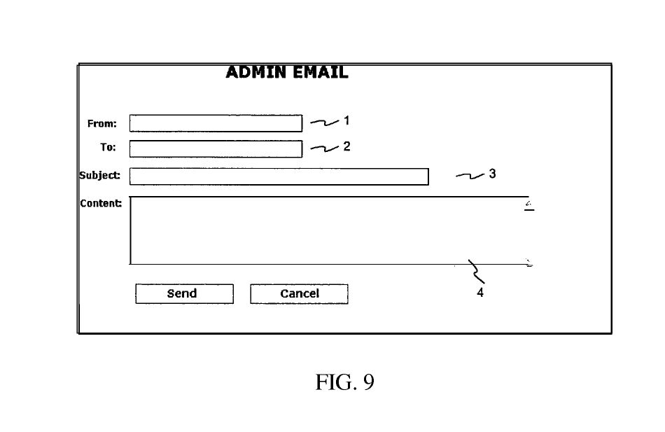

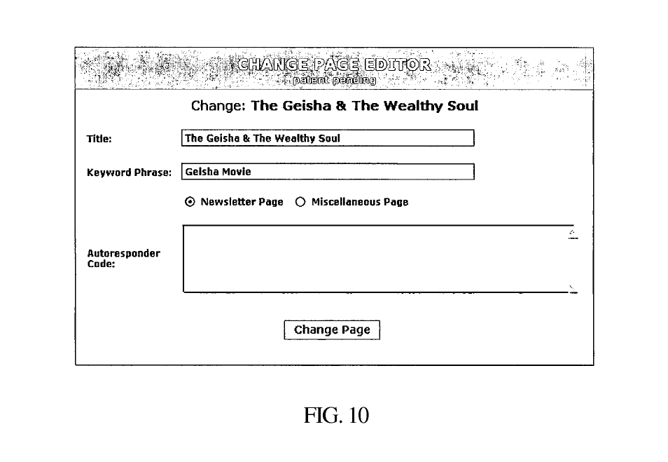

Referring to FIG. 9, an administrator email screen shot according to an exemplary embodiment is shown. This figure shows a standard email script that enables the administrator to email the specific end user who made a post. The administrator selects an email option from the administrator page editor screen. The email option of the administrator page editor is linked for easy use to every post generated by end users. The “From” field is automatically populated with the administrator's name and email address. The “To” field is automatically populated with the end user's name and email address obtained when the end user made his or her first post either on the display page, or when he or she signed up for a personal journal on the login/sign-up screen. The content field can be made to automatically populate with any script the administrator entered into the administrator page creator. In the administrator page creator, any message can be input and automatically sent to every end user making a post.

Referring to FIG. 10, an administrator change page editor screen shot according to an exemplary embodiment is shown. This screen is virtually identical to the administrator page creator of FIG. 4. An important difference is that all of the fields are auto-populated with the information the administrator previously entered to create a specific page. This change page editor screen allows the administrator to update or change previous settings appearing on the display page of FIG. 7. The change page editor screen is accessible to the administrator via the change page option on the administrator page editor screen of FIG. 6.

A “look-at-me page” may be virtually identical to the display page of—FIG. 7 except for its URL. The URL for the “look-at-me page” is dynamically generated, and it features the end user's posts at the top of the comments section, highlighting them in any variety of ways such as by displaying them in different background colors and designs compared to the other posts, or bordered by stars, in bold, etc. The end user may be provided with various options for highlighting his or her own posts. The end user may also choose which posts to make public and which to keep private. End users may be much more inclined to publicize their own posts if they can personalize them for others. It also results in promotion of the administrator's site using the tell-a-friend feature in FIG. 8 because the end user's post is the highlight of the “look-at-me page.” The feature allows the end user to perform the functions of a “secondary administrator” and promote greater use of the primary administrator's web site thereby greatly increasing the primary administrator's traffic.

A contest generator page hosts the results of end-user post rankings using web site visitors' ratings of the various posts via the ratings feature on the display page of FIG. 7. It features a list of numerically ranked end users names according to his or her scores, highest to lowest. An administrator area of this page contains another entry field that allows the administrator to specify date ranges within which to calculate the scores. Another entry field allows the administrator to specify how many points he or she wants each end user to automatically receive per each post entered. This approach rewards people who post frequently, thus encouraging active participation of end users. The administrator can determine what prizes will be rewarded for each winner.

A “create blog” feature allows each end user to create a blog that displays just his or her posts, and just the ones they choose to make public via checkmark boxes that appear next to each of his or her posts. The end user performs the functions of a “secondary administrator,” and promotes greater use of the primary administrator's web site thereby greatly increasing the primary administrator's traffic.

An eBook feature allows each end user to create an eBook of all his or her unique “look-at-me” pages. The end user chooses which posts to include in the eBook. This feature automatically puts all selected posts into an MS Word format or a pdf. format, per his or her own choosing. It also includes various cover template designs, table of content designs, and overall book designs. The administrator may also be eBook creator by creating ebooks of comments. The ebooks may be sold or distributed as a “virtual marketing tool.” End users whose comments appear frequently in an eBook may be inclined to distribute the eBook to others.

An end user greeting card creator feature enables the end user to send his or her posts as virtual greeting cards. This feature may be used in addition to or instead of the tell-a-friend emails and provides another dynamic marketing tool for the administrator's web site.

A comment rotator and emailer feature allows an administrator to rotate posts appearing at the top of each web page. The posts may be rotated daily or more frequently throughout the day. An email may be sent automatically to each particular end user at the time his/her post is headlined. This feature creates a reason for the end user to revisit the web page and to refer friends to it.

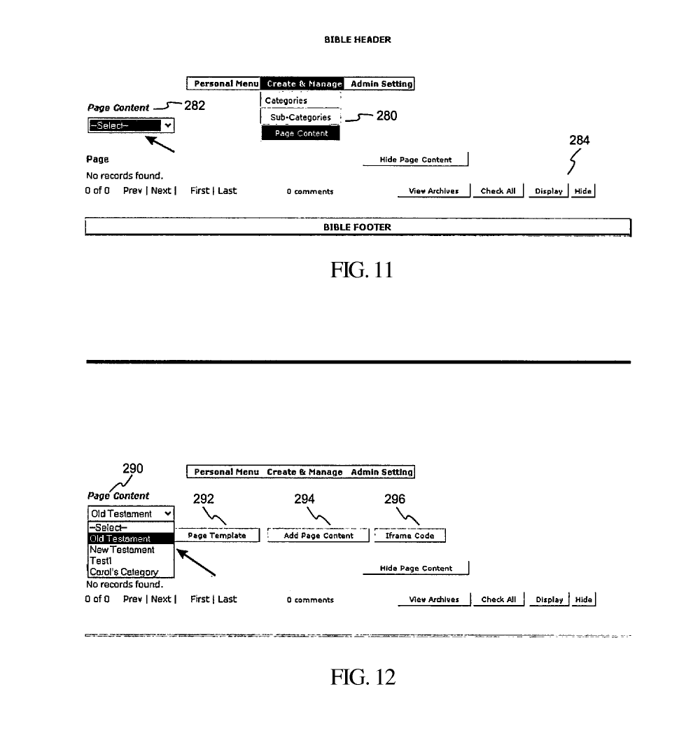

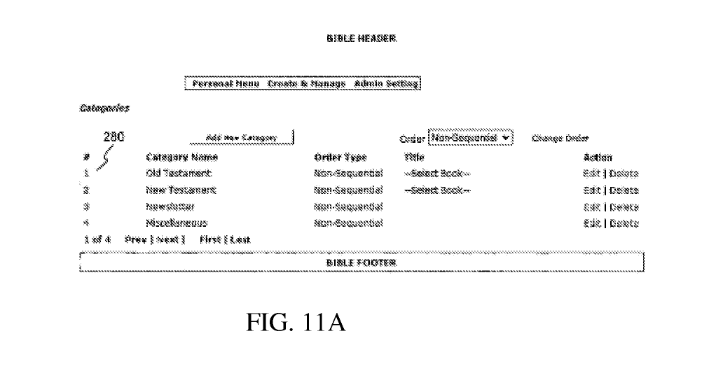

Referring to FIGS. 11-16, screen shots for administrator category creation according to an example embodiment. The administrator may create categories, subcategories, and page content as he or she chooses so that the administrator can use his or her own preferred way of classifying the web pages for a site. Referring to FIG. 11, the administrator selects “categories,” “sub-categories,” or “page content” from a create and manage menu 280 in order to create a preferred classification for web pages. The administrator may create a plurality of categories and sub-categories from which to choose when creating and classifying web pages. The web page classification also facilitates end user selection of content for which the end user would like to provide comments. The administrator selects a category or sub-category to be associated with web page content 282. Additional options for managing created web page content include options for viewing archive pages, selecting pages, and displaying/hiding pages are also provided 284.

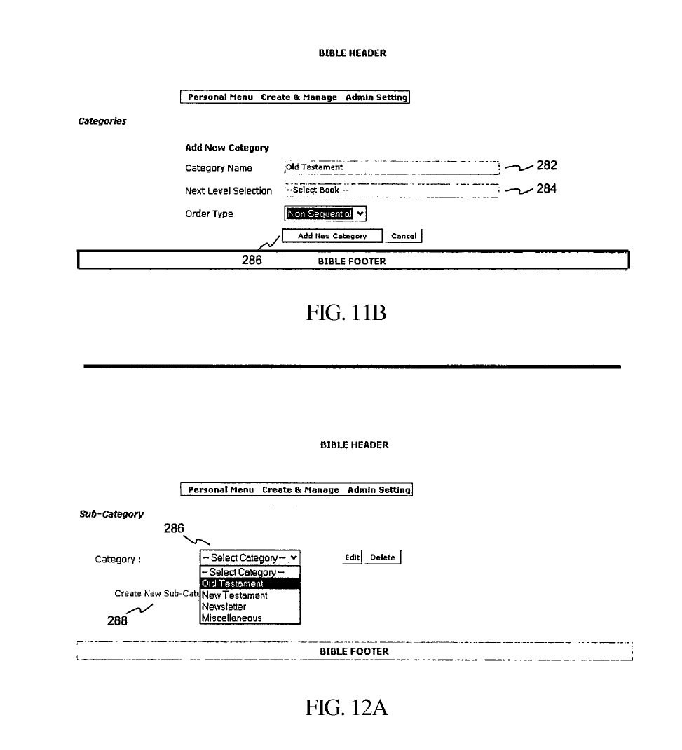

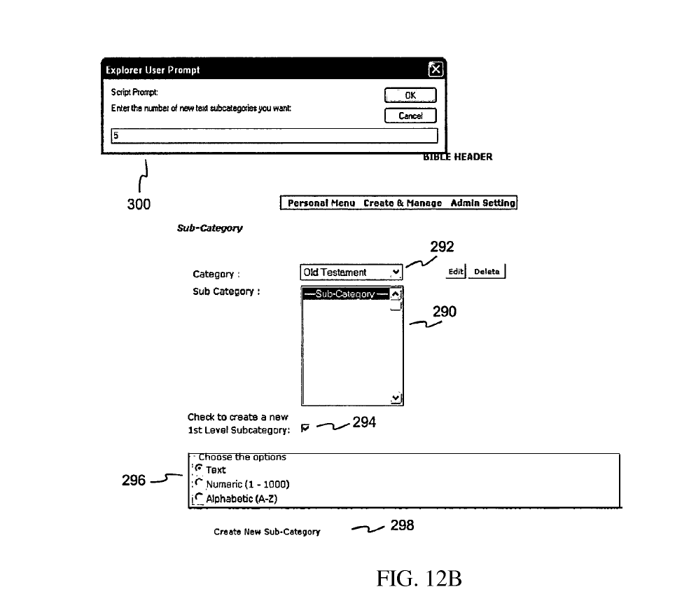

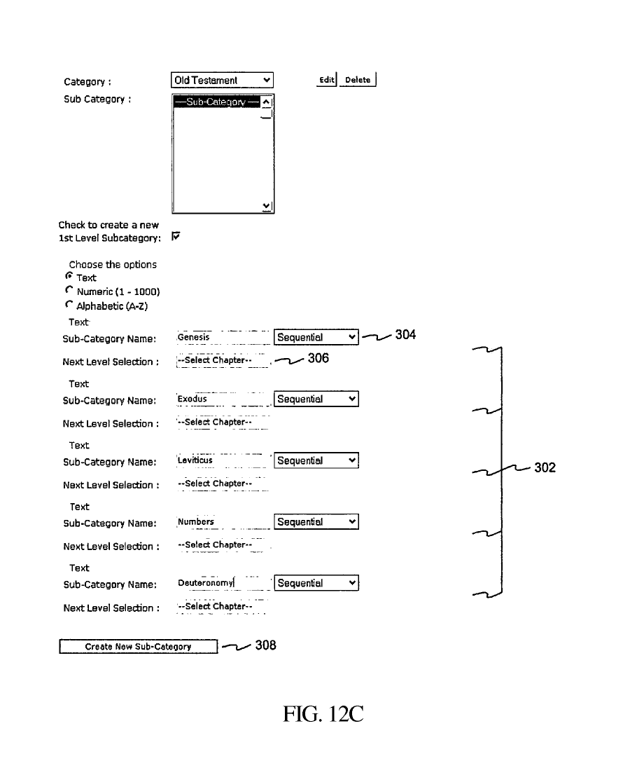

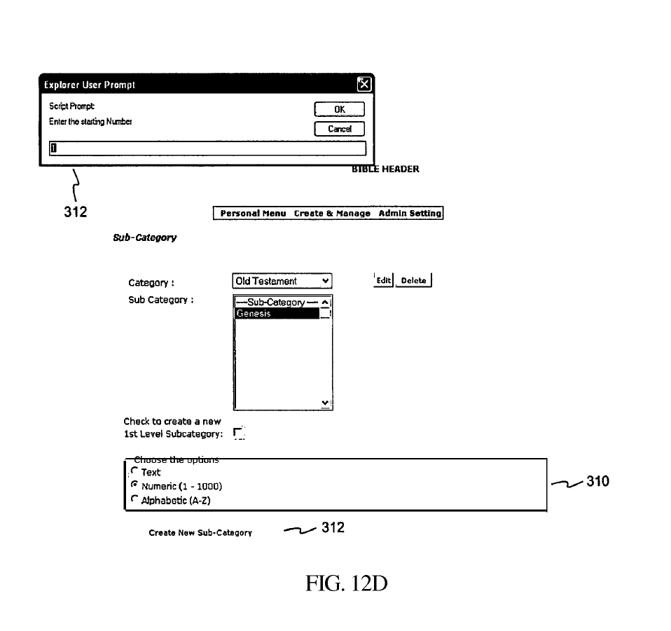

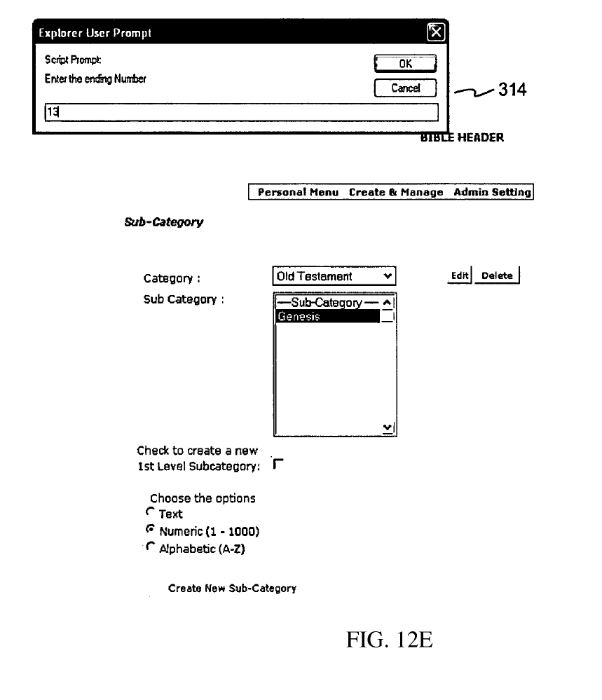

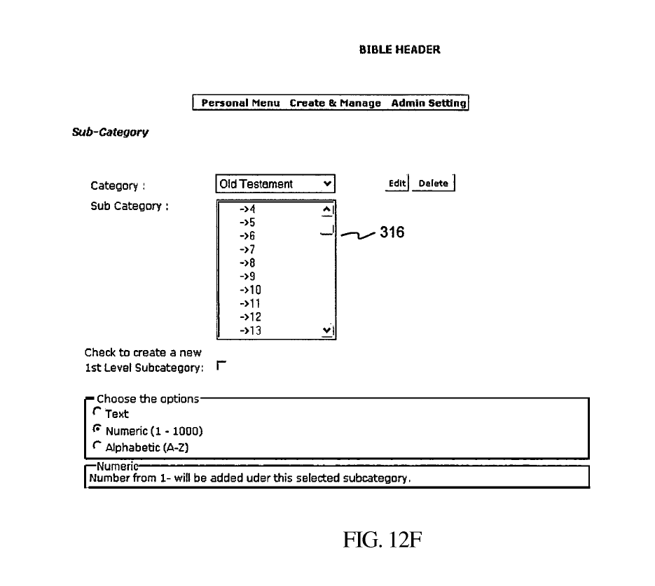

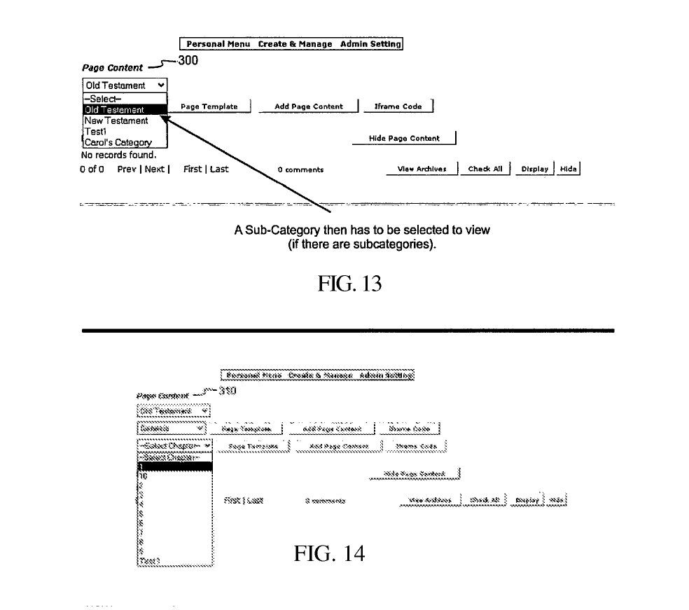

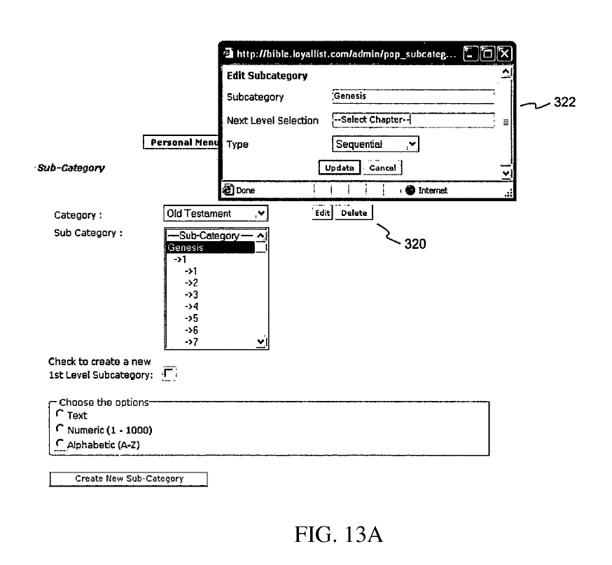

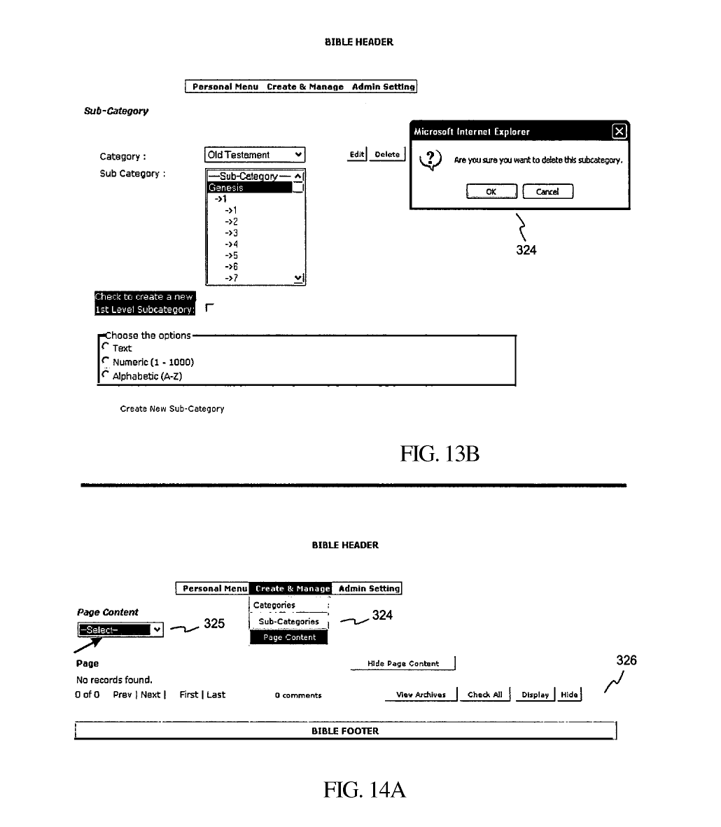

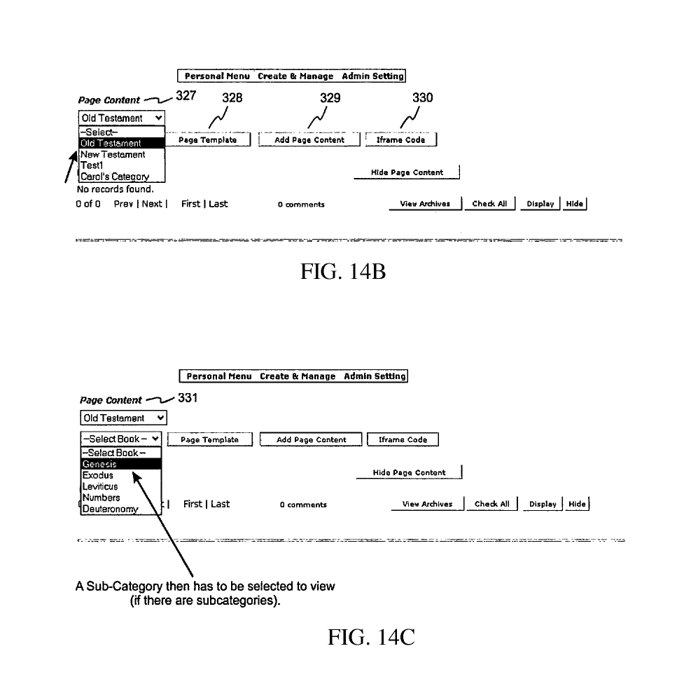

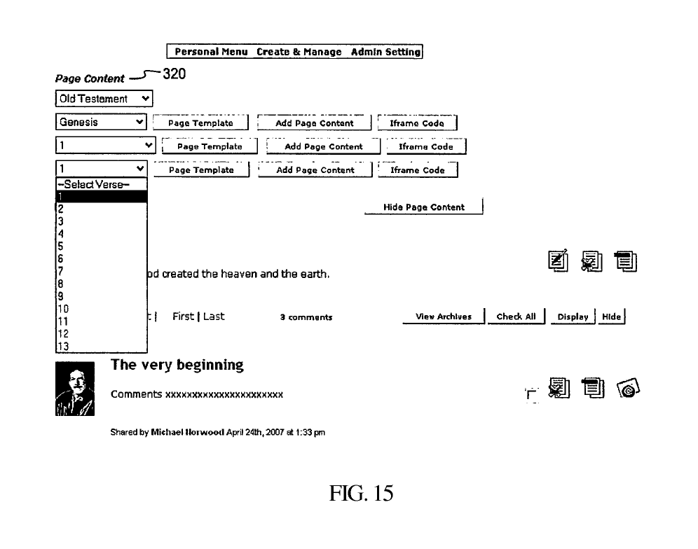

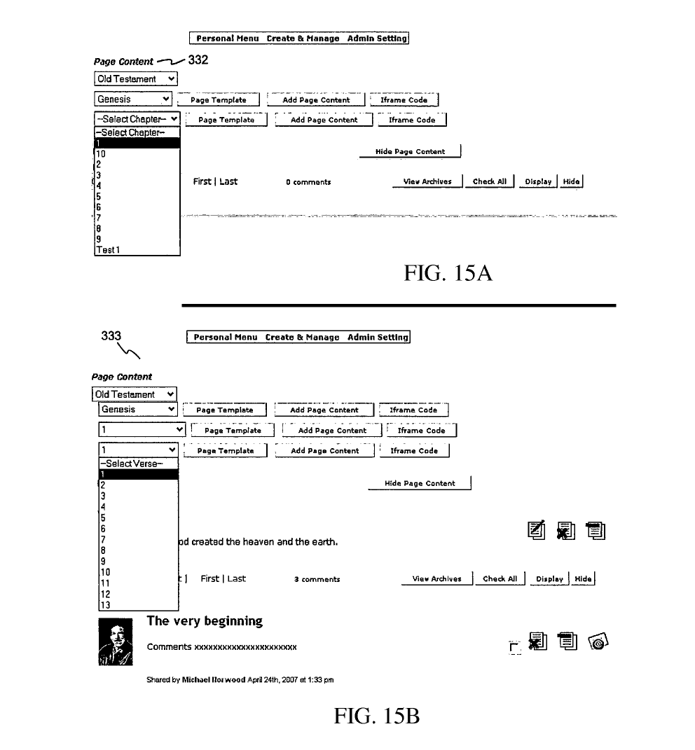

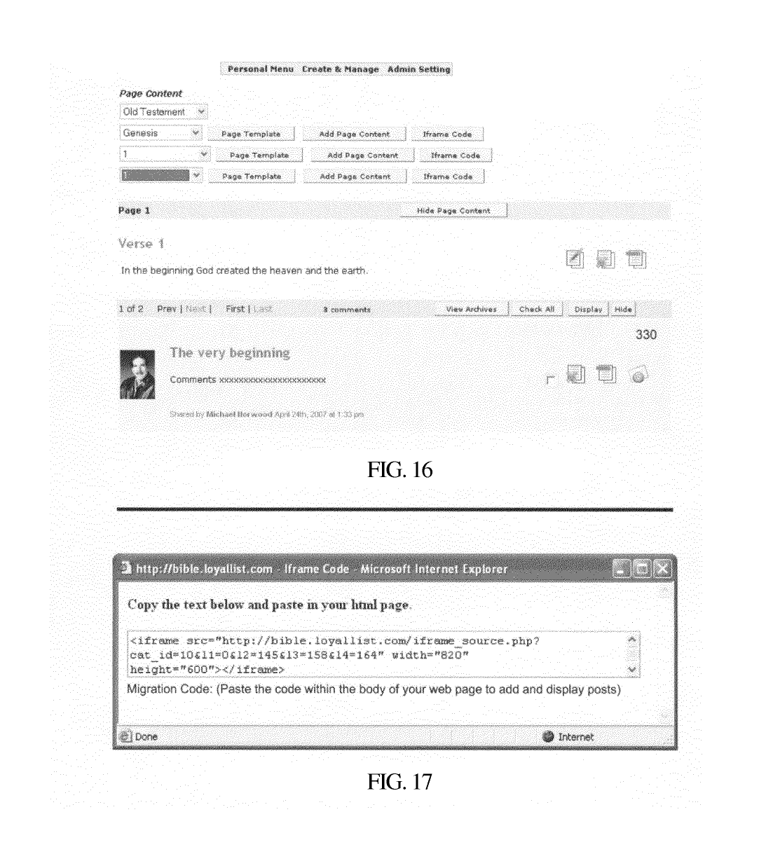

Referring to FIG. 12, the administrator selects a category 290 (e.g., “Old Testament.” The administrator may further select a page template 292 for creating the web page, an option to add page content 294, and an option to add iFrame code 296 to a web page to create a comment area on a web page associated with the specified category. Referring to FIG. 13, following selection of the category, the administrator may select a first sub-category 300 (e.g., “Genesis”). Referring to FIGS. 14 and 15, additional sub-categories may be selected (e.g., “Chapter 1” 310 and “Verse 1” 320). Referring to FIG. 16, the administrator may then specify content to be associated with the specified categories and sub-categories 330. Referring to FIG. 17, sample iFrame code according to an exemplary embodiment is shown. The iFrame code to be associated with the specified content is generated so that it may be added to HTML code for the web page. The iFrame code provides access to the comment area for the specified portion of the web page. Comments provided by end users are then associated with the specified portion of the web page through the comment area. When comments are entered by s of the web site, they are saved in a database remote from the administrator's web site.

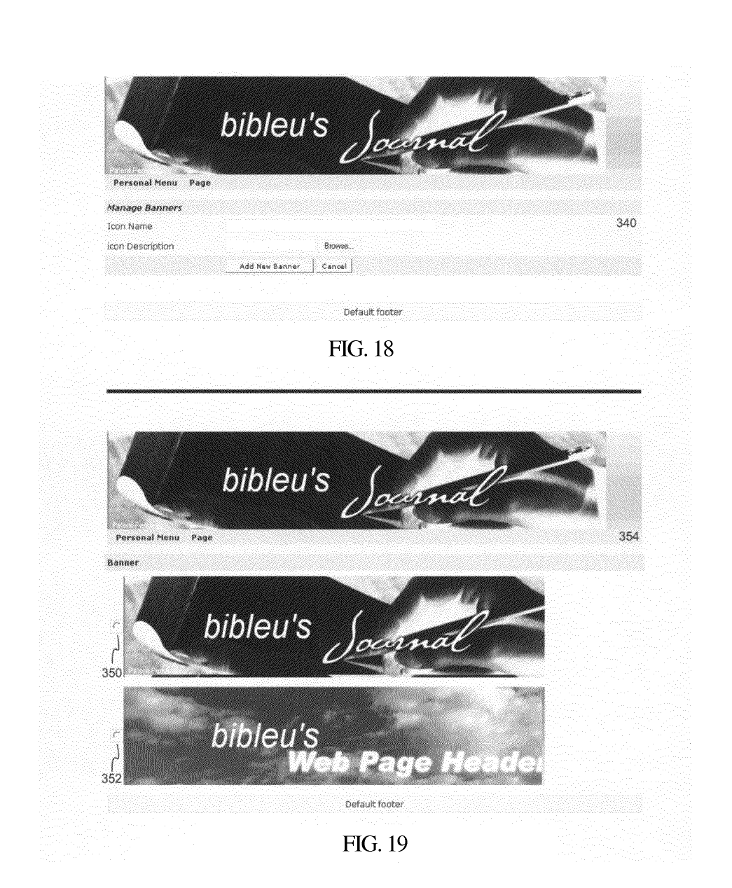

Referring to FIGS. 18 and 19, screen shots for creating and managing banners according to an exemplary embodiment are shown. Referring to FIG. 18, an administrator can define various icons 340 to be used as banners for a web page. Referring to FIG. 19, an administrator can select a banner 350, 352 to be used in association with a specified web page. The selected banner may be displayed at the top of the page.

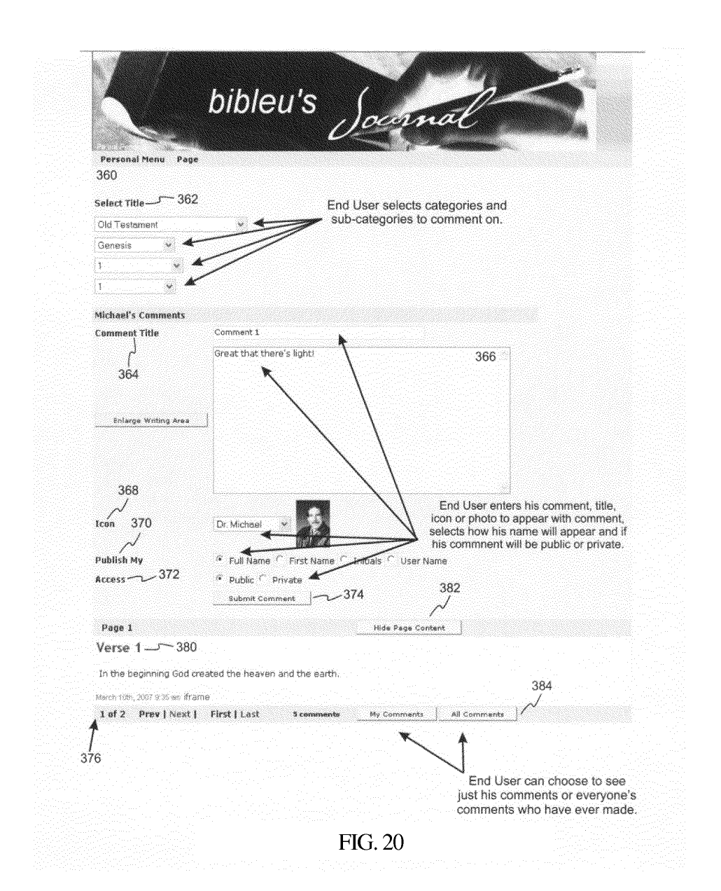

Referring to FIGS. 20-22, sample end user comment screen shots for an exemplary embodiment are shown. The screen may comprise a comment input section 360 and a comment output section 376. Referring to FIG. 20, using the categories and sub-categories defined by the administrator, the end user can specify a category and sub-categories to select a portion of a web page on which to comment 362. In the comment area of the screen, the end user specifies a comment title 364 and enters his or her comment in a text area of the screen 366. The end user may further specify an icon to be associated with the comment 368. The end user may also specify an identifier to be associated with the comment 370 (e.g., full name, first name, initials, or user name). The end user may also decide whether to make his or her comments public or private by specifying an access option 372. After providing the requested input, the end user selects a submit comment option 374 to post the comment publicly or privately depending upon the access option selected.

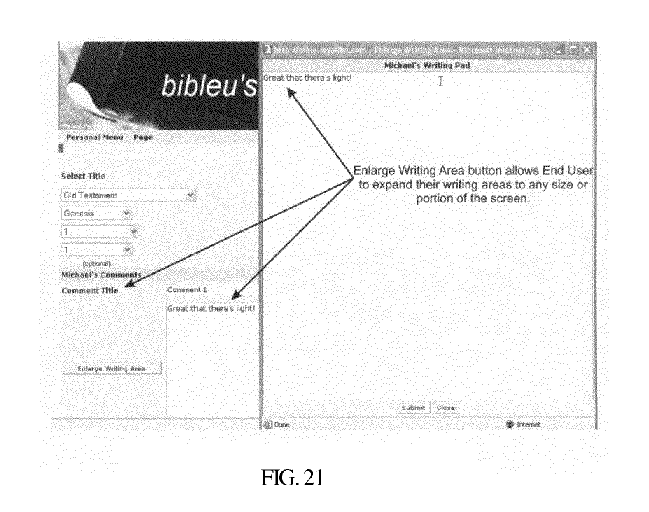

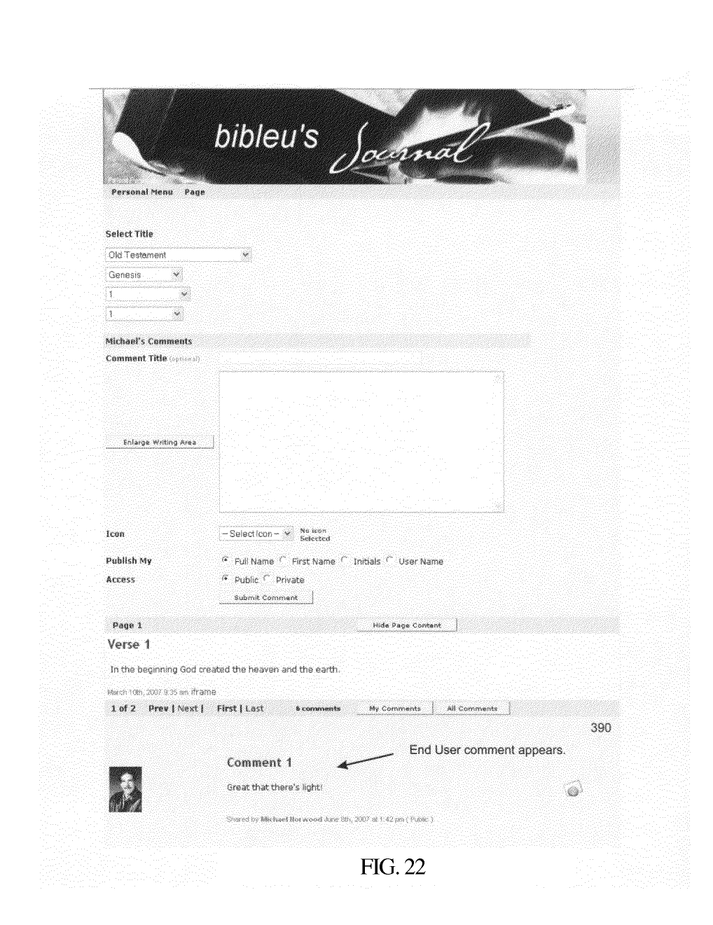

The end user's comment is displayed in the comment output section at the bottom of the screen 376. The comment is displayed 380 along with a time stamp indicating when it was entered. The user may select an option to hide the comment once it has been entered 382. The end user can also choose to see only his or her comment or all of the comments entered by other users 384. Referring to FIG. 21, a screen shot for an enlarged writing area option according to an exemplary embodiment is shown. Referring to FIG. 22, another sample end user comment screen shot according to an exemplary embodiment is shown. As shown in the output section 390, the end user's comment appears as it will on the display page for the web site.

Technical details related to the category/sub-category feature are as follows. AJAX framework (HTML_AJAX) controls AJAX functionalities. The code <?php $utils->get_category_list(‘slt_category’,“onchange=\”sendSubCategory(this.value);showOther( )\””);?>loads a list of categories in the Manage Sub Category page (manage sub category.php) page. A utility class is defined in a classes folder (root_folder/classes/utils.class.php) which is a collection of utility functions. This class has many functions including redirecting and displaying JavaScript message, and listing many other functions. The above function get_category_list( ) is defined in a root_folder/classes/utils.class.php file which will that takes some parameters and lists the all the categories made by the current administrator.

When the selection of items listed in the category dropdown list is changed, an onchange event (onchange=\“sendSubCategory(this.value)) is called in this function and this sendSubCateory(this.value) sends the selected item id to sendSubCategory(cat_id) javascript function defined in the current page. After the a value is passed to sendSubCategory(cat_id) function and parameter values are passed to the function, it hides the Options Panel and sub category Panel if the passed parameter value is 0. Otherwise it creates an instance of object of review class defined in root folder/ajax classes/review.class.php.

After the instance of object of review class is created using javascript, a last line of code defined in the function sendSubCateogry(cat_id) registers a php function loadSubCategory(cat_id,”) defined in review.class.php class file. While using HTML_AJAX framework in our program we have to register our user defined class to the ReviewServer defined in root_folder/ajax claases/auto server.class.php. After the loadSubCategory(cat_id) is called this function connects to the database and loads all the subcategories under selected category and return to the JavaScript. Again there is a function called loadSubCategory: function(result) which is a part of HTML_AJAX. This retrieves the HTML and reloads the sub category drop down box. The options panel is also visible.

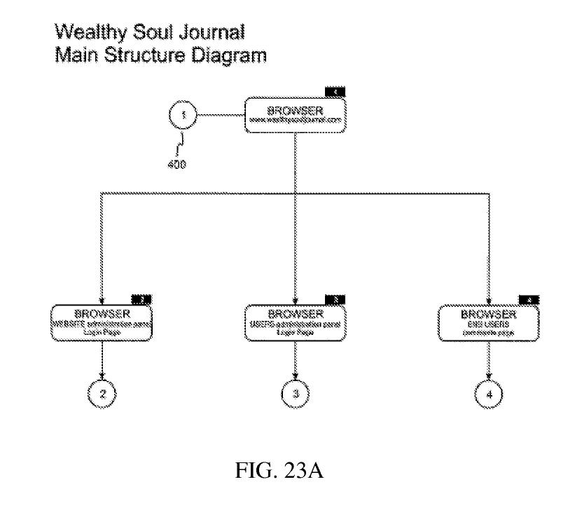

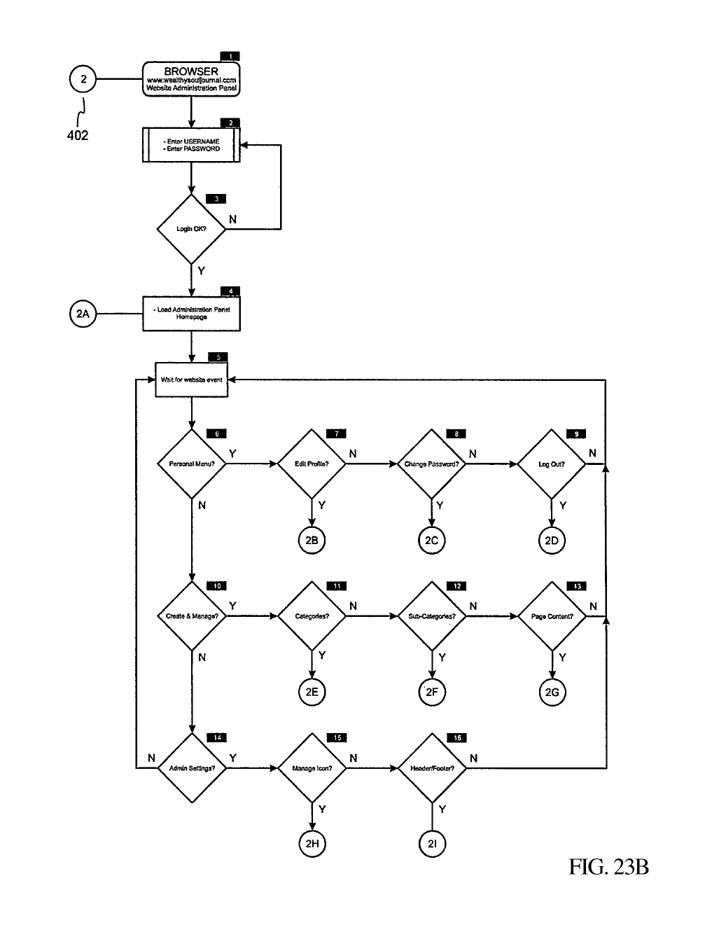

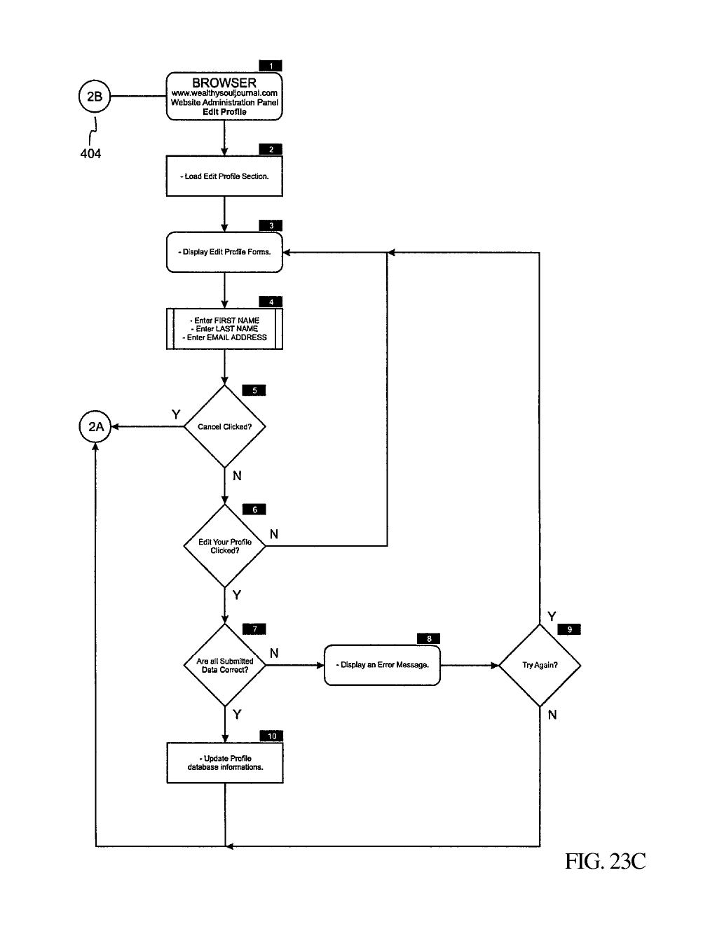

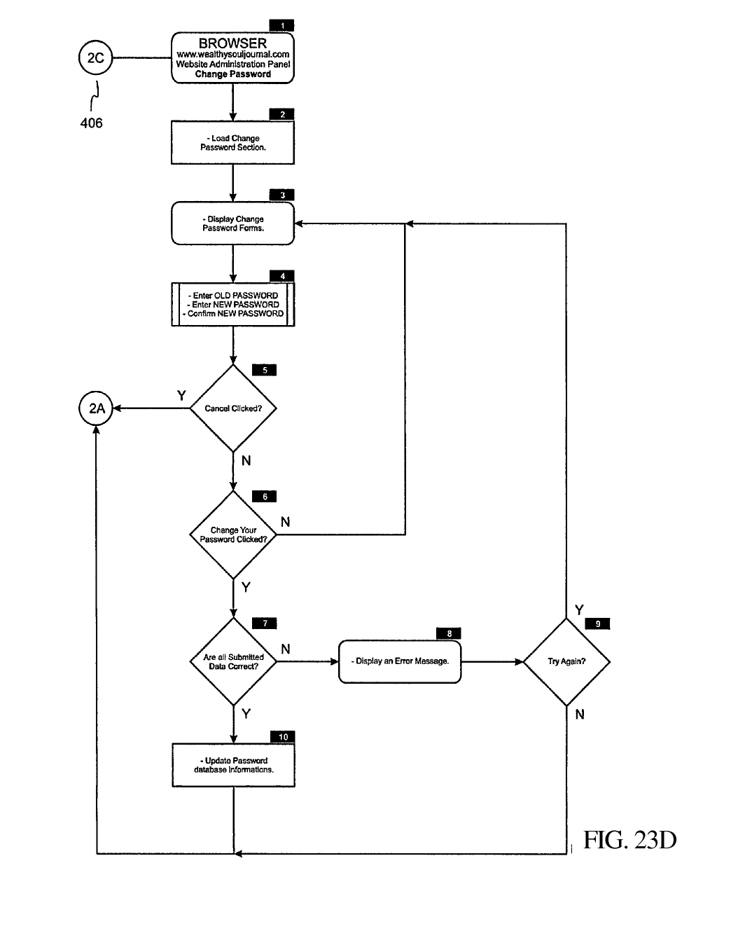

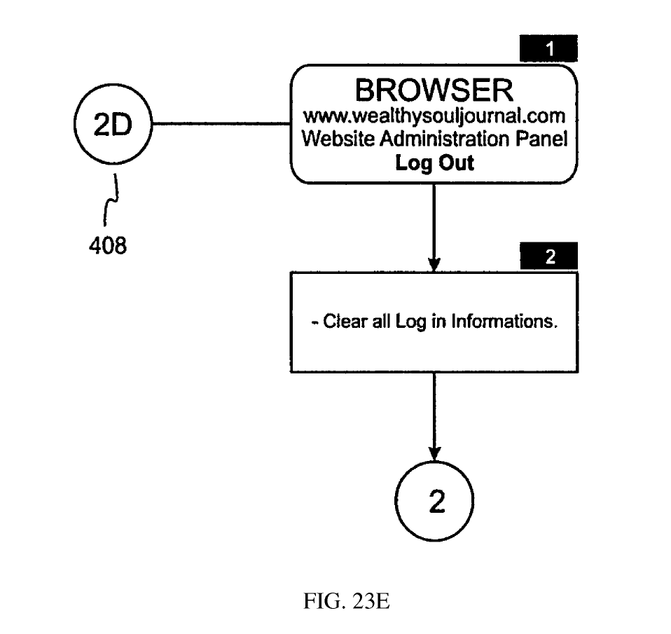

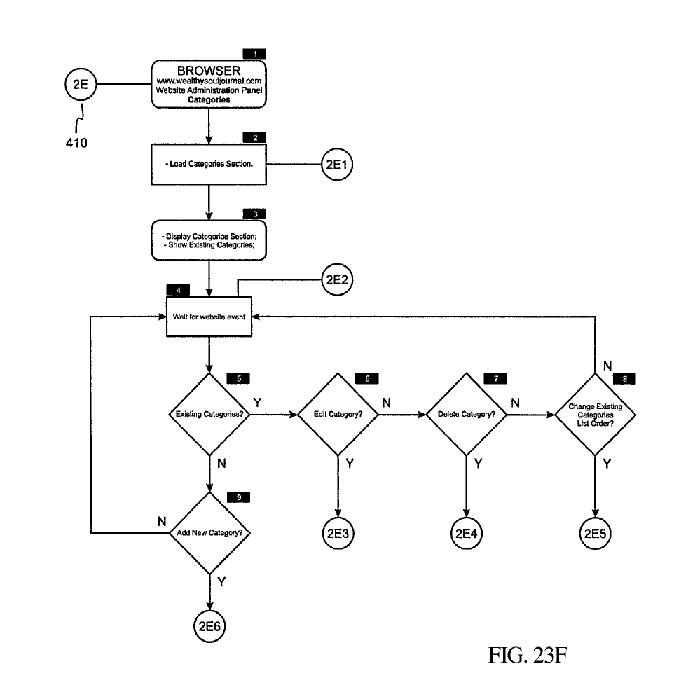

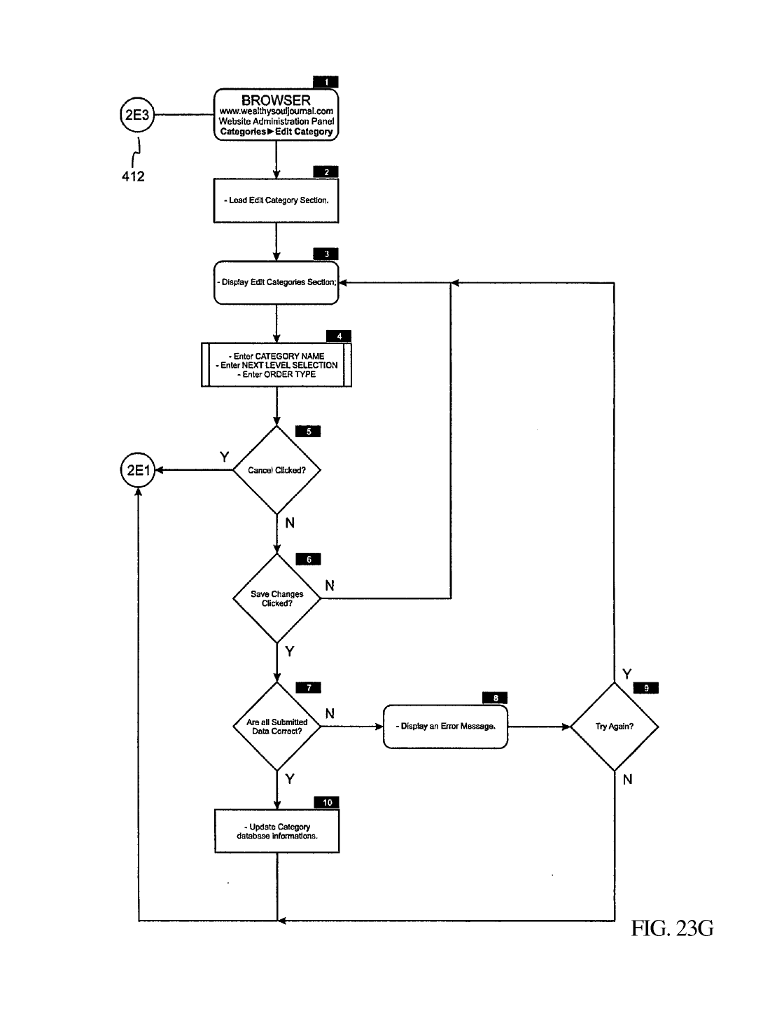

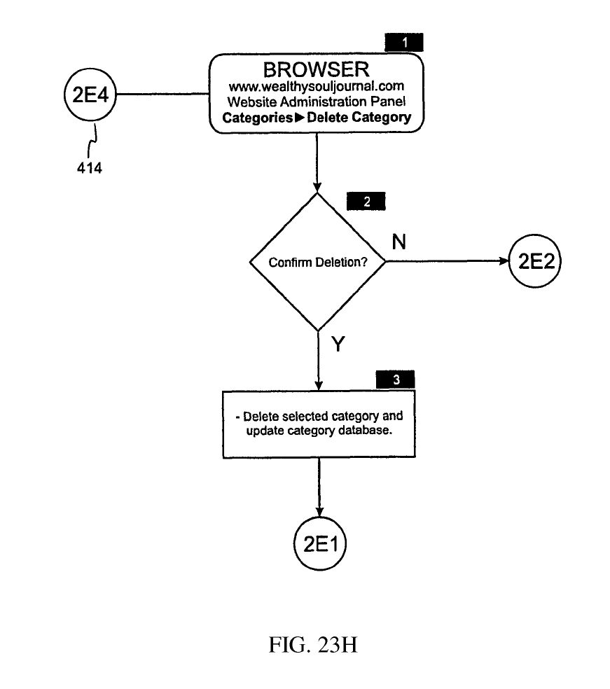

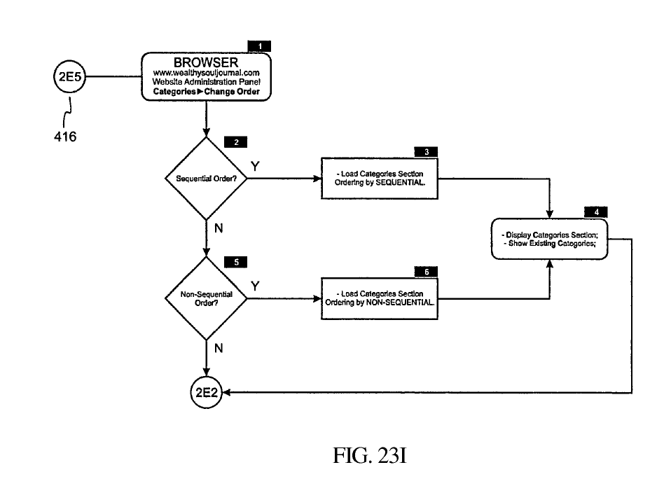

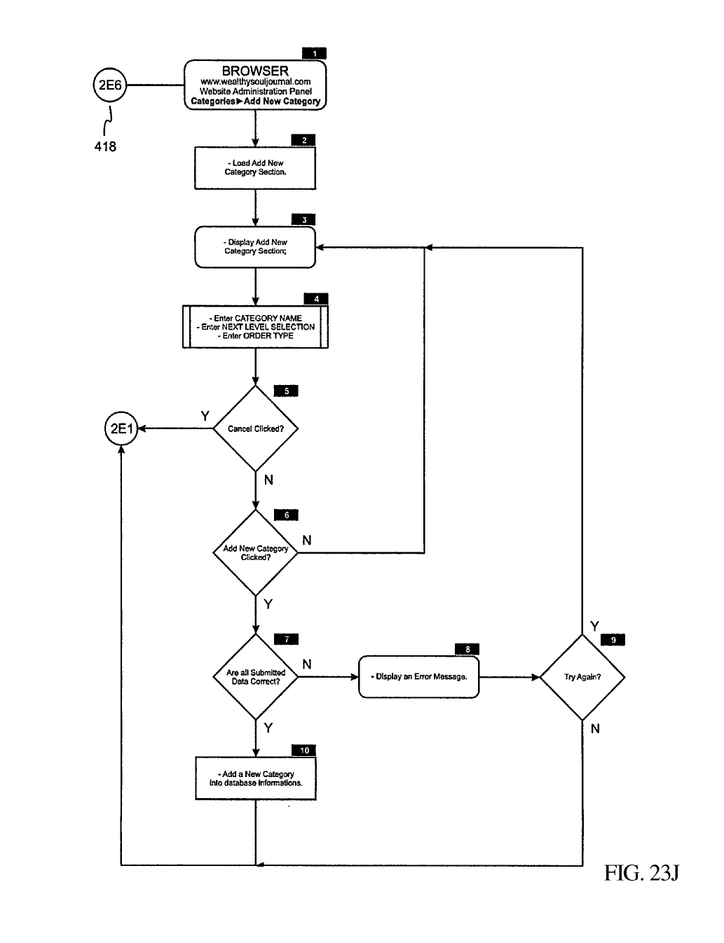

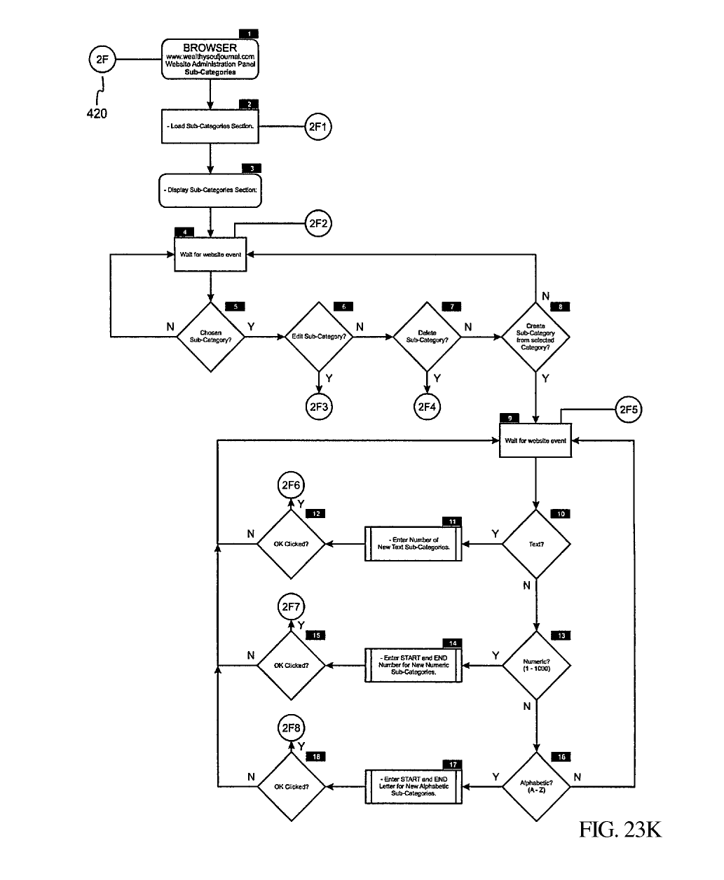

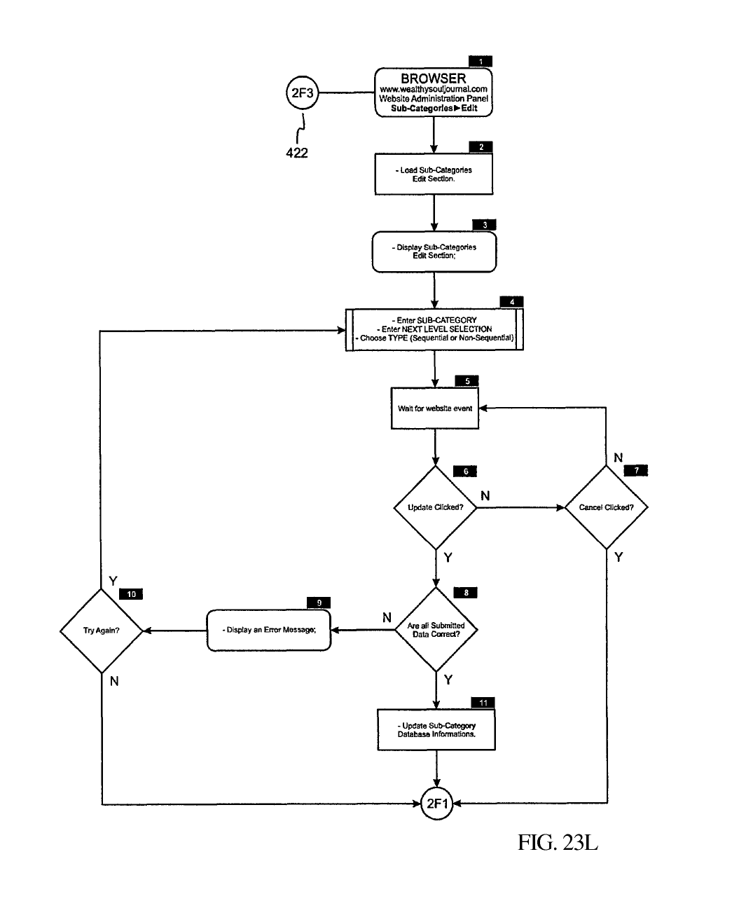

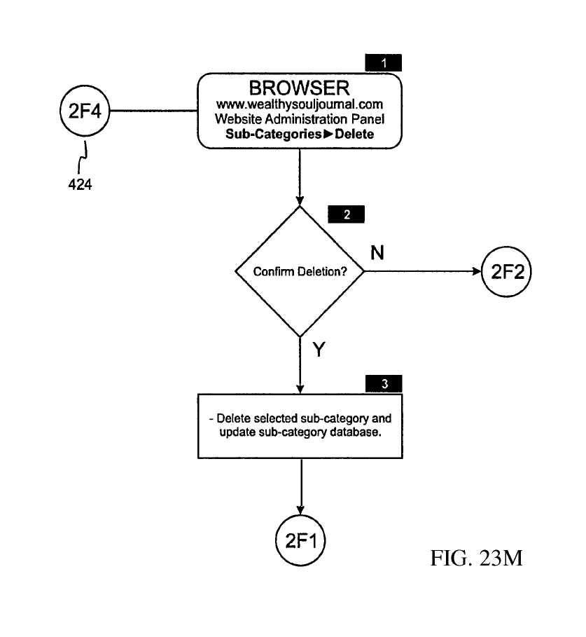

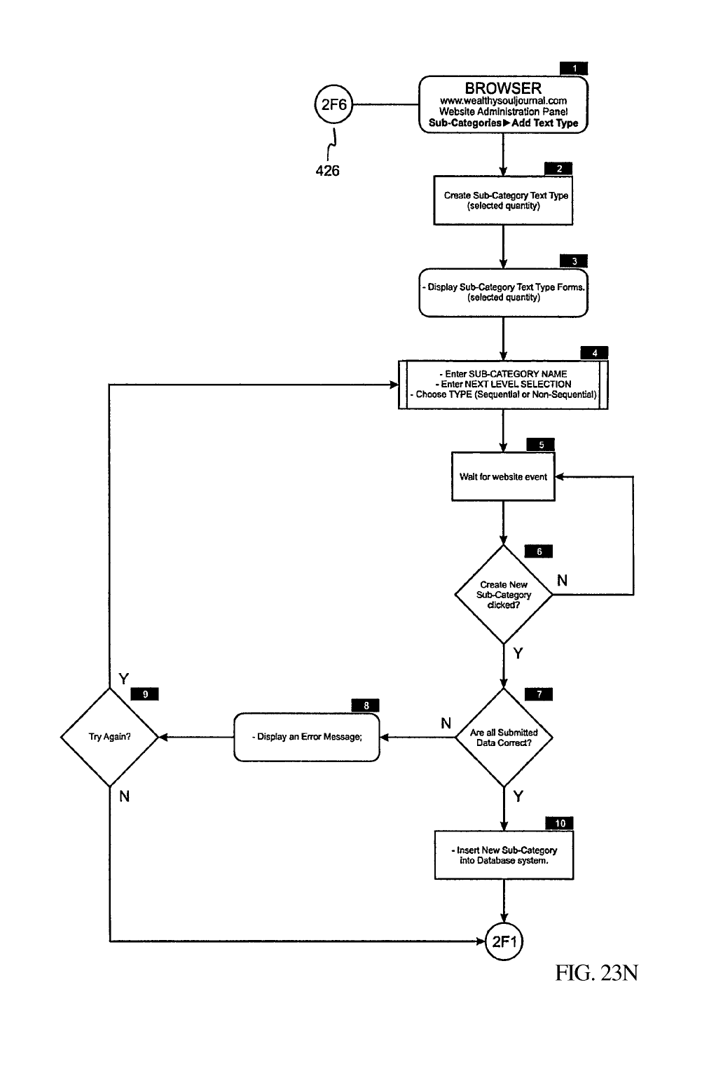

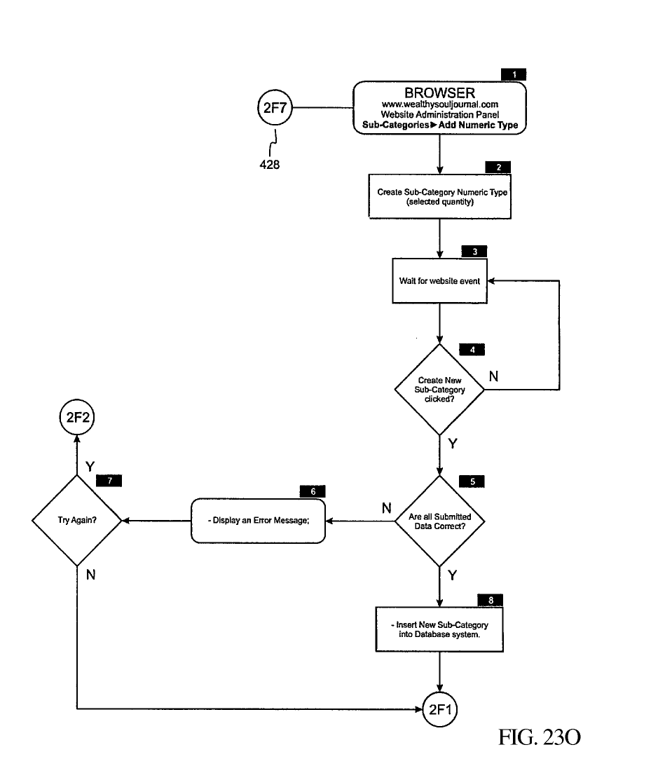

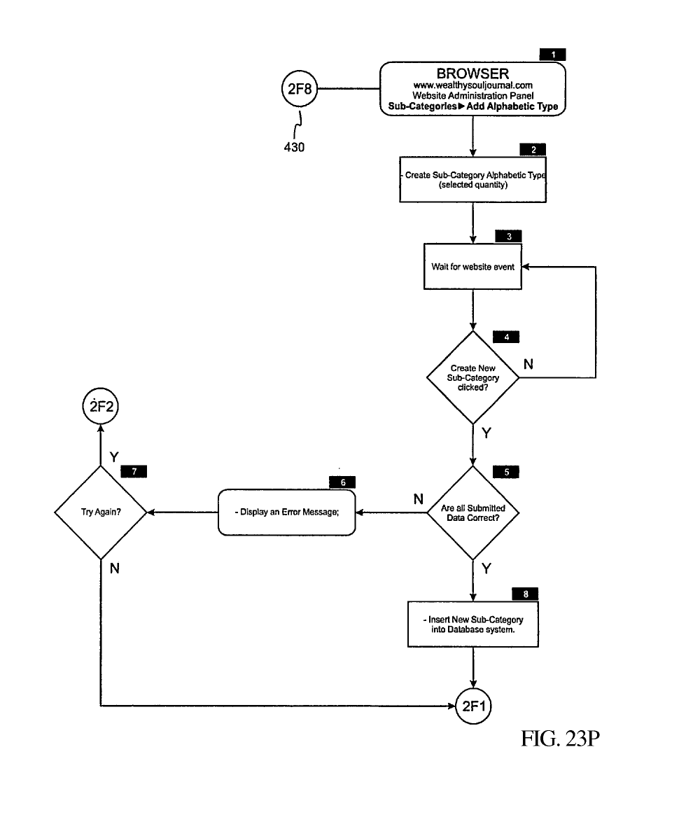

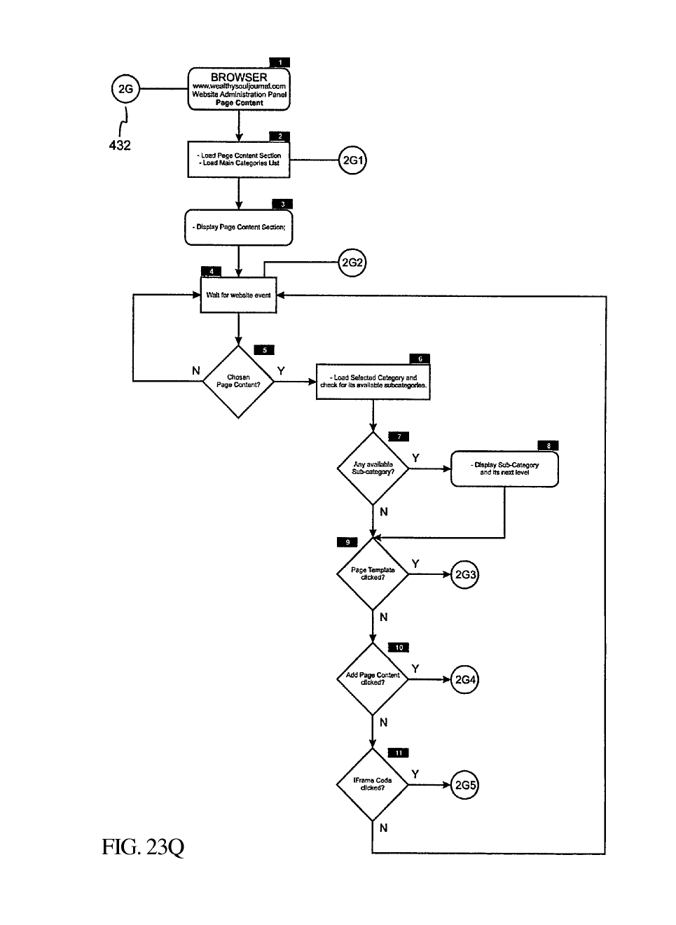

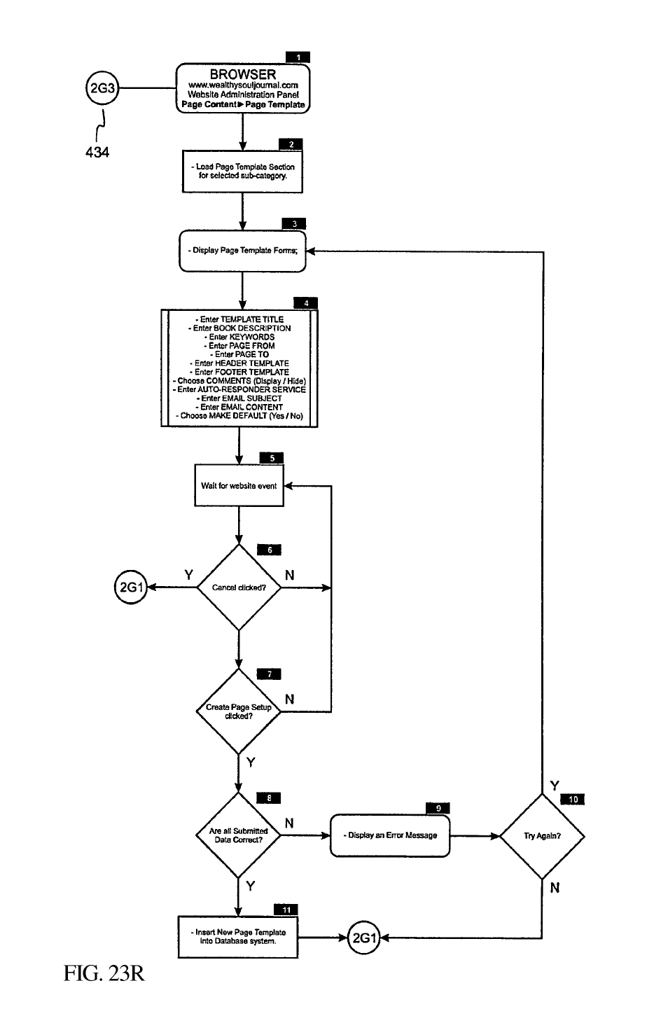

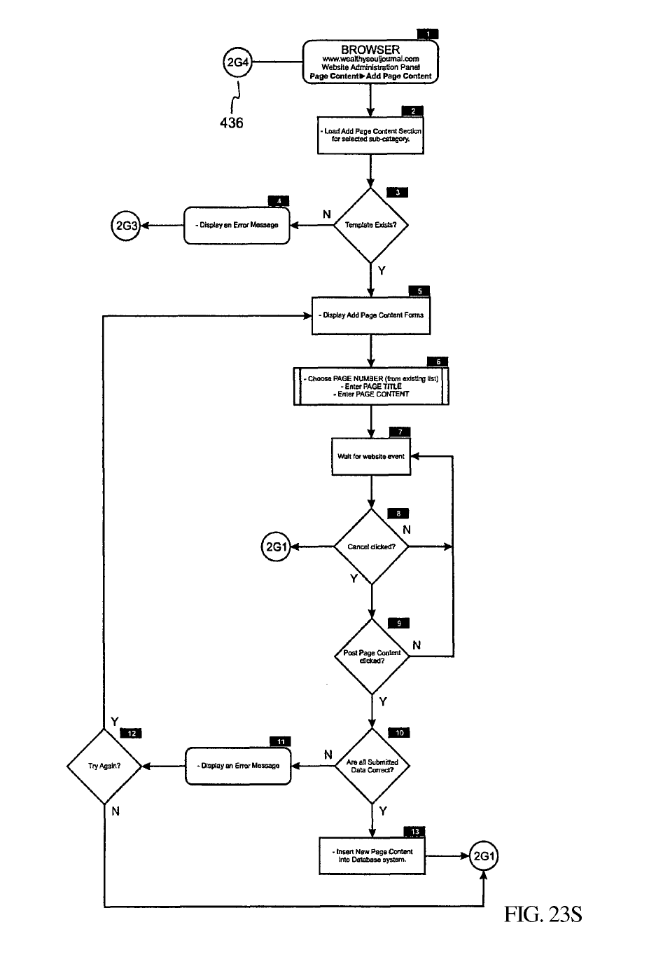

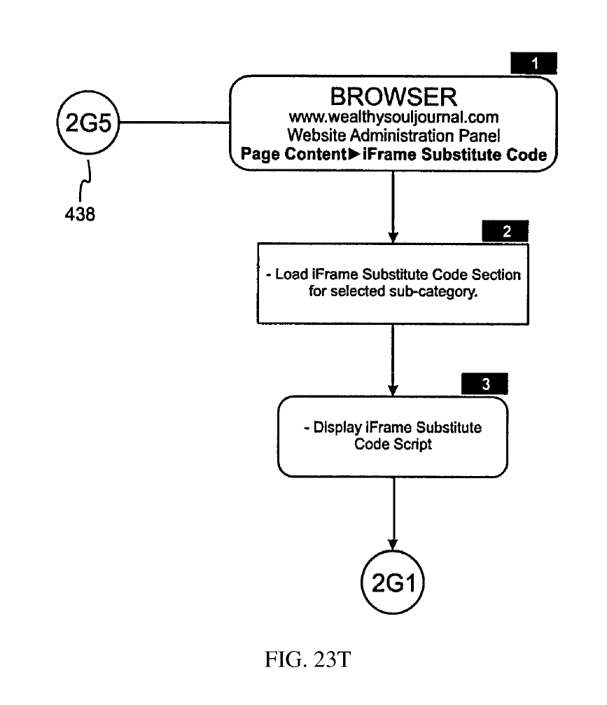

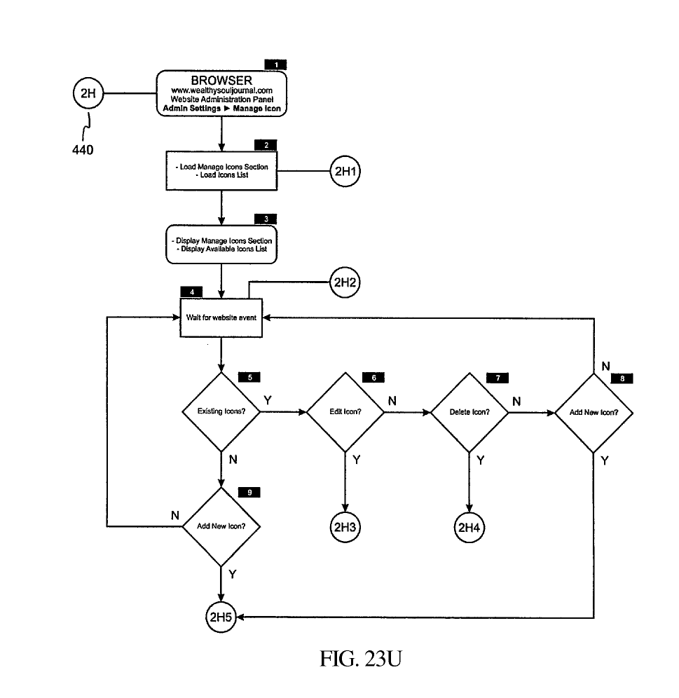

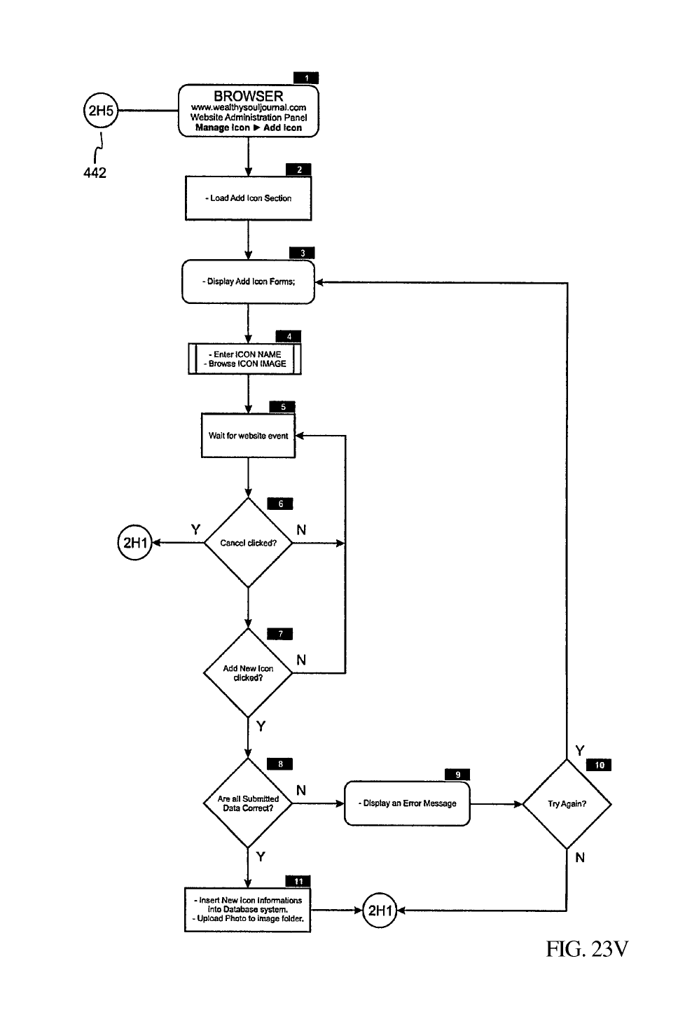

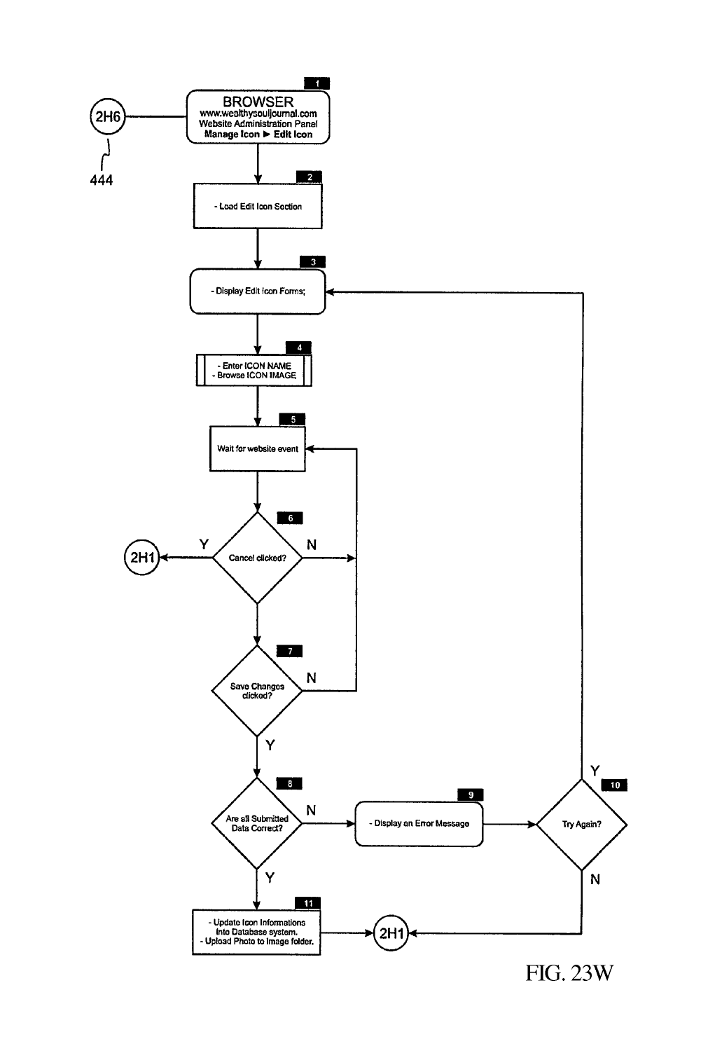

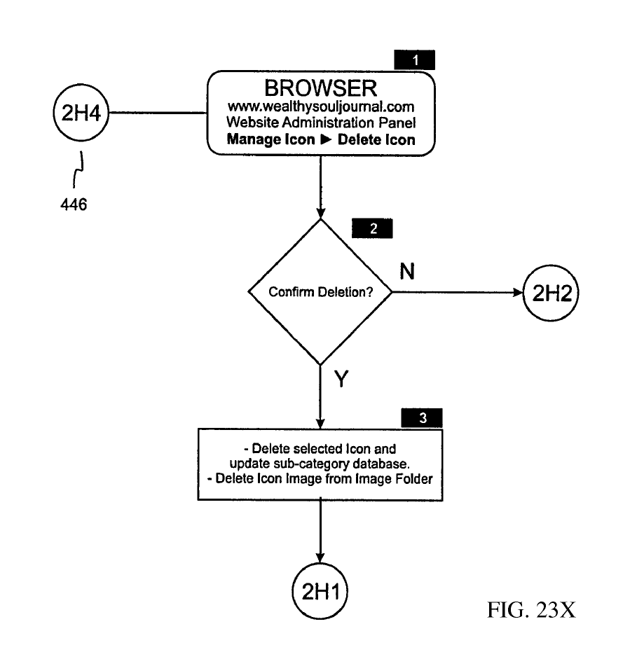

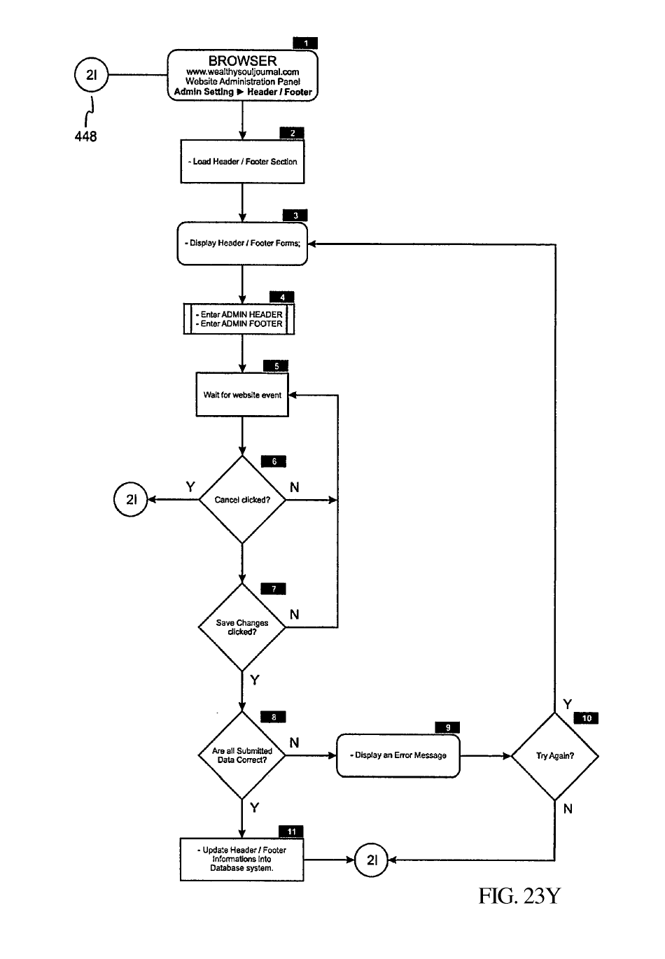

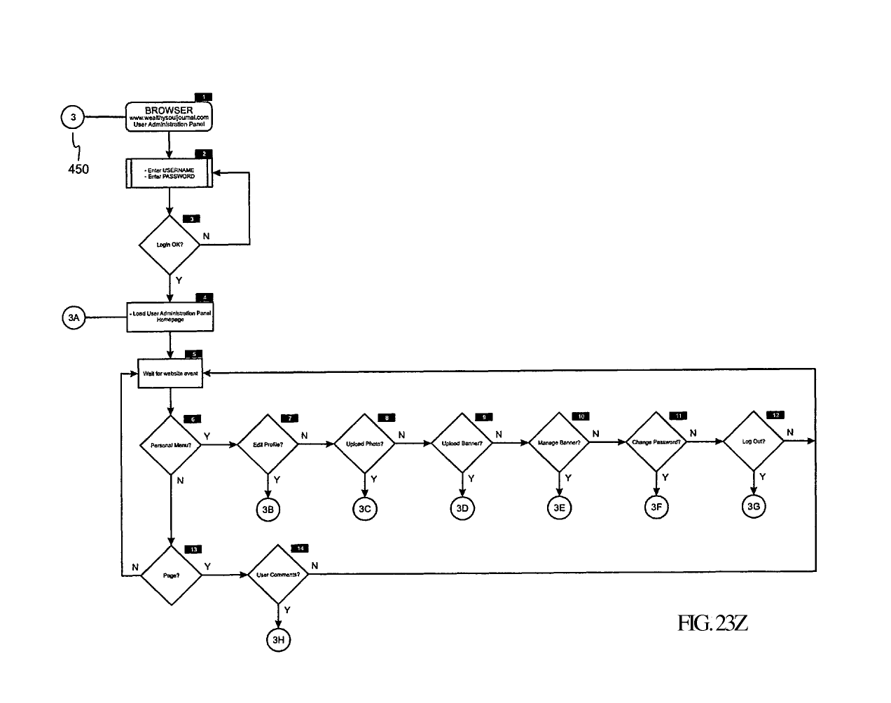

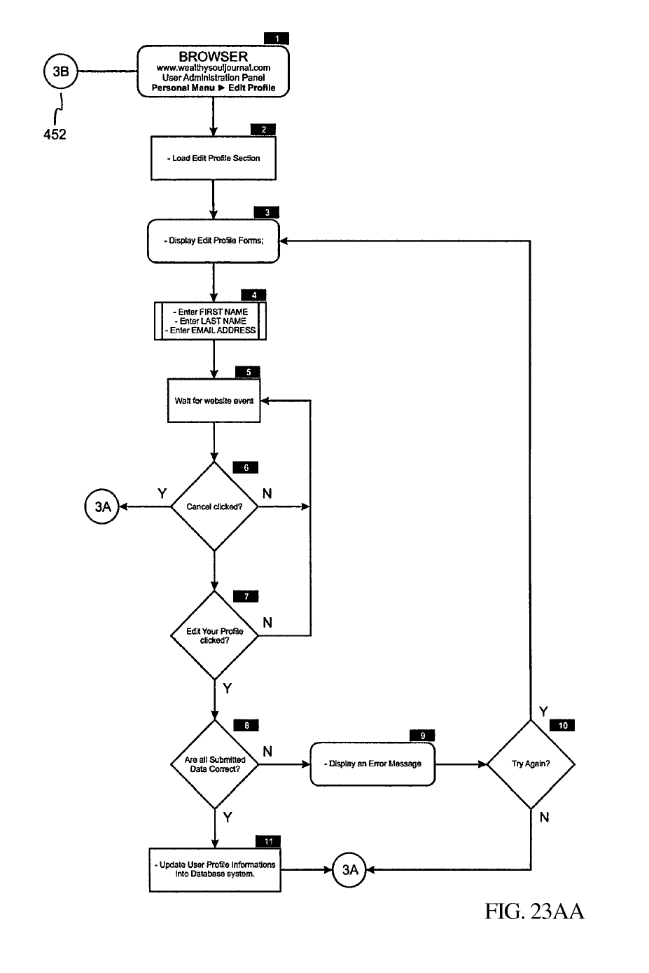

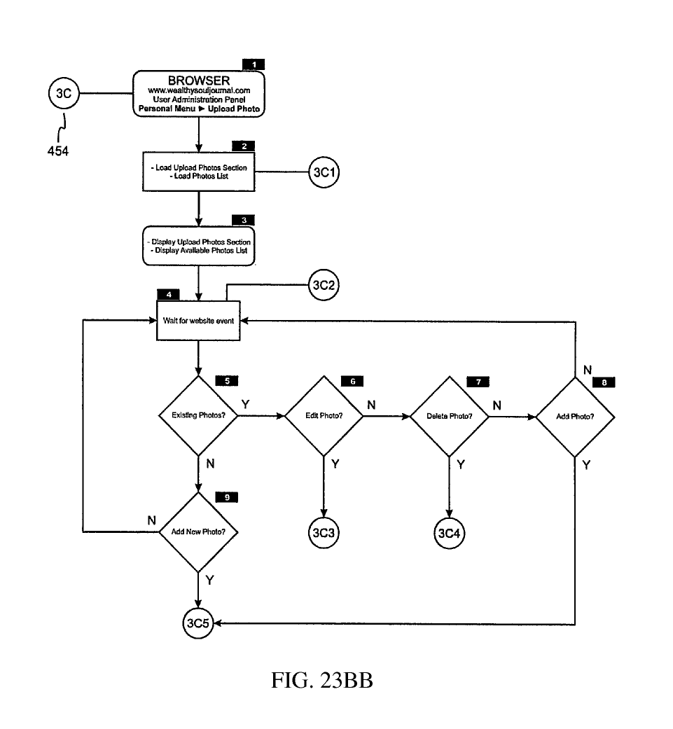

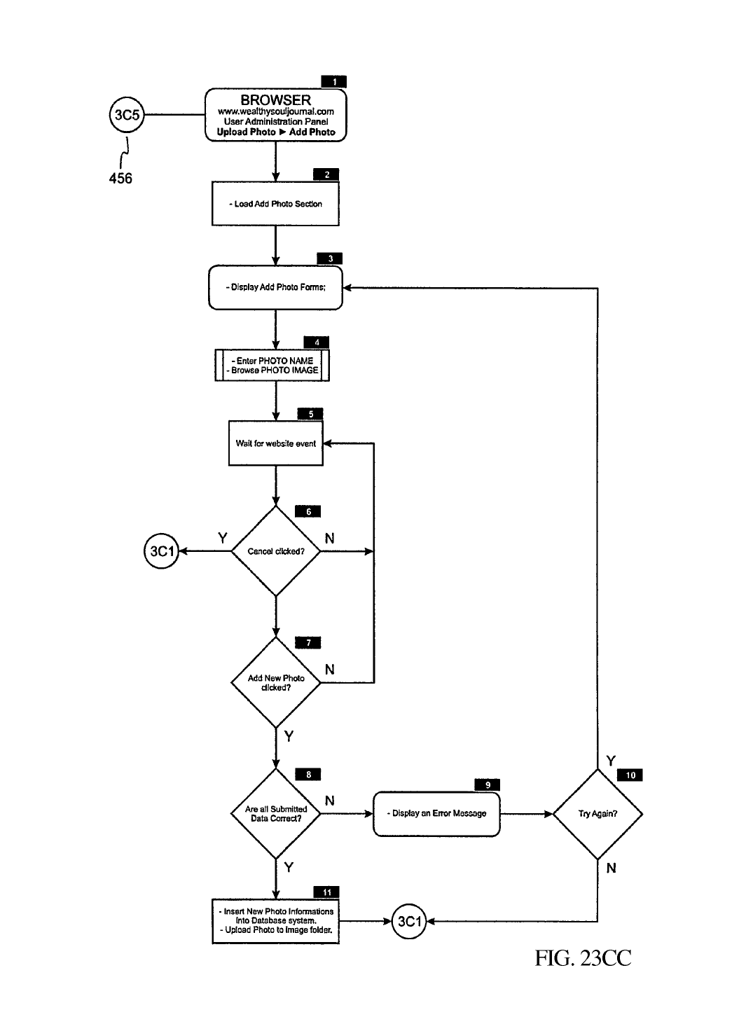

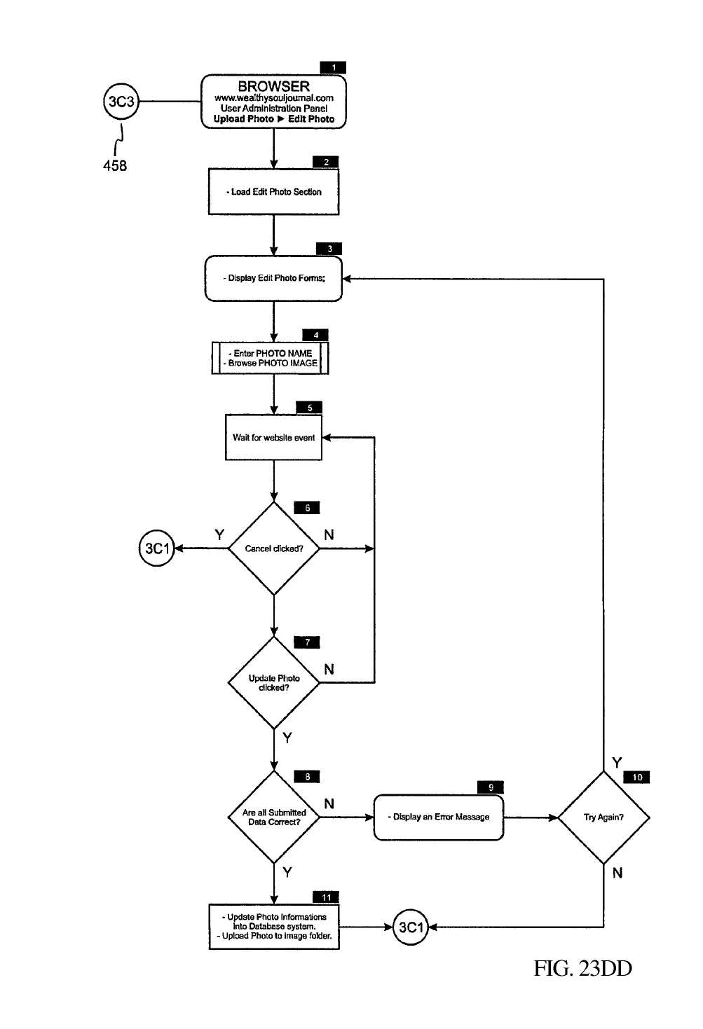

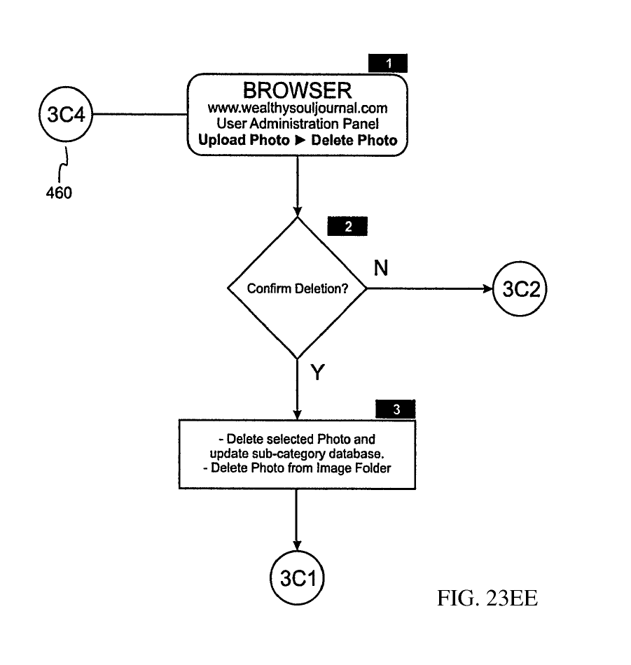

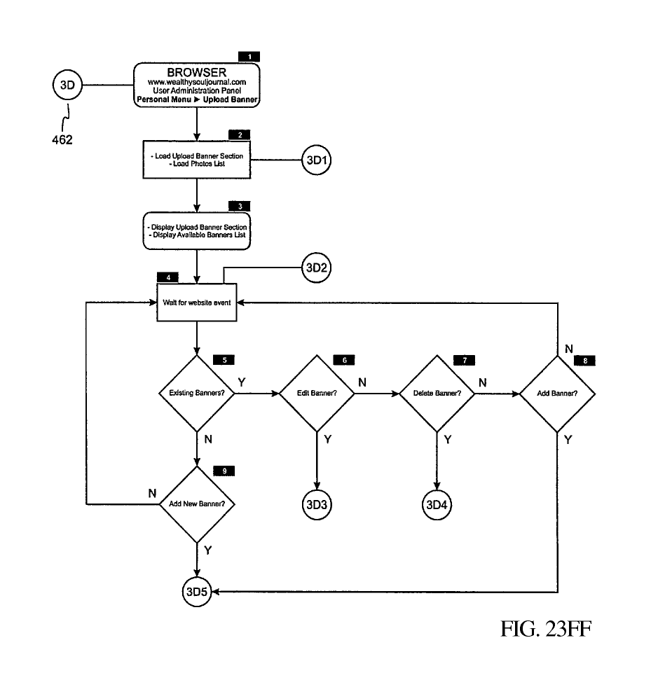

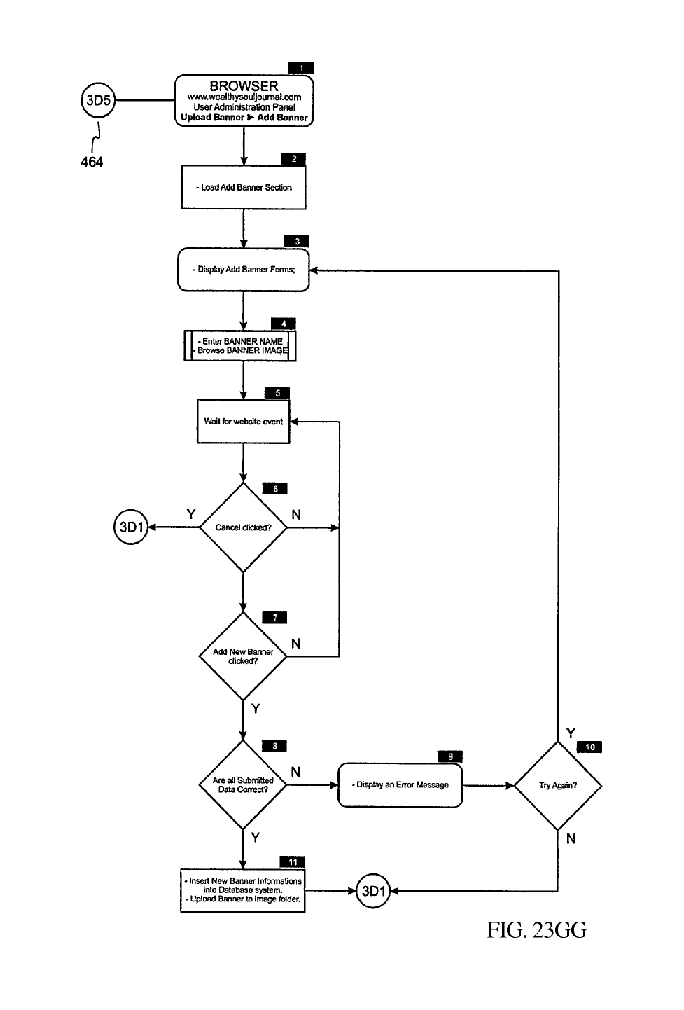

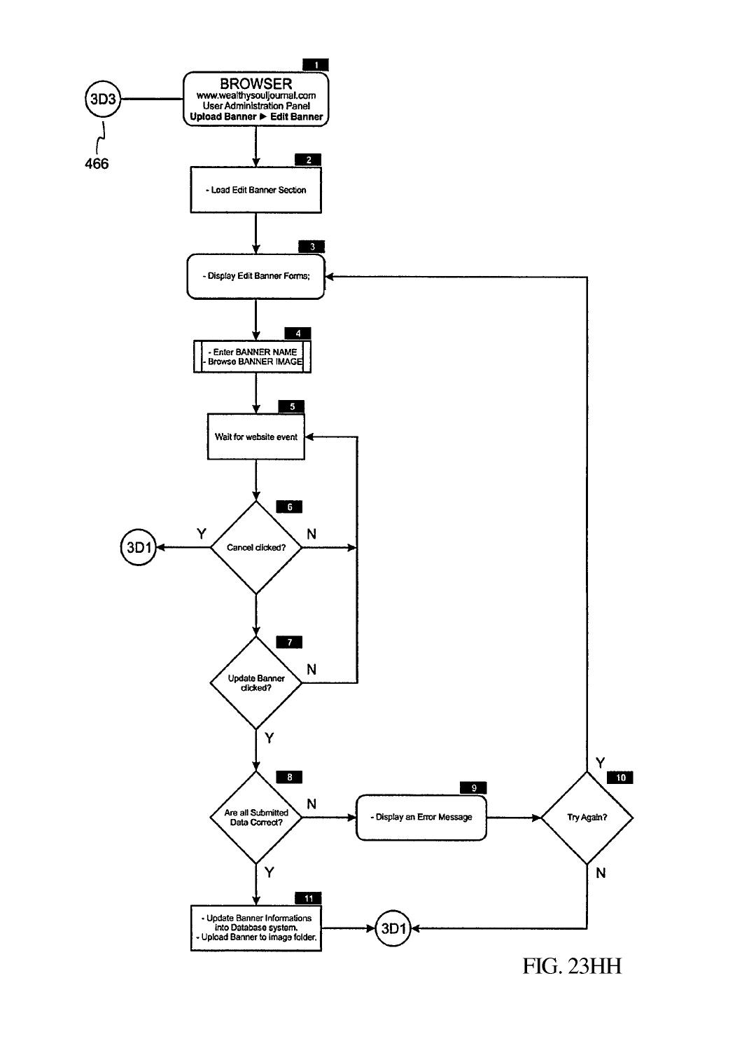

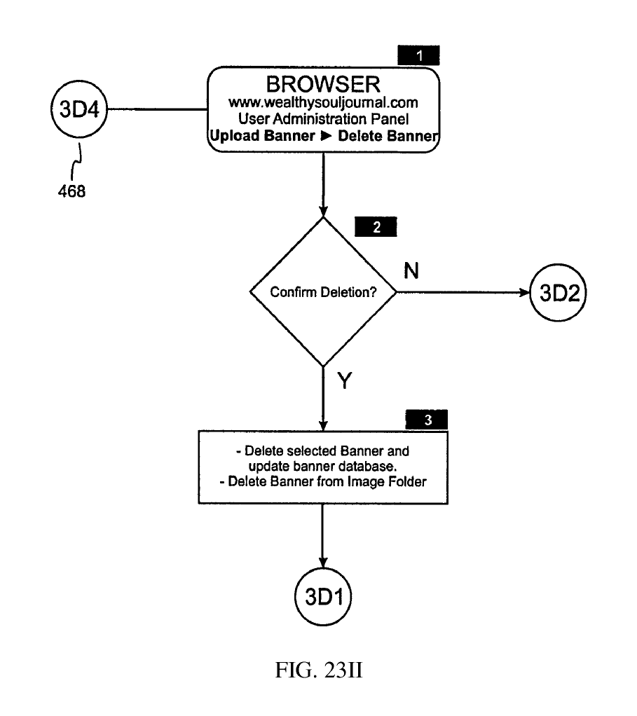

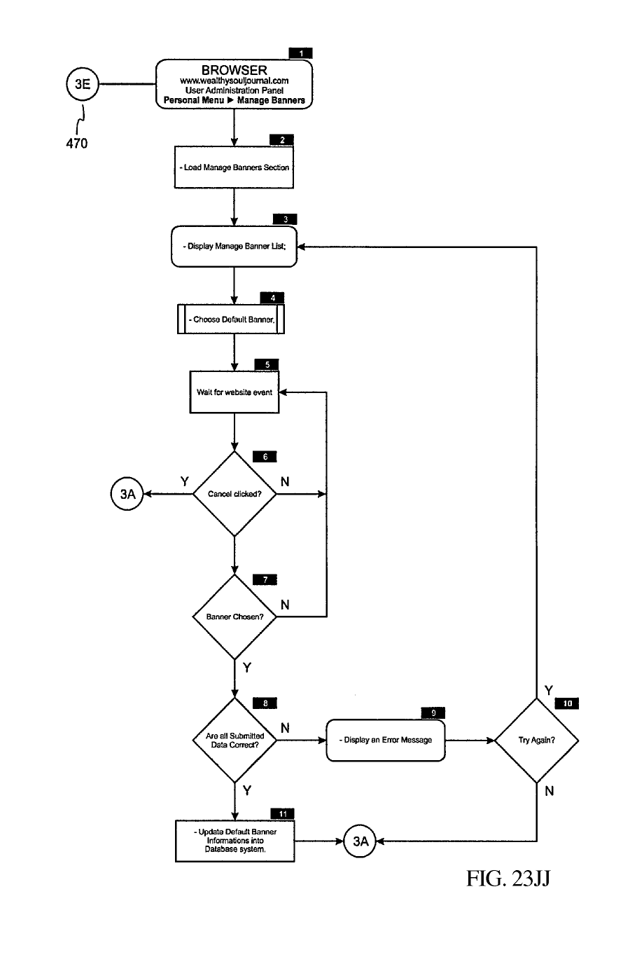

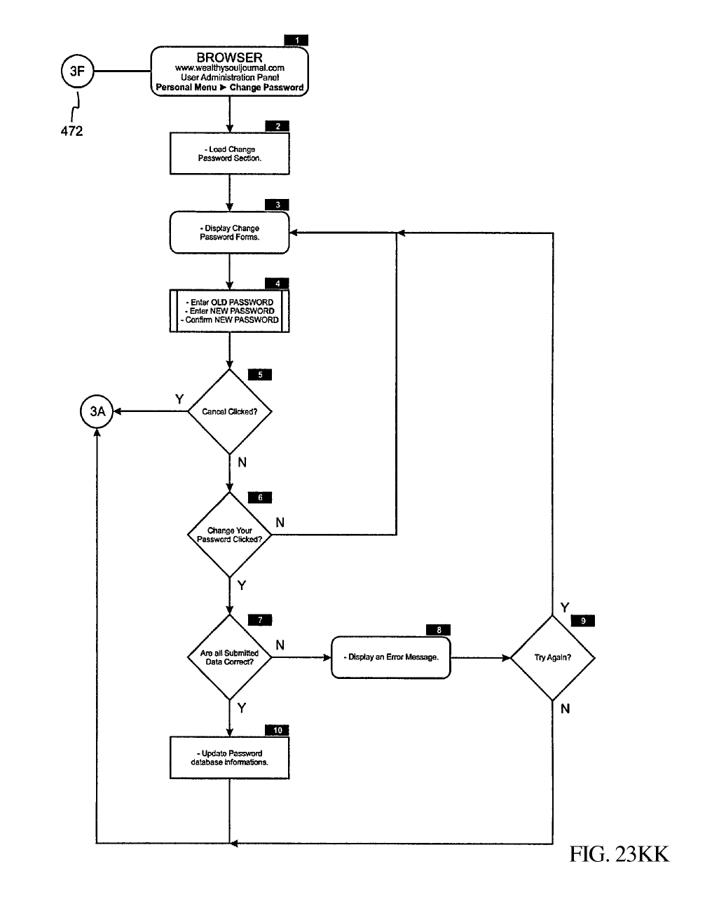

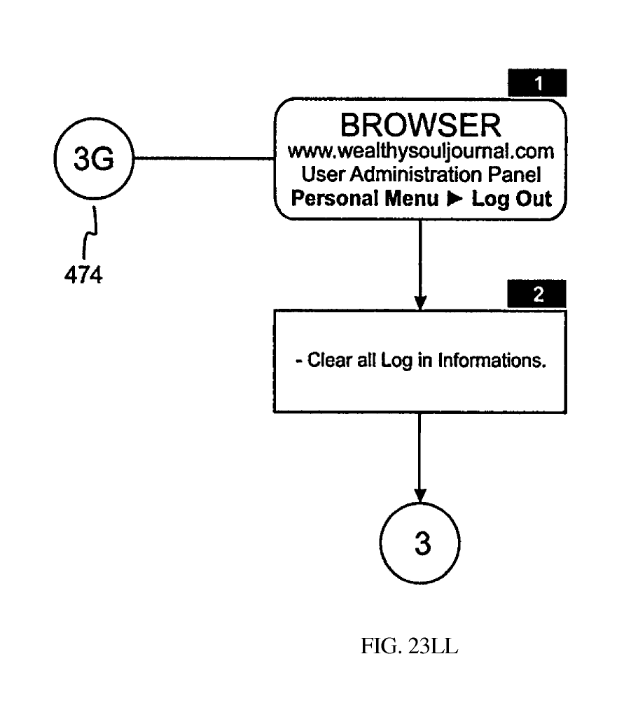

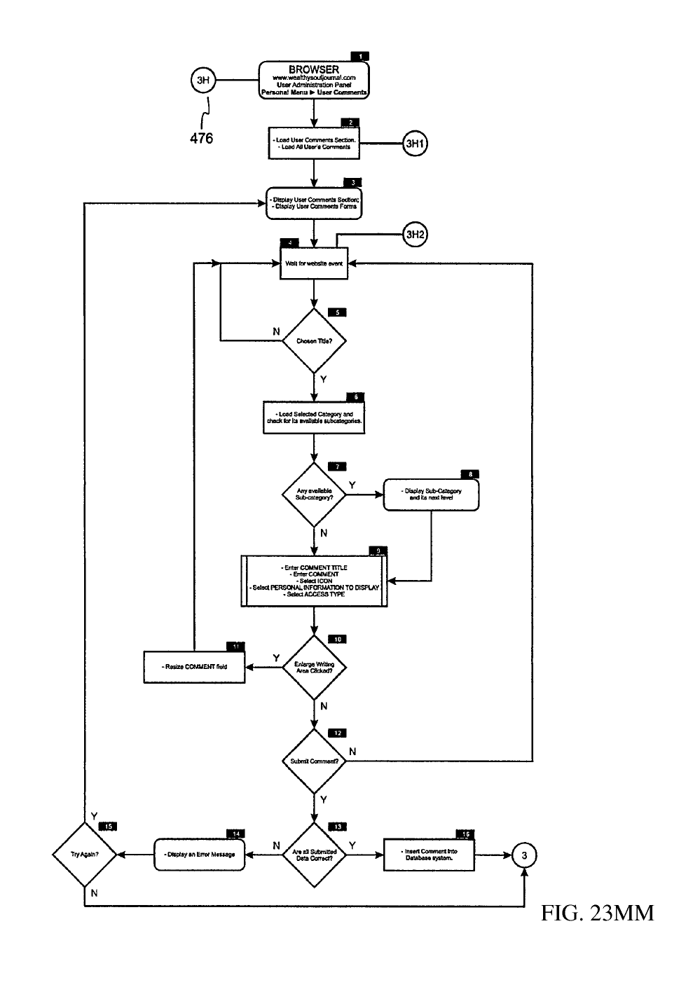

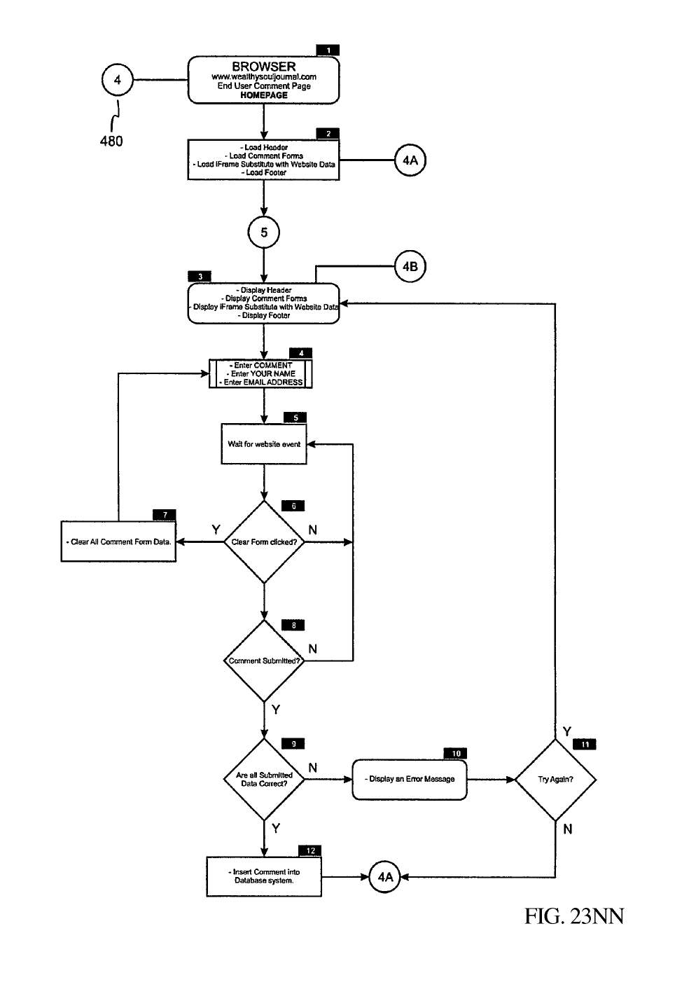

Referring to FIGS. 23A-23OO, a flow diagram illustrating the web site administration, user administration, and end user components for an exemplary embodiment is shown. Various embodiments may include an iFrame solution to provide features and functionality related to comment areas. The embedded technologies in the iFrame Solution include HTML, PHP, Javascript, MySQL, CSS, and AJAX methods.

Referring to FIG. 23A, beginning at 400, the following steps are performed.

TABLE 1

| Step | Action |
|---|---|
| 1 | With any ECMA-262 compatible browsers (Internet Explorer 5+, |
| | FireFox 1.5+, Opera 8+, etc), the user accesses a URL (e.g., |
| | (www.wealthysouljournal.com). Users are permitted to access to |
| | one of three distinct sections: Web Site Administration System |
| | Panel, Users Administration System Panel, and End |
| | User System Panel. |
| 2 | The user proceeds to the WEB SITE administration panel login |
| | page. |
| 3 | The user proceeds to the USERS administration panel login page. |
| 4 | The user proceeds to the END USERS comment page. |

Referring to FIG. 23B, beginning at 402, the following steps are performed.

TABLE 2

| Step | Action |
|---|---|
| 1 | Browser will display a security check page asking USERNAME and PASSWORD. |
| 2 | User MUST enter USERNAME and PASSWORD; |
| 3 | If USERNAME and PASSWORD are OK, then follow the “Y” path, otherwise, follow the “N” path; |
| 4 | With an authenticated user, the system will load the “Website Administration Panel” homepage and will |
| | show all available menu option for this section; |
| 5 | The website will wait until the user choose one of the options on main menu; |
| 6 | If user chose PERSONAL MENU, a sub-menu with another options will appear and wait until one of its |
| | options are chosen; Its options are: (7) Edit Profile, (8) Change Password and (9) Log out; |
| 7 | If user chose PERSONAL MENU→EDIT PROFILE, it will follow “Y” path to diagram [2B], otherwise it |
| | will wait until the user's choice. |
| 8 | If user chose PERSONAL MENU→EDIT PROFILE, it will follow “Y” path to diagram [2C], otherwise it |
| | will wait until the user's choice. |
| 9 | If user chose PERSONAL MENU→EDIT PROFILE, it will follow “Y” path to diagram [2D], otherwise it |
| | will wait until the user's choice. |
| 10 | If user chose CREATE & MANAGE MENU, a sub-menu with another options will appear and wait until |
| | one of its options are chosen; Its options are: (11) Categories, (12) Sub-Categories and (13) Page Content; |
| 11 | If user chose CREATE & MANAGE MENU→CATEGORIES, it will follow “Y” path to diagram [2E], |
| | otherwise it will wait until the user's choice. |
| 12 | If user chose CREATE & MANAGE MENU→SUB-CATEGORIES, it will follow “Y” path to diagram |
| | [2F], otherwise it will wait until the user's choice. |
| 13 | If user chose CREATE & MANAGE MENU→PAGE CONTENT, it will follow “Y” path to diagram |
| | [2G], otherwise it will wait until the user's choice. |
| 14 | If user chose ADMIN SETTINGS MENU, a sub-menu with another options will appear and wait until one |
| | of its options are chosen; Its options are: (15) Manage Icon and (16) HEADER/FOOTER; |
| 15 | If user chose ADMIN SETTINGS MENU→MANAGE ICON, it will follow “Y” path to diagram [2H], |
| | otherwise it will wait until the user's choice. |
| 16 | If user chose ADMIN SETTINGS MENU→HEADER/FOOTER, it will follow “Y” path to diagram [2I], |
| | otherwise it will wait until the user's choice. |

Referring to FIG. 23C, beginning at 404, the following steps are performed:

TABLE 3

| Step | Action |
|---|---|
| 1 | Browser will display EDIT PROFILE title. |
| 2 | Website will load EDIT PROFILE section; |
| 3 | Website will display EDIT PROFILE page with its forms; |
| 4 | User MUST enter FIRST NAME, LAST NAME and EMAIL |
| | ADDRESS; |
| 5 | If user clicked on CANCEL during the process, the system will |
| | follow the “Y” path to diagram [2A], otherwise it will |
| | follow the “N” path; |
| 6 | If user clicked on EDIT YOUR PROFILE, the system will follow |
| | the “Y” path, otherwise it will follow |
| | the “N” path; |
| 7 | If all submitted data are correct, it will follow the “Y” path, |
| | otherwise it will follow the “N” path; |
| 8 | If an error happens, an error message will be showed and user |
| | can choose to try again; |
| 9 | If user wants to try again it will follow the “Y” path, otherwise |
| | it will follow the “N” path to diagram [2A]; |
| 10 | The system will update USER PROFILE database and goes to |
| | diagram [2A]; |

Referring to FIG. 23D, beginning at 406, the following steps are performed.

TABLE 4

| Step | Action |
|---|---|
| 1 | Browser will display CHANGE PASSWORD title. |
| 2 | Website will load CHANGE PASSWORD section; |
| 3 | Website will display CHANGE PASSWORD page with its forms; |
| 4 | User MUST enter OLD PASSWORD, NEW PASSWORD and |
| | CONFIRM NEW PASSWORD; |
| 5 | If user clicked on CANCEL during the process, the system will |
| | follow the “Y” path to diagram [2A], otherwise it will |
| | follow the “N” path; |
| 6 | If user clicked on CHANGE PASSWORD, the system will follow |
| | the “Y” path, otherwise it will follow the “N” path; |
| 7 | If all submitted data are correct, it will follow the “Y” path, |
| | otherwise it will follow the “N” path; |
| 8 | If an error happens, an error message will be showed and user can |
| | choose to try again; |
| 9 | If user wants to try again it will follow the “Y” path, otherwise it |
| | will follow the “N” path to diagram [2A]; |
| 10 | The system will update PASSWORD database and goes to diagram |
| | [2A]; |

Referring to FIG. 23E, beginning at 408, the following steps are performed.

TABLE 5

| Step | Action |
|---|---|
| 1 | Browser will display LOG OUT title. |
| 2 | Website will clear all log in information and goes to diagram [2]; |

Referring to FIG. 23F, beginning at 410, the following steps are performed.

TABLE 6

| Step | Action |
|---|---|
| 1 | Browser will display CATEGORIES title. |
| 2 | Website will load CATEGORIES section and check if there are any categories into database system; |
| 3 | If any category was previously added, these categories will be listed and a special menu for it will be |
| | loaded and ADD NEW CATEGORY will be in the options too. The options for its menu are: (9) Add |
| | New Category, (6) Edit Category, (7) Delete Category, (8) Change Existing Categories List Order; |
| 4 | If user chose PERSONAL MENU, a sub-menu with another options will appear and wait until one of its |
| | options are chosen; Its options are: (7) Edit Profile, (8) Change Password and (9) Log out; |
| 5 | If user clicked on CANCEL during the process, the system will follow the “Y” path to diagram [2E1], |
| | otherwise it will follow the “N” path; |
| 6 | If user chose CATEGORIES→EDIT CATEGORY, it will follow “Y” path to diagram [2E3], otherwise it |
| | will wait until the user's choice. |
| 7 | If user chose CATEGORIES→DELETE CATEGORY, it will follow “Y” path to diagram [2E4], |
| | otherwise it will wait until the user's choice. |
| 8 | If user chose CATEGORIES→CHANGE LIST ORDER, it will follow “Y” path to diagram [2E5], |
| | otherwise it will wait until the user's choice. |

Referring to FIG. 23G, beginning at 412, the following steps are performed.

TABLE 7

| Step | Action |
|---|---|
| 1 | Browser will display CATEGORIES - EDIT CATEGORY title. |
| 2 | Website will load EDIT CATEGORY section and check if there |
| | are any sub-categories for selected category; |
| 3 | Website will display EDIT CATEGORY page with its forms; |
| 4 | User MUST enter CATEGORY NAME, NEXT LEVEL |
| | SELECTION and ORDER TYPE; |
| 5 | If user clicked on CANCEL during the process, the system will |
| | follow the “Y” path to diagram [2E1], otherwise it will follow |
| | the “N” path; |
| 6 | If user clicked on SAVE CHANGES, the system will follow the |
| | “Y” path, otherwise it will follow the “N” path; |
| 7 | If all submitted data are correct, it will follow the “Y” path, |
| | otherwise it will follow the “N” path; |
| 8 | If an error happens, an error message will be showed and user can |
| | choose to try again; |
| 9 | If user wants to try again it will follow the “Y” path, otherwise it |
| | will follow the “N” path to diagram [2E1]; |
| 10 | The system will update CATEGORY database and goes to diagram |
| | [2E1]; |

Referring to FIG. 23H, beginning at 414, the following steps are performed.

TABLE 8

| Step | Action |
|---|---|
| 1 | Browser will display CATEGORIES - DELETE CATEGORY title. |
| 2 | Website will ask user to CONFIRM CATEGORY TO DELETE; |
| | If user clicked on NO during the process, the system will follow |
| | the “N” path to diagram [2E2], otherwise it will |
| | follow the “Y” path; |
| 3 | The system will delete selected CATEGORY, update category |
| | database and goes to diagram [2E1]; |

Referring to FIG. 23I, beginning at 416, the following steps are performed.

TABLE 9

| Step | Action |
|---|---|
| 1 | Browser will display CATEGORIES - CHANGE ORDER title. |
| 2 | If user chose SEQUENTIAL ORDER, it will follow the “Y” path, |
| | otherwise it will follow “N” path; |
| 3 | Website will load all available categories ordering by |
| | “SEQUENTIAL” option; |
| 4 | The system display CATEGORIES SECTION using the chosen |
| | order and goes to diagram [2E2]; |
| 5 | If user chosen NON-SEQUENTIAL ORDER, it will follow the |
| | “Y” path, otherwise it will follow “N” path; |
| 6 | Website will load all available categories ordering by |
| | “NON-SEQUENTIAL” option; |

Referring to FIG. 23J, beginning at 418, the following steps are performed.

TABLE 10

| Step | Action |
|---|---|
| 1 | Browser will display ADD NEW CATEGORY title. |
| 2 | Website will load ADD NEW CATEGORY section; |
| 3 | Website will display ADD NEW CATEGORY page with its forms; |
| 4 | User MUST enter CATEGORY NAME, NEXT LEVEL |
| | SELECTION and ORDER TYPE; |
| 5 | If user clicked on CANCEL during the process, the system will |
| | follow the “Y” path to diagram [2E1], otherwise it will follow |
| | the “N” path; |
| 6 | If user clicked on ADD NEW CHANGE PASSWORD, the system |
| | will follow the “Y” path, otherwise it will follow the “N” path; |
| 7 | If all submitted data are correct, it will follow the “Y” path, |
| | otherwise it will follow the “N” path; |
| 8 | If an error happens, an error message will be showed and user can |
| | choose to try again; |
| 9 | If user wants to try again it will follow the “Y” path, otherwise it |
| | will follow the “N” path to diagram [2E1]; |
| 10 | The system will ADD A NEW CATEGORY into database and |
| | goes to diagram [2E1]; |

Referring to FIG. 23K, beginning at 420, the following steps are performed.

TABLE 11

| Step | Action |
|---|---|
| 1 | Browser will display SUB-CATEGORIES title. |
| 2 | Website will load SUB-CATEGORIES section; |
| 3 | Website will display SUB-CATEGORIES page with its forms; |
| 4 | Website will wait until one of the available options is chosen; |
| 5 | If SUB-CATEGORIES chosen, it will follow the “Y” path and a sub-menu will appear for its sub- |
| | categories, otherwise it will follow the “N” path; |
| 6 | If user chose SUB-CATEGORIES→EDIT SUB-CATEGORY, it will follow “Y” path to diagram [2F3], |
| | otherwise it will wait until the user's choice. |
| 7 | If user chose SUB-CATEGORIES→DELETE SUB-CATEGORY, it will follow “Y” path to diagram |
| | [2F4], otherwise it will wait until the user's choice. |
| 8 | If a category is chosen and the user clicks on SUB-CATEGORIES→CREATE SUB-CATEGORY, a list |
| | of options for SUB-CATEGORY creation type will appear; |
| 9 | The system will wait until one of the available types of sub-categories is chosen. The options are: (10) |
| | Text, (13) Numeric and (16) Alphabetic; |
| 10 | If TEXT is chosen, it will follow “Y” path, otherwise it will follow “N” path; |
| 11 | User MUST enter the number (quantity) of NEW TEXT SUB-CATEGORIES that will be created; |
| 12 | If creation is confirmed, it will follow “Y” path to diagram [2F6], otherwise it will be canceled and will |
| | follow the “N” path; |
| 13 | If NUMERIC is chosen, it will follow “Y” path, otherwise it will follow “N” path; |
| 14 | User MUST enter the STARTING NUMBER and END NUMBER of NEW NUMERIC SUB- |
| | CATEGORIES that will be created. These numbers MUST be bigger than 0 and smaller than 1001; |
| 15 | If creation is confirmed, it will follow “Y” path to diagram [2F7], otherwise it will be canceled and will |
| | follow the “N” path; |
| 16 | If ALPHABETIC is chosen, it will follow “Y” path, otherwise it will follow “N” path; |
| 17 | User MUST enter the STARTING LETTER and END LETTER of NEW ALPHABETIC SUB- |
| | CATEGORIES that will be created; |
| 18 | If creation is confirmed, it will follow “Y” path to diagram [2F8], otherwise it will be canceled and will |
| | follow the “N” path; |

Referring to FIG. 23L, beginning at 422, the following steps are performed.

TABLE 12

| Step | Action |
|---|---|
| 1 | Browser will display SUB-CATEGORIES - EDIT title. |
| 2 | Website will load SUB-CATEGORIES-EDIT section; |
| 3 | Website will display SUB-CATEGORIES-EDIT page with its |
| | forms; |
| 4 | User MUST enter CATEGORY NAME, NEXT LEVEL |
| | SELECTION and ORDER TYPE; |
| 5 | Website will wait until one of the available options is chosen; |
| 6 | If UPDATE clicked, the system will follow the “Y” path, |
| | otherwise it will follow the “N” path; |
| 7 | If user clicked on CANCEL during the process, the system will |
| | follow the “Y” path to diagram [2F1], |
| | otherwise it will follow the “N” path; |
| 8 | If all submitted data are correct, it will follow the “Y” path, |
| | otherwise it will follow the “N” path; |
| 9 | If an error happens, an error message will be showed and user can |
| | choose to try again; |
| 10 | If user wants to try again it will follow the “Y” path, otherwise it |
| | will follow the “N” path to diagram [2F1]; |
| 11 | The system will UPDATE THE SUB-CATEGORY into database |
| | and goes to diagram [2F1]; |

Referring to FIG. 23M, beginning at 424, the following steps are performed.

TABLE 13

| Step | Action |
|---|---|
| 1 | Browser will display SUB-CATEGORIES - DELETE title. |
| 2 | Website will ask user to CONFIRM SUB-CATEGORY TO |
| | DELETE; |
| | If user clicked on NO during the process, the system will follow |
| | the “N” path to diagram [2F2], otherwise it will follow the |
| | “Y” path; |
| 3 | The system will delete selected SUB-CATEGORY, update |
| | sub-category database and goes to diagram [2F1]; |

Referring to FIG. 23N, beginning at 426, the following steps are performed.

TABLE 14

| Step | Action |
|---|---|
| 1 | Browser will display SUB-CATEGORIES - ADD TEXT TYPE |
| | title. |
| 2 | Website will create SUB-CATEGORIES TEXT TYPE |
| | (selected category); |
| 3 | Website will display SUB-CATEGORIES TEXT TYPE forms |
| | (selected category); |
| 4 | User MUST enter SUB-CATEGORY NAME, NEXT LEVEL |
| | SELECTION and ORDER TYPE; |
| 5 | Website will wait until one of the available options is chosen; |
| 6 | If CREATE NEW SUB-CATEGORY clicked, the system will |
| | follow the “Y” path, otherwise it will follow the “N” path; |
| 7 | If all submitted data are correct, it will follow the “Y” path, |
| | otherwise it will follow the “N” path; |
| 8 | If an error happens, an error message will be showed and user |
| | can choose to try again; |
| 9 | If user wants to try again it will follow the “Y” path, otherwise |
| | it will follow the “N” path to diagram [2F1]; |
| 10 | The system will add the NEW SUB-CATEGORIES into database |
| | and goes to diagram [2F1]; |

Referring to FIG. 23O, beginning at 428, the following steps are performed.

TABLE 15

| Step | Action |
|---|---|
| 1 | Browser will display SUB-CATEGORIES - ADD NUMERIC |
| | TYPE title. |
| 2 | Website will create SUB-CATEGORIES NUMERIC TYPE |
| | (selected category); |
| 3 | Website will wait until one of the available options is chosen; |
| 4 | If CREATE NEW SUB-CATEGORY clicked, the system will |
| | follow the “Y” path, otherwise it will follow the “N” path; |
| 5 | If all submitted data are correct, it will follow the “Y” path, |
| | otherwise it will follow the “N” path; |
| 6 | If an error happens, an error message will be showed and user can |
| | choose to try again; |
| 7 | If user wants to try again it will follow the “Y” path and goes to |
| | diagram [2F2]; otherwise it will follow the “N” path to diagram |
| | [2F1]; |
| 8 | The system will add the NEW SUB-CATEGORIES into database |
| | and goes to diagram [2F1]. |

Referring to FIG. 23P, beginning at 430, the following steps are performed.

TABLE 16

| Step | Action |
|---|---|
| 1 | Browser will display SUB-CATEGORIES - ADD ALPHABETIC |
| | TYPE title. |
| 2 | Website will create SUB-CATEGORIES ALPHABETIC TYPE |
| | (selected category); |
| 3 | Website will wait until one of the available options is chosen; |
| 4 | If CREATE NEW SUB-CATEGORY clicked, the system will |
| | follow the “Y” path, otherwise it will follow the “N” path; |
| 5 | If all submitted data are correct, it will follow the “Y” path, |
| | otherwise it will follow the “N” path; |
| 6 | If an error happens, an error message will be showed and user |
| | can choose to try again; |
| 7 | If user wants to try again it will follow the “Y” path and goes to |
| | diagram [2F2], otherwise it will follow the “N” path to diagram |
| | [2F1]; |
| 8 | The system will add the NEW SUB-CATEGORIES into database |
| | and goes to diagram [2F1]. |

Referring to FIG. 23Q, beginning at 432, the following steps are performed.

TABLE 17

| Step | Action |
|---|---|
| 1 | Browser will display PAGE CONTENT title. |
| 2 | Website will load PAGE CONTENT section and all MAIN CATEGORIES LIST; |
| 3 | Website will display PAGE CONTENT page with its forms; |
| 4 | Website will wait until one of the available options is chosen; |
| 5 | If PAGE CONTENT chosen, it will follow the “Y” path and a sub-menu will appear for its sub- |
| | categories, otherwise it will follow the “N” path; |
| 6 | The system will load selected category and will check for its available sub-categories; |
| 7 | If category has any sub-categories available it will follow “Y” path, otherwise it will follow “N” path; |
| 8 | Website will display Category's sub-categories and its next levels; |
| 9 | If PAGE TEMPLATE was clicked, it will follow “Y” path to diagram [2G3], otherwise it will follow “N” |
| | path; |
| 10 | If ADD PAGE CONTENT was clicked, it will follow “Y” path to diagram [2G4], otherwise it will follow |
| | “N” path; |
| 11 | If IFRAME CODE was clicked, it will follow “Y” path to diagram [2G5], otherwise it will follow “N” |
| | path; |

Referring to FIG. 23R, beginning at 434, the following steps are performed.

TABLE 18

| Step | Action |
|---|---|
| 1 | Browser will display PAGE CONTENT - PAGE TEMPLATE title. |
| 2 | Website will load PAGE TEMPLATE section for selected category or sub-category; |
| 3 | Website will display PAGE TEMPLATE page with its forms; |
| 4 | User MUST enter TEMPLATE TITLE, BOOK DESCRIPTION, KEYWORDS, PAGE FROM, PAGE |
| | TO, HEADER TEMPLATE, FOOTER TEMPLATE, choose COMMENTS TYPE (Display or Hide), |
| | AUTO-RESPONDER SERVICE, EMAIL SUBJECT, EMAIL CONTENT and choose MAKE |
| | DEFAULT (Yes or No); |
| 5 | Website will wait until one of the available options is chosen; |
| 6 | If user clicked on CANCEL during the process, the system will follow the “Y” path to diagram [2G1], |
| | otherwise it will follow the “N” path; |
| 7 | If CREATE PAGE SETUP clicked, the system will follow the “Y” path, otherwise it will follow the “N” |
| | path; |
| 8 | If all submitted data are correct, it will follow the “Y” path, otherwise it will follow the “N” path; |
| 9 | If an error happens, an error message will be showed and user can choose to try again; |
| 10 | If user wants to try again it will follow the “Y” path, otherwise it will follow the “N” path to diagram |
| | [2G1]; |
| 11 | The system will ADD A NEW TEMPLATE into database and goes to diagram [2G1]. |

Referring to FIG. 23S, beginning at 436, the following steps are performed.

TABLE 19

| Step | Action |
|---|---|
| 1 | Browser will display PAGE CONTENT - ADD PAGE CONTENT title. |
| 2 | Website will load ADD PAGE CONTENT section for selected category or sub-category; |
| 3 | If no templates are found for its category/subcategory it will follow the “N” path, otherwise it will follow |
| | the “Y” path; |
| 4 | System will show an error message and goes to diagram [2G3]; |
| 5 | Website will display ADD PAGE CONTENT page with its forms; |
| 6 | User MUST choose PAGE NUMBER (from existing list), enter PAGE TITLE and enter PAGE |
| | CONTENT; |
| 7 | Website will wait until one of the available options is chosen; |
| 8 | If user clicked on CANCEL during the process, the system will follow the “Y” path to diagram [2G1], |
| | otherwise it will follow the “N” path; |
| 9 | If POST PAGE CONTENT clicked, the system will follow the “Y” path, otherwise it will follow the “N” |
| | path; |
| 10 | If all submitted data are correct, it will follow the “Y” path, otherwise it will follow the “N” path; |
| 11 | If an error happens, an error message will be showed and user can choose to try again; |
| 12 | If user wants to try again it will follow the “Y” path, otherwise it will follow the “N” path to diagram |
| | [2G1]; |
| 13 | The system will ADD NEW PAGE CONTENT into database and goes to diagram [2G1]. |

Referring to FIG. 23T, beginning at 438, the following steps are performed.

TABLE 20

| Step | Action |
|---|---|
| 1 | Browser will display PAGE CONTENT - IFRAME SUBSTITUTE |
| | CODE title. |
| 2 | Website will load IFRAME SUBSTITUTE CODE section for |
| | selected category or sub-category; |
| 3 | Website will display IFRAME SUBSTITUTE CODE SCRIPT |
| | to be used into website's HTML body and goes to diagram [2G1]. |

Referring to FIG. 23U, beginning at 440, the following steps are performed.

TABLE 21

| Step | Action |
|---|---|
| 1 | Browser will display ADMIN SETTINGS - MANAGE ICON title. |
| 2 | Website will load MANAGE ICON section and its available icons; |
| 3 | Website will display MANAGE ICON and its available icons; |
| 4 | Website will wait until one of the available options is chosen; |
| 5 | If there are any previously icons added it will follow the “Y” path and a sub-menu for its icons will |
| | appear, otherwise it will follow the “N” path and only ADD NEW ICON must be showed; |
| 6 | If EDIT ICON is chosen it will follow “Y” path to diagram [2H3], otherwise it will await until the user's |
| | choice. |
| 7 | If DELETE ICON is chosen it will follow “Y” path to diagram [2H4], otherwise it will await until the |
| | user's choice. |
| 8 | If ADD ICON is chosen it will follow “Y” path to diagram [2H5], otherwise it will await until the user's |
| | choice. |
| 9 | If ADD ICON is chosen it will follow “Y” path to diagram [2H5], otherwise it will await until the user's |
| | choice. |

Referring to FIG. 23V, beginning at 442, the following steps are performed.

TABLE 22

| Step | Action |
|---|---|
| 1 | Browser will display MANAGE ICON - ADD ICON title. |
| 2 | Website will load ADD ICON section; |
| 3 | Website will display ADD ICON page with its forms; |
| 4 | User MUST enter ICON NAME and choose an ICON IMAGE to upload; |
| 5 | Website will wait until one of the available options is chosen; |
| 6 | If user clicked on CANCEL during the process, the system will follow the “Y” path to diagram [2H1], |
| | otherwise it will follow the “N” path; |
| 7 | If ADD NEW ICON clicked, the system will follow the “Y” path, otherwise it will follow the “N” path; |
| 8 | If all submitted data are correct, it will follow the “Y” path, otherwise it will follow the “N” path; |
| 9 | If an error happens, an error message will be showed and user can choose to try again; |
| 10 | If user wants to try again it will follow the “Y” path, otherwise it will follow the “N” path to diagram |
| | [2H1]; |
| 11 | The system will ADD NEW ICON information and UPLOAD AN ICON IMAGE to image folder and |
| | goes to diagram [2H1]. |

Referring to FIG. 23W, beginning at 444, the following steps are performed.

TABLE 23

| Step | Action |
|---|---|
| 1 | Browser will display MANAGE ICON - EDIT ICON title. |
| 2 | Website will load EDIT ICON section; |
| 3 | Website will display EDIT ICON page with its forms; |
| 4 | User MUST enter ICON NAME and choose an ICON IMAGE to upload; |
| 5 | Website will wait until one of the available options is chosen; |
| 6 | If user clicked on CANCEL during the process, the system will follow the “Y” path to diagram [2H1]; |
| | otherwise it will follow the “N” path; |
| 7 | If SAVE CHANGES clicked, the system will follow the “Y” path, otherwise it will follow the “N” path; |
| 8 | If all submitted data are correct, it will follow the “Y” path, otherwise it will follow the “N” path; |
| 9 | If an error happens, an error message will be showed and user can choose to try again; |
| 10 | If user wants to try again it will follow the “Y” path, otherwise it will follow the “N” path to diagram |
| | [2H1]; |
| 11 | The system will UPDATE ICON information and UPLOAD AN ICON IMAGE to image folder and goes |
| | to diagram [2H1]. |

Referring to FIG. 23X, beginning at 446, the following steps are performed.

TABLE 24

| Step | Action |
|---|---|
| 1 | Browser will display MANAGE ICON - DELETE title. |
| 2 | Website will ask user to CONFIRM ICON TO DELETE; If user |
| | clicked on NO during the process, the system will follow the “N” |
| | path to diagram [2H2], otherwise it will follow the “Y” path; |
| 3 | The system will delete selected ICON and ICON IMAGE, update |
| | icon database and goes to diagram [2H1]; |

Referring to FIG. 23Y, beginning at 448, the following steps are performed.

TABLE 25

| Step | Action |
|---|---|
| 1 | Browser will display ADMIN SETTING - HEADER/FOOTER title. |
| 2 | Website will load HEADER/FOOTER section; |
| 3 | Website will display HEADER/FOOTER page with its forms; |
| 4 | User MUST enter ADMIN HEADER and ADMIN FOOTER; |
| 5 | Website will wait until one of the available options is chosen; |
| 6 | If user clicked on CANCEL during the process, the system will follow the “Y” path to diagram [2I], |
| | otherwise it will follow the “N” path; |
| 7 | If SAVE CHANGES clicked, the system will follow the “Y” path, otherwise it will follow the “N” path; |
| 8 | If all submitted data are correct, it will follow the “Y” path, otherwise it will follow the “N” path; |
| 9 | If an error happens, an error message will be showed and user can choose to try again; |
| 10 | If user wants to try again it will follow the “Y” path, otherwise it will follow the “N” path to diagram [2I]; |
| 11 | The system will UPDATE HEADER AND FOOTER information and goes to diagram [2I]. |

Referring to FIG. 23Z, beginning at 450, the following steps are performed.

TABLE 26

| Step | Action |
|---|---|
| 1 | Browser will display a security check page asking USERNAME and PASSWORD. |
| 2 | User MUST enter USERNAME and PASSWORD; |
| 3 | If USERNAME and PASSWORD are OK, then follow the “Y” path, otherwise, follow the “N” path; |
| 4 | With an authenticated user, the system will load the “User Administration Panel” homepage and will |
| | show all available menu option for this section; |
| 5 | The website will wait until the user choose one of the options on main menu; |
| 6 | If user chose PERSONAL MENU, a sub-menu with another options will appear and wait until one of its |
| | options are chosen; Its options are: (7) Edit Profile, (8) Upload Photo, (9) Upload Banner, (10) Manage |
| | Banner, (11) Change Password and (12) Log out; |
| 7 | If user chose PERSONAL MENU→EDIT PROFILE, it will follow “Y” path to diagram [3B], otherwise |
| | it will wait until the user's choice. |
| 8 | If user chose PERSONAL MENU→UPLOAD PHOTO, it will follow “Y” path to diagram [3C], |
| | otherwise it will wait until the user's choice. |
| 9 | If user chose PERSONAL MENU→UPLOAD BANNER, it will follow “Y” path to diagram [3D]. |
| | otherwise it will wait until the user's choice. |
| 10 | If user chose PERSONAL MENU→MANAGE BANNER, it will follow “Y” path to diagram [3E]. |
| | otherwise it will wait until the user's choice. |
| 11 | If user chose PERSONAL MENU→CHANGE PASSWORD, it will follow “Y” path to diagram [3F]. |
| | otherwise it will wait until the user's choice. |
| 12 | If user chose PERSONAL MENU→LOG OUT, it will follow “Y” path to diagram [3G] otherwise it will |
| | wait until the user's choice. |
| 13 | If user chose PAGE MENU, a sub-menu with another option will appear and wait until one of its options |
| | are chosen; Its options is: (14) User Comments; |
| 14 | If user chose PAGE MENU→USER COMMENTS, it will follow “Y” path to diagram [3H], otherwise it |
| | will wait until the user's choice. |

Referring to FIG. 23AA, beginning at 452, the following steps are performed.

TABLE 27

| Step | Action |
|---|---|
| 1 | Browser will display PERSONAL MENU - EDIT PROFILE title. |
| 2 | Website will load EDIT PROFILE section; |
| 3 | Website will display EDIT PROFILE page with its forms; |
| 4 | User MUST enter FIRST NAME, LAST NAME and EMAIL ADDRESS; |
| 5 | Website will wait until one of the available options is chosen; |
| 6 | If user clicked on CANCEL during the process, the system will follow the “Y” path to diagram [3A], |
| | otherwise it will follow the “N” path; |
| 7 | If EDIT YOUR PROFILE was clicked, the system will follow the “Y” path, otherwise it will follow the |
| | “N” path; |
| 8 | If all submitted data are correct, it will follow the “Y” path, otherwise it will follow the “N” path; |
| 9 | If an error happens, an error message will be showed and user can choose to try again; |
| 10 | If user wants to try again it will follow the “Y” path, otherwise it will follow the “N” path to diagram |
| | [3A]; |
| 11 | The system will UPDATE USER PROFILE information and goes to diagram [3A]; |

Referring to FIG. 23BB, beginning at 454, the following steps are performed.

TABLE 28

| Step | Action |
|---|---|
| 1 | Browser will display PERSONAL MENU - UPLOAD PHOTO title. |
| 2 | Website will load UPLOAD PHOTO section and its available photos; |
| 3 | Website will display UPLOAD PHOTO and its available photos; |
| 4 | Website will wait until one of the available options is chosen; |
| 5 | If there are any previously photos added it will follow the “Y” path and a sub-menu for its photos will |
| | appear, otherwise it will follow the “N” path and only ADD NEW PHOTO must be showed; |
| 6 | If EDIT PHOTO is chosen it will follow “Y” path to diagram [3C3], otherwise it will await until the |
| | user's choice. |
| 7 | If DELETE PHOTO is chosen it will follow “Y” path to diagram [3C4], otherwise it will await until the |
| | user's choice. |
| 8 | If ADD PHOTO is chosen it will follow “Y” path to diagram [3C5], otherwise it will await until the |
| | user's choice. |
| 9 | If ADD PHOTO is chosen it will follow “Y” path to diagram [3C5], otherwise it will await until the |
| | user's choice. |

Referring to FIG. 23CC, beginning at 456, the following steps are performed.

TABLE 29

| Step | Action |
|---|---|
| 1 | Browser will display UPLOAD PHOTO - ADD PHOTO title. |
| 2 | Website will load ADD PHOTO section; |
| 3 | Website will display ADD PHOTO page with its forms; |
| 4 | User MUST enter PHOTO NAME and choose a PHOTO to upload; |
| 5 | Website will wait until one of the available options is chosen; |
| 6 | If user clicked on CANCEL during the process, the system will follow the “Y” path to diagram [3C1], |
| | otherwise it will follow the “N” path; |
| 7 | If ADD NEW PHOTO clicked, the system will follow the “Y” path, otherwise it will follow the “N” |
| | path; |
| 8 | If all submitted data are correct, it will follow the “Y” path, otherwise it will follow the “N” path; |
| 9 | If an error happens, an error message will be showed and user can choose to try again; |
| 10 | If user wants to try again it will follow the “Y” path, otherwise it will follow the “N” path to diagram |
| | [3C1]; |
| 11 | The system will ADD THE PHOTO information and UPLOAD THE PHOTO to image folder and goes |
| | to diagram [3C1]; |

Referring to FIG. 23DD, beginning at 458, the following steps are performed.

TABLE 30

| Step | Action |
|---|---|
| 1 | Browser will display UPLOAD PHOTO - EDIT PHOTO title. |
| 2 | Website will load EDIT PHOTO section; |
| 3 | Website will display EDIT PHOTO page with its forms; |
| 4 | User MUST enter PHOTO NAME and choose a PHOTO to upload; |
| 5 | Website will wait until one of the available options is chosen; |
| 6 | If user clicked on CANCEL during the process, the system will follow the “Y” path to diagram [3C1], |
| | otherwise it will follow the “N” path; |
| 7 | If SAVE CHANGES clicked, the system will follow the “Y” path, otherwise it will follow the “N” path; |
| 8 | If all submitted data are correct, it will follow the “Y” path, otherwise it will follow the “N” path; |
| 9 | If an error happens, an error message will be showed and user can choose to try again; |
| 10 | If user wants to try again it will follow the “Y” path, otherwise it will follow the “N” path to diagram |
| | [3C1]; |
| 11 | The system will UPDATE PHOTO information and UPLOAD THE PHOTO to image folder and goes to |
| | diagram [3C1]; |

Referring to FIG. 23EE, beginning at 460, the following steps are performed.

TABLE 31

| Step | Action |
|---|---|
| 1 | Browser will display UPLOAD PHOTO - DELETE PHOTO title. |
| 2 | Website will ask user to CONFIRM PHOTO TO DELETE; |
| 3 | If user clicked on NO during the process, the system will follow |
| | the “N” path to diagram [2C2], otherwise it will follow the |
| | “Y” path; |
| 4 | The system will delete selected PHOTO information and PHOTO, |
| | update photo database and goes to diagram [3C1]; |

Referring to FIG. 23FF, beginning at 462, the following steps are performed.

TABLE 32

| Step | Action |
|---|---|
| 1 | Browser will display PERSONAL MENU - UPLOAD BANNER title. |
| 2 | Website will load UPLOAD BANNER section and its available photos; |
| 3 | Website will display UPLOAD BANNER and its available photos; |
| 4 | Website will wait until one of the available options is chosen; |
| 5 | If there are any previously banners added it will follow the “Y” path and a sub-menu for its banners will |
| | appear, otherwise it will follow the “N” path and only ADD NEW BANNER must be showed; |
| 6 | If EDIT BANNER is chosen it will follow “Y” path to diagram [3D3], otherwise it will await until the |
| | user's choice. |
| 7 | If DELETE BANNER is chosen it will follow “Y” path to diagram [3D4], otherwise it will await until |
| | the user's choice. |
| 8 | If ADD BANNER is chosen it will follow “Y” path to diagram [3D5], otherwise it will await until the |
| | user's choice. |
| 9 | If ADD BANNER is chosen it will follow “Y” path to diagram [3D5], otherwise it will await until the |
| | user's choice. |

Referring to FIG. 23GG, beginning at 464, the following steps are performed.

TABLE 33

| Step | Action |
|---|---|
| 1 | Browser will display UPLOAD BANNER - ADD BANNER title. |
| 2 | Website will load ADD BANNER section; |
| 3 | Website will display ADD BANNER page with its forms; |
| 4 | User MUST enter BANNER NAME and choose a BANNER to upload; |
| 5 | Website will wait until one of the available options is chosen; |
| 6 | If user clicked on CANCEL during the process, the system will follow the “Y” path to diagram [3D1], |
| | otherwise it will follow the “N” path; |
| 7 | If ADD NEW BANNER clicked, the system will follow the “Y” path, otherwise it will follow the “N” |
| | path; |
| 8 | If all submitted data are correct, it will follow the “Y” path, otherwise it will follow the “N” path; |
| 9 | If an error happens, an error message will be showed and user can choose to try again; |
| 10 | If user wants to try again it will follow the “Y” path, otherwise it will follow the “N” path to diagram |
| | [3D1]; |
| 11 | The system will ADD THE BANNER information and UPLOAD THE BANNER to image folder and |
| | goes to diagram [3D1]; |

Referring to FIG. 23HH, beginning at 464, the following steps are performed.

TABLE 34

| Step | Action |
|---|---|
| 1 | Browser will display UPLOAD BANNER - EDIT BANNER title. |
| 2 | Website will load EDIT BANNER section; |
| 3 | Website will display EDIT BANNER page with its forms; |
| 4 | User MUST enter BANNER NAME and choose a BANNER to upload; |
| 5 | Website will wait until one of the available options is chosen; |
| 6 | If user clicked on CANCEL during the process, the system will follow the “Y” path to diagram [3D1], |
| | otherwise it will follow the “N” path; |
| 7 | If SAVE CHANGES clicked, the system will follow the “Y” path, otherwise it will follow the “N” path; |
| 8 | If all submitted data are correct, it will follow the “Y” path, otherwise it will follow the “N” path; |
| 9 | If an error happens, an error message will be showed and user can choose to try again; |
| 10 | If user wants to try again it will follow the “Y” path, otherwise it will follow the “N” path to diagram |
| | [3D1]; |
| 11 | The system will UPDATE BANNER information and UPLOAD THE BANNER to image folder and |
| | goes to diagram [3C1]; |

Referring to FIG. 23II, beginning at 468, the following steps are performed.

TABLE 35

| Step | Action |
|---|---|
| 1 | Browser will display UPLOAD BANNER - DELETE BANNER |
| | title. |
| 2 | Website will ask user to CONFIRM BANNER TO DELETE; If |
| | user clicked on NO during the process, the system will follow the |
| | “N” path to diagram [3D2], otherwise it will follow the “Y” path; |
| 3 | The system will delete selected BANNER information and |
| | BANNER, update banner database and goes to diagram [3C1]; |

Referring to FIG. 23JJ, beginning at 470, the following steps are performed.

TABLE 36

| Step | Action |
|---|---|
| 1 | Browser will display PERSONAL MENU - MANAGE BANNER title. |
| 2 | Website will load MANAGE BANNER section; |
| 3 | Website will display MANAGE BANNER page with its forms; |
| 4 | User MUST choose the DEFAULT BANNER; |
| 5 | Website will wait until one of the available options is chosen; |
| 6 | If user clicked on CANCEL during the process, the system will follow the “Y” path to diagram [3A], |
| | otherwise it will follow the “N” path; |
| 7 | If BANNER is chosen, the system will follow the “Y” path, otherwise it will follow the “N” path; |
| 8 | If all submitted data are correct, it will follow the “Y” path, otherwise it will follow the “N” path; |
| 9 | If an error happens, an error message will be showed and user can choose to try again; |
| 10 | If user wants to try again it will follow the “Y” path, otherwise it will follow the “N” path to diagram |
| | [3A]; |
| 11 | The system will UPDATE DEFAULT BANNER information into database system and goes to diagram |
| | [3A]; |

Referring to FIG. 23KK, beginning at 472, the following steps are performed.

TABLE 37

| Step | Action |
|---|---|
| 1 | Browser will display PERSONAL MENU - CHANGE PASSWORD title. |
| 2 | Website will load CHANGE PASSWORD section; |
| 3 | Website will display CHANGE PASSWORD page with its forms; |
| 4 | User MUST enter OLD PASSWORD, NEW PASSWOR and CONFIRM NEW PASSWORD; |
| 5 | If user clicked on CANCEL during the process, the system will follow the “Y” path to diagram [3A], |
| | otherwise it will follow the “N” path; |
| 6 | If CHANGE YOUR PASSWORD was clicked, the system will follow the “Y” path, otherwise it will |
| | follow the “N” path; |
| 7 | If all submitted data are correct, it will follow the “Y” path, otherwise it will follow the “N” path; |
| 8 | If an error happens, an error message will be showed and user can choose to try again; |
| 9 | If user wants to try again it will follow the “Y” path, otherwise it will follow the “N” path to diagram |
| | [3A]; |
| 10 | The system will UPDATE PASSWORD information into database system and goes to diagram [3A]; |

Referring to FIG. 23LL, beginning at 474, the following steps are performed.

TABLE 38

| Step | Action |
|---|---|
| 1 | Browser will display LOG OUT title. |
| 2 | Website will clear all log in information and goes to diagram [3]; |

Referring to FIG. 23MM, beginning at 476, the following steps are performed.

TABLE 39

| Step | Action |
|---|---|
| 1 | Browser will display PERSONAL MENU - USER COMMENTS title. |
| 2 | Website will load USER COMMENTS section and all available users' comments; |
| 3 | Website will display USER COMMENTS page with its forms; |
| 4 | Website will wait until one of the available options is chosen; |
| 5 | If Title is chosen the system will follow the “Y” path, otherwise it will follow the “N” path; |
| 6 | Website will load the selected category and will check for available sub-categories; |
| 7 | If there are sub-categories, it will follow the “Y” path, otherwise it will follow the “N” path; |
| 8 | The system will display all available sub-categories for selected category and its next levels; |
| 9 | User MUST enter COMMENT TITLE, COMMENT, choose ICON, select which PERSONAL |
| | INFORMATION the system will display, and select ACCESS TYPE; |
| 10 | If Enlarge Writing Area was clicked it will follow the “Y” path, otherwise it will follow the “N” path; |
| 11 | As soon Enlarge Writing Area is chosen, the COMMENT field will be resized either to a bigger writing |
| | area or, if it already resized, will be resized to its initial size; |
| 12 | If all information were submitted it will follow the “Y” path, otherwise it will follow the “N” path; |
| 13 | If all submitted data are correct, it will follow the “Y” path, otherwise it will follow the “N” path; |
| 14 | If an error happens, an error message will be showed and user can choose to try again; |
| 15 | If user wants to try again it will follow the “Y” path, otherwise it will follow the “N” path to diagram |
| | [3]; |
| 16 | The system will ADD COMMENT information into database system and goes to diagram [3]; |

Referring to FIG. 23NN, beginning at 480, the following steps are performed.

TABLE 40

| Step | Action |
|---|---|
| 1 | Browser will display WEALTHYSOULJOURNAL.COM HOMEPAGE (A.K.A. End Users' Comments |
| | Page) title. |
| 2 | Website will load HEADER, COMMENT FORMS, IFRAME SUBSTITUTE (described on DIAGRAM |
| | 5 file) and FOOTER sections; |
| 3 | Website will display HEADER, COMMENT FORMS, IFRAME SUBSTITUTE (described on |
| | DIAGRAM 5 file) and FOOTER sections; |
| 4 | User MUST enter COMMENT, NAME and EMAIL ADDRESS; |
| 5 | Website will wait until one of the available options is chosen; |
| 6 | If CLEAR FORM was clicked the system will follow the “Y” path, otherwise it will follow the “N” |
| | path; |
| 7 | The system will clear any information that user added to comments forms; |
| 8 | If User's comments were submitted it will follow the “Y” path, otherwise it will follow “N” path; |
| 9 | If all submitted data are correct, it will follow the “Y” path, otherwise it will follow the “N” path; |
| 10 | If an error happens, an error message will be showed and user can choose to try again; |
| 11 | If user wants to try again it will follow the “Y” path, otherwise it will follow the “N” path to diagram |
| | [4A]; |
| 12 | The system will ADD USER'S COMMENT information into database system and goes to diagram |
| | [4A]; |

Referring to FIG. 23OO, beginning at 482, the following steps are performed.

TABLE 41

| Step | Action |
|---|---|
| 1 | Browser will display an iFrame DIV into HTML body's layout; |
| 2 | Browser will display a LOADING PAGE until all iFrame is loaded; |
| 3 | Website will send its ID to comments database to identify which data will be loaded; |
| 4 | Website will load Comment Title, Keyword (used for Search Engine Optimizations), Full Comment, |
| | Personal Data, Date and Time for each comment; |
| 5 | If all data is already loaded it will follow the “Y” path, otherwise it will follow the “N” until all |
| | available data is loaded; |
| 6 | Website will load user's template that was chosen into “User's Admin Panel”; |
| 7 | If template is loaded, all data will be formatted into it and the website will create the complete |
| | comments' page; |
| 8 | If iFrame is fully loaded it will follow the “Y” path, otherwise it will follow the “N” until all available |
| | data is loaded; |
| 9 | With all data loaded, another script will detect if these data has been fit into the actual height, or if it |
| | needs to be resized. If it has been fit then the script will follow the “Y” path, if not, it will follow the |
| | “N” path; |
| 10 | When the loaded data can't fit into its actual iFrame height, another script will be triggered and a new |
| | height will be calculated; |
| 11 | When the new height has been calculated, this script will resize the iFrame to its new height and will fit |
| | it into the all page content; |
| 12 | With all internal iFrame process is done, it will remove the LOADER PAGE from iFrame Substitute |
| | Area and goes to diagram [4B]; |

Various embodiments may include an “iFrame solution” to add comment areas to web pages. Typically, XML code is used to display input from a local web site to a remote web site. However, XML code cannot display database input fields from one site to another. This requirement is met using an “iFrames.” The use of iFrames with XML code is a unique combination that allows this feature to be implemented. The reason that HTML Frames are not used exclusively is that the text of comments would not be placed on the remote web site (even though it would appear to be), thus preventing the search engine optimization feature of this system as produced in the keyword label 262 of the display page as shown in FIG. 7.

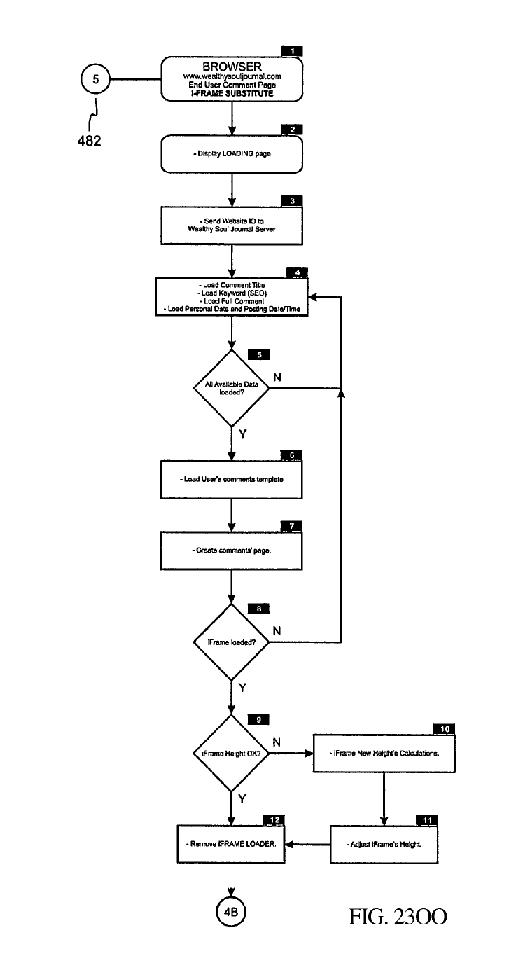

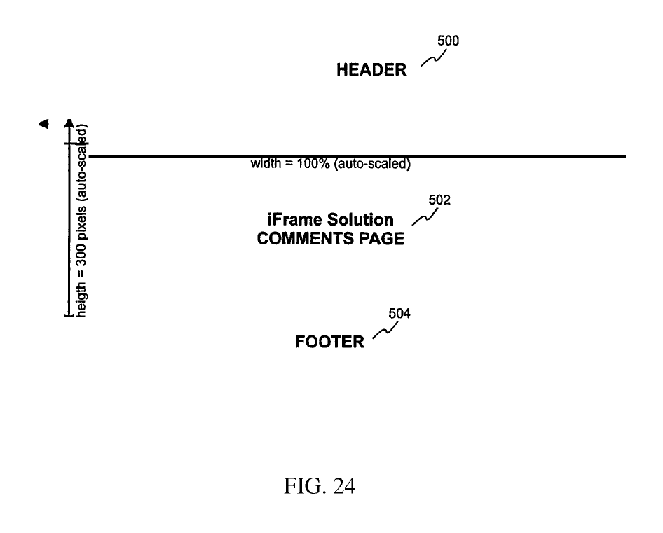

The “iFrame solution” may be implemented with an existing web page framework. In the following example, the www.wealthysoul.com domain is used. An iFrame is a webpage element that creates an inline frame that contains another document. An iFrame functions as a document within a document, or like a floating FRAME. It just loads another HTML document within the <iframe> tags. Syntax <IFRAME> . . . </IFRAME>. The following example uses the IFRAME element and an HTML fragment to create a frame containing the page sample.htm as shown in FIG. 24. The page comprises a header 500, comments page 502, and footer 504. Comments, therefore, may be added within any section of a HTML document comprising the iFrame solution.

TABLE 42

| Code | Parameters for IFrame |
|---|---|
| <IFRAME | SRC = URI (URI of frame content) |
| ID=“iFrame1” | NAME = CDATA (name of frame) |
| FRAMEBORDER=“0 | LONGDESC = URI (link to long description) |
| ” | WIDTH = Length (frame width) |
| SCROLLING=“NO” | HEIGHT = Length (frame height) |
| SRC=“sample.htm”> | ALIGN = [top\|middle\|bottom\|left\|right] (frame |
| </IFRAME> | alignment) |
| | FRAMEBORDER = [1\|0] (frame border) |
| | MARGINWIDTH = Pixels (margin width) |
| | MARGINHEIGHT = Pixels (margin height) |
| | SCROLLING = [yes\|no\|auto] (ability to scroll) |

The embedded technologies into iFrame solution are HTML, PHP, Javascript, MySQL, CSS and AJAX methods.

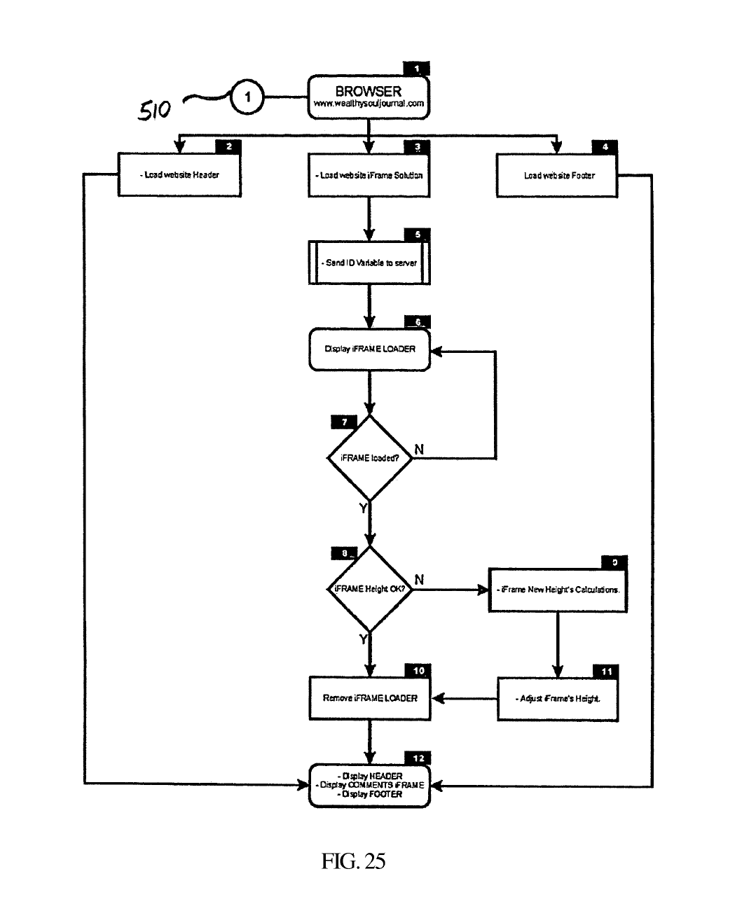

Referring to FIG. 25, a flowchart illustrating the iFrame solution according to an exemplary embodiment is shown. Referring to FIG. 25, beginning at 510, the following steps are performed to implement the iFrame solution.

TABLE 43

| Step | Action |
|---|---|
| 1 | With any ECMA-262 compatible browsers (Internet Explorer 5+, FireFox 1.5+, Opera 8+, etc), the |
| | user will access URL given in this example (www.wealthysoul.com); |
| 2 | Accessing the domain, the main framework will load its HEADER information and will display it as |
| | seen FIG. 24 header 500; |
| 3 | Accessing the domain, the main framework will load its FOOTER information and will display it as |
| | seen in FIG. 24 footer 500; |
| 4 | The iFrame will load an internal PHP dynamic page called comments.php. |
| 5 | Starting the loading functions, the framework should detect its domain (in this example, |
| | www.wealthysoul.com), and will send an ID variable that will define which data the comments.php |
| | page must load, as all its CSS styles; |
| 6 | As soon as comments.php start its function, a Javascript code will load a DIV tag who will display an |
| | 100% opaque image (white board in the example given), displaying an animated gif showing |
| | “LOADING”; |
| 7 | Into the HEAD TAG, an OnLoad trigger will start another script as soon as all contents from database |
| | is loaded as noticed into “Y” path. If all data haven't been loaded yet, the loader DIV will stay on |
| | screen as noticed into the “N” path; |
| 8 | With all data loaded, another script will detect if these data has been fit into the actual height, or if it |
| | needs to be resized. If it has been fit then the script will follow the “Y” path, if not, it will follow the |
| | “N” path; |
| 9 | When the loaded data can't fit into its actual iFrame height, another script will be triggered and a new |
| | height will be calculated; |
| 10 | When the new height has been calculated, this script will resize the iFrame to its new height and will |
| | fit it into the all page content; |
| 11 | After all scripts have been executed and none has failed, the iFrame LOADER DIV will be removed |
| | and the loaded data will be revealed. |
| 12 | HEADER, comments.php iFrame and FOOTER will be revealed into user's browser (e.g., as shown in |
| | FIG. 24: header 500, comments page 502, footer 504. |

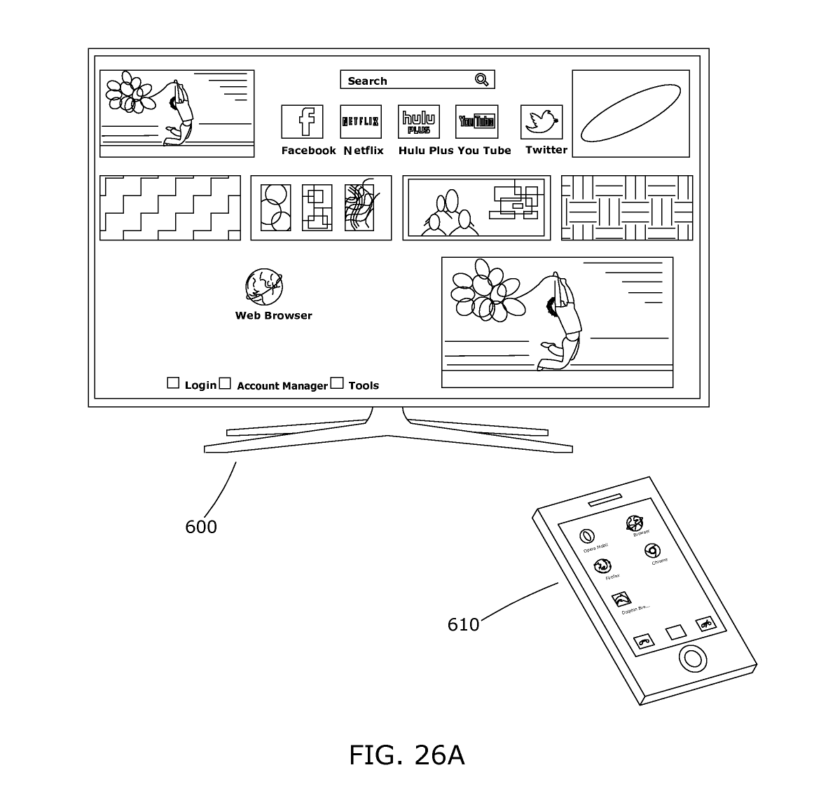

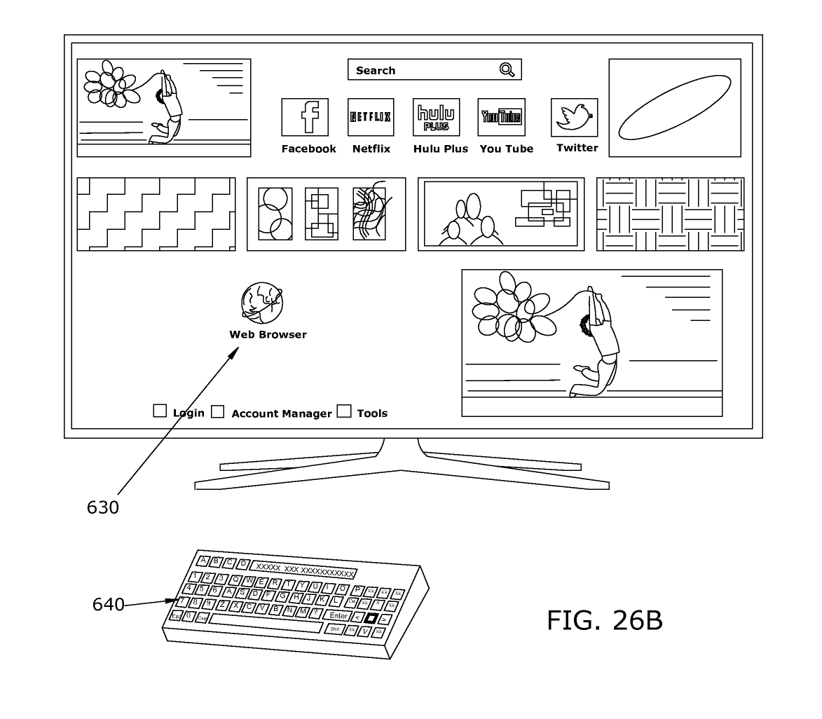

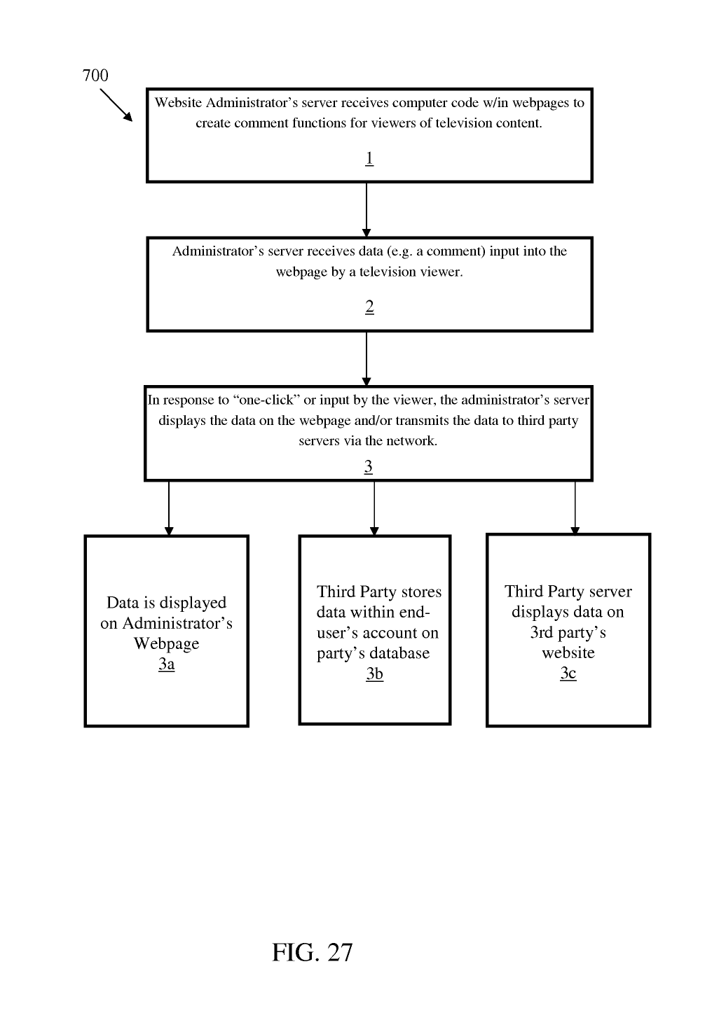

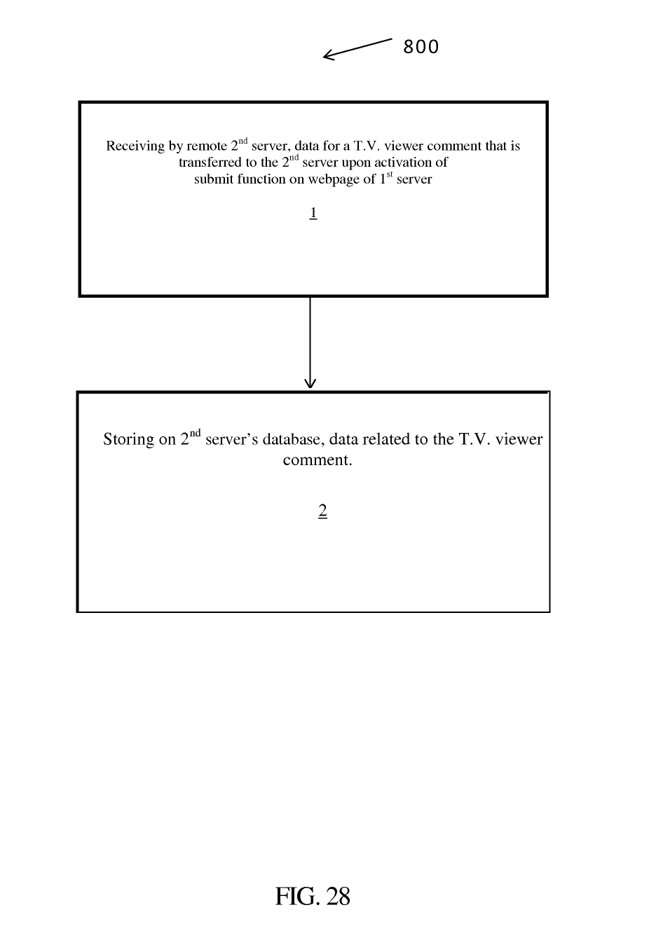

Referring to FIG. 26A, is an illustration of the electronic computing devices utilized in one embodiment comprising a television, television with Internet connectivity, or a smart television 600 and a viewer (end user) with a smartphone comprising a web browser 610 wherein the end user inputs their comments into the interface of their smartphone that displays a webpage of a first website server. The viewer may navigate to the administrator's website using the web browser on their device 610, or they may use a device that communicates with a smart television's web browser 630, such as a keyboard (see FIG. 26B, 640). They may also view and respond to comments from other users from the webpage of third party websites by using the interface on their electronic computing devices. Referring to FIG. 27 and Table 44, a flowchart 700 is provided for illustrating the creation of a webpage by an administrator with the functionality for receiving, displaying, and transmitting to third parties a plurality of viewers' comments about television, online, or cinema content. Each viewer is utilizing an electronic computing device displaying the administrator's webpage, such as a mobile device (e.g. smartphone with browser) and/or smart television with web browser and keyboard.

TABLE 44

| Step | Action |
|---|---|
| 1 | Website Administrator's server receives computer code w/in |
| | webpages to create comment functions for viewers of television |
| | and cinema content. |
| 2 | Administrator's server receives data (e.g. a comment) input into the |
| | webpage by a television or cinema viewer. |
| 3 | In response to “one-click” or input by the viewer, the |
| | administrator's server displays the data on the webpage and/or |
| | transmits the data to third party servers via the network. |
| 3a | Data (comment) is displayed on Administrator's Webpage. |
| 3b | Third Party stores data (comment) within viewer's account on |
| | party's database. |
| 3c | Third Party server displays data (comment) on 3rd party's website. |

In various embodiments, the third party database and website may comprise a plurality of cinema or television programs owned by one or more media organizations; and, further comprise a means well known in the art to filter the end-user comments, and transmit the filtered comments to a fourth party server comprising one or more advertising entities and/or film and/or media distribution companies. The second and/or third party database may also perform a variety of types of data and statistical analysis on a plurality of users' comments, and display the results on the server's associated website, and/or transmit the data to another entity.

In various embodiments, the second or third party database may also consolidate all of a user's comments made online, such as at various social media websites (e.g. Facebook®), into a record on the database. The user is then able to search for all of their online comments. Alternatively, or additionally, the record may comprise or be filtered for displaying only user comments about television, online, and/or cinema content.

In the various embodiments, the comment data entered by the user into their electronic computing device's web browser may comprise any combination of text, audio, video and graphic input.

Referring to FIG. 27 and Table 45, a flowchart 800 is provided for illustrating the steps taken by the 3^{rd} party's website server (i.e. second website server) in receiving and storing the viewer's comment. The 3^{rd} party may be, for example, a television rating firm that will utilize the comments stored in the database to perform mathematical computations to “rate” the favorability of a particular television program or streaming movie, and specific aspects of it (e.g. likeability of characters, plot, etc.).

TABLE 45

| Step | Action |
|---|---|
| 1 | Receiving by remote 2nd server, data for a viewer comment that is |
| | transferred to the 2nd server upon activation of submit function on |
| | webpage of 1st server |
| 2 | Storing on 2nd server's database, data related to the |
| | viewer's comment. |

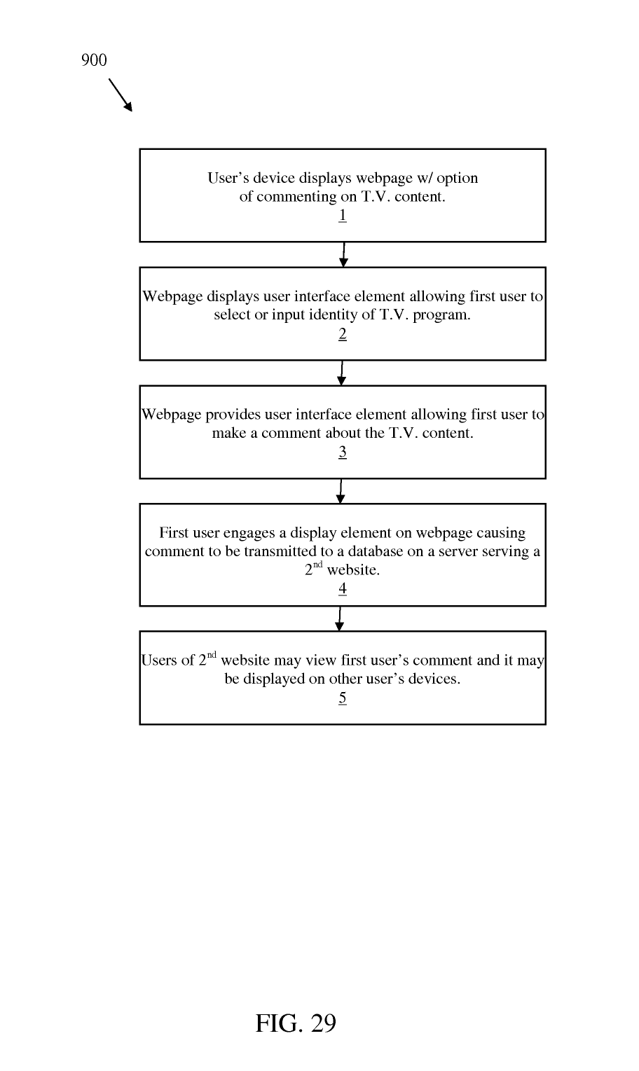

Referring to FIG. 29 and Table 46, a flowchart 900 is provided illustrating the computer steps for an electronic computing device with a web browser to carry forth the steps of the following method using webpage(s) that may comprise a user interface element with one or more screens, or elements in a screen, that: 1) allows the user to select or input the identification of the television content—e.g. program or streaming movie or advertisement; 2) transmit over the Internet the comment in response to a user input, such as one user action (e.g. 1-Click) on the webpage; 3) receive at a remote second website server the user input; and, 4) store the user input (i.e. comment(s)) in a database of the second server and/or display on a webpage of the website of the second server.

| Step | Action |
|---|---|
| 1 | User's utilize an electronic computing device with a web browser, |
| | such as a keyboard of a smart television with a web browser, |
| | laptop, tablet, portable computer, etc. which displays a webpage |
| | with the option of commenting on a television program, or cinema |
| | movie or advertisement. |
| 2 | Webpage displays a user interface element that allows the user to |
| | select or input identifying information of the user's television show |
| | or cinema movie title. |
| 3 | Webpage provides a user interface element allowing the user to |
| | make a comment about the show. |
| 4 | User engages a display element on the webpage that causes the |
| | comment to be sent to a database on a server serving a second |
| | website. |
| 5 | Readers of the second website may view the user's comments and |
| | it may be displayed on other user's devices; and, readers may |
| | respond to the user's comments. |

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

The present embodiments may further computer program products for one or more embodiments disclosed herein, wherein the products comprise computer code stored in memory on the system server, such as a remote cloud-based server, and/or accessible by or stored in whole or in part the within the memory of an end user's electronic computing device. The products may further comprise non-transitory computer readable medium containing computer executable instructions to carry out, by the processor, the methods when the instructions are run on an end user's electronic computing device or on a network, and wherein the instructions are downloadable from or stored on a system server. In one embodiment, for example, the computer program product is a mobile application on an end user's computing device (e.g. smartphone), wherein the product comprises non-transitory computer readable storage medium containing software instructions that, when executed by the device's processor, cause the device to perform acts included in one or more of the embodiments disclosed herein.

What is claimed is:

1. A computerized method for receiving and managing user comments about television or cinema content, wherein a first web site server displays a web page modified to display a user comment function and is configured to receive data related to a comment entered by a user displayed by said first web site server, the method comprising the actions of:
a. receiving at a remote second web site server data related to a comment about television or cinema content, said data transferred upon said viewer actuating a submit function displayed on the web page presented by the first web site server;
b. storing at said remote second web site server, using a database that is remote from said first web site server said data related to said comment that was entered by the viewer at said first web site server; and,
c. wherein said data is entered into an electronic computing device comprising a web browser.

2. The method of claim 1, wherein said electronic computing device comprises a remote control keyboard or touch pad for a smart television with web browser.

3. The method of claim 1, wherein said electronic computing device with a web browser comprises portable computers, laptop computers, desktop computers, tablet computers, smartphones, cellular phones, and personal digital assistant devices.

4. The method of claim 1, wherein said user is a viewer in real-time of the television or cinema content, a viewer who has previously viewed the content, and/or a responder to the comment of the viewer.

5. The method of claim 1, wherein the content comprises television programs, streaming movies, streaming videos, cinema movies, television advertisements, and cinema advertisements.

6. The comment of claim 1, wherein a plurality of user comment data is processed and statistical data generated by the first and/or second server.

7. The method of claim 1, wherein the second website server database further comprises records for each of a user's social media accounts located on a plurality of first website servers, the records comprising a history of all of a user's comments about media content.

8. A computerized method for receiving and managing user comments associated with television or cinema content comprising:
a. displaying, by a first web site server, a web page comprising a user comment area, said user comment area comprising a user comment input;
b. receiving, in said user comment input section, data related to a comment entered by a user and associated with a television or cinema content;
c. receiving, at a remote second web site server, said data related to said comment, said data transferred upon said user selection of a submit option on said user comment input section;
d. storing at said remote second web site server, using a database that is remote from said first web site server said data related to said comment entered by said user of said web page at said first web site server; and,
e. wherein said data is entered into an electronic computing device comprising a web browser.

9. The method of claim 8, wherein said electronic computing device comprises a remote control keyboard or touch pad for a smart television with a web browser.

10. The method of claim 8, wherein said electronic computing device with a web browser comprises portable computers, laptop computers, desktop computers, tablet computers, smartphones, cellular phones, and personal digital assistant devices.

11. The method of claim 8, wherein receiving, at a remote second web site server, data in response to a single submit option further comprises posting said comment on a webpage of the the first and/or second web site server.

12. The method of claim 8, wherein said user a viewer in real-time of the television or cinema content, a viewer who has previously viewed the content, and/or a responder to the comment of the viewer.

13. The method of claim 8, wherein the content comprises television programs, streaming movies, streaming videos, cinema movies, television advertisements, and cinema advertisements.

14. The comment of claim 8, wherein a plurality of user comment data is processed and statistical data generated by the first and/or second server.

15. The method of claim 8, wherein the second website server database further comprises records for each of a user's social media accounts located on a plurality of first website servers.

16. A content commenting computerized system for managing a web site comment area in a web page, wherein said comments relate to television or cinema content as viewed by a user with an electronic computing device comprising a web browser, the system comprising:
a) an administrator page creator software component for defining a comment area details for said web page, said comment area details comprising a mean to identify the content comprising title, date of viewing, and/or host of content;
b) a code generation software component for generating code to define a comment area in a web page hosted at a first web site server, said comment area defined by said comment area details and wherein comments are received and stored at a remote second web site server;
c) a web page editing software component for editing a web page selected by an administrator to contain said code defining said comment area;
d) a database at a remote second web site server for receiving comments, wherein said database is remote from said first web site server and receives comments in response to one user submit function; and,
e) an administrator page editor software component for reviewing comments entered in said comment area within said web page before posting said comments on a webpage of the first website server.

17. The content commenting method of claim 16, wherein the content comprises television programs, streaming movies, streaming videos, cinema movies, television advertisements, and cinema advertisements.

18. The content commenting system of claim 16, wherein said electronic computing device comprises a remote control keyboard or touch pad for a smart television with a web browser.

19. The content commenting system of claim 16, wherein said electronic computing device with a web browser comprises portable computers, laptop computers, desktop computers, tablet computers, smartphones, cellular phones, and personal digital assistant devices.

20. The content commenting system of claim 16, wherein the comment data is received in response to the end user providing any combination of text, audio, video and graphic input.
